(19) United States
(12) Patent Application Publication
(10) Pub. No.: US 2022/0335369 A1
(43) Pub. Date: Oct. 20, 2022

(54) FILLING ORDERS USING ITEM ADJACENCY

(71) Applicant: Thomas Francis, Dubuque, IA (US)

(72) Inventor: Thomas Francis, Dubuque, IA (US)

(21) Appl. No.: 17/634,521

(22) PCT Filed: Aug. 10, 2020
(86) PCT No.: PCT/US20/45651

§ 371 Date: Feb. 10, 2022

Related U.S. Application Data
(60) Provisional application No. 62/885,284, filed on Aug. 11, 2019.

(51) Int. Cl. G06Q 10/08; B65G 1/137

(52) U.S. Cl. CPC G06Q 10/087; B65G 1/1373; B65G 2209/04

(57) ABSTRACT

An order filling system includes a computing system and a mobile scanning device. The computing system is configured to generate an item adjacency map based on a plurality of scan times associated with a plurality of stocked items for picking from a store according to one or more electronic customer orders. The item adjacency map indicates which of the stocked items are adjacent to one another. Additionally, the computing system is configured to receive an electronic customer order including a plurality of ordered items indicating which of the stocked items are to be picked and wirelessly transmit the electronic customer order. The mobile scanning device includes a display. The mobile scanning device is configured to receive the transmitted electronic customer order and arrange at least some of the plurality of ordered items on the display based on the item adjacency map.

### CROSS-REFERENCE TO RELATED APPLICATION

This application claims the benefit of U.S. Provisional Application No. 62/885,284, filed on Aug. 11, 2019. The disclosure of the above application is incorporated herein by reference in its entirety.

### TECHNICAL FIELD

The disclosure relates to techniques for filling orders, and more particularly, to techniques for filling orders using mobile computing devices.

### BACKGROUND

Customers purchase products from a variety of different types of stores. Stores may sell a variety of different products or be limited to particular types of products. Example products include dry goods, grocery products, or any other items a customer may purchase. Different stores may have a variety of different sizes and layouts. Some stores may sell tens of thousands of products over a floor space covering tens of thousands of square feet. Stores may be referred to by different names, depending on the types of products sold at the store, the size of the store, the location of the store, and other factors. For example, a store may be referred to as a retail store, a grocery store, a supermarket, a hypermarket, a warehouse, a distribution facility, an outdoor market, or by another name.

Customers may interact with stores in a variety of different ways. In some scenarios, a customer may travel to the store and select products from within the store. Typically, the customer selects the desired products within the store and purchases the products at a checkout section of the store. In other scenarios, a customer may place an order for products from a location remote from the store (e.g., via the Internet or phone). In these scenarios, the purchased products may be shipped from the store to the customer's home.

### SUMMARY

In some examples, an order filling system comprises a computing system and a mobile scanning device. The computing system is configured to generate an item adjacency map based on a plurality of scan times associated with a plurality of stocked items for picking from a store according to one or more electronic customer orders. The item adjacency map indicates which of the stocked items are adjacent to one another. Additionally, the computing system is configured to receive an electronic customer order including a plurality of ordered items indicating which of the stocked items are to be picked and wirelessly transmit the electronic customer order. The mobile scanning device comprises a display. The mobile scanning device is configured to receive the transmitted electronic customer order and arrange at least some of the plurality of ordered items on the display based on the item adjacency map.

### BRIEF DESCRIPTION OF THE DRAWINGS

FIG. 1 shows an example implementation of an order filling system (OFS) implemented in a store.

FIGS. 2A-2D illustrate a central computing system (CCS) and a third-party computing system (TPCS) communicating with a plurality of customer computing devices.

FIGS. 3A-3B show perspective views of example racks of a store.

FIGS. 4A-9 show example racks including location indicators in different locations.

FIGS. 10A-10C show example location indicators that transmit location signals.

FIGS. 11A-11C show different example readable codes which may be used as location indicators.

FIGS. 12-18 illustrate example arrangements of location indicators and associated location values that are associated with different areas of a store.

FIGS. 19A-22B show example stores and associated location maps.

FIGS. 23A-23B show an example store and an associated location map including items.

FIGS. 24-25 show functional block diagrams of example mobile scanning devices (MSDs).

FIGS. 26A-26I show example MSD form factors.

FIG. 27 shows the placement of customer orders with a CCS and wireless transmission of the customer orders to MSDs.

FIGS. 28A-C show how multiple MSDs may display customer orders to users.

FIGS. 29A-29B show example communications between MSDs and a CCS.

FIGS. 30A-30C show the store and the MSDs of FIGS. 28A-28C after the MSDs have moved through the store and some items have been picked.

FIGS. 31A-31C show how a display of an MSD may be updated as the MSD is moved throughout a store.

FIGS. 32A-32E show displays of multiple MSDs and how the displays are updated when items are picked.

FIG. 33 is a method that describes operation of an OFS from the time a customer order is received until the order is provided to the customer.

FIG. 34 is a method that describes operation of an MSD configured to receive location signals.

FIG. 35 is a method that describes operation of an MSD configured to scan location indicators that include readable codes.

FIG. 36 is a method that describes operation of an MSD when items are picked by the MSD and other MSDs.

FIGS. 37A-37E show generation of an item association table and updating of the item association table.

FIG. 38 illustrates a method for generating an item association table.

FIGS. 39A-39C illustrate GUIs for an MSD in an item association mode.

FIG. 40 illustrates an example method for generating a location map.

FIGS. 41A-41D illustrate automatic generation of a location map using a single MSD.

FIGS. 42A-42F illustrate automatic generation of a location map using multiple MSDs.

FIGS. 43A-43B illustrate automatic updating of a location map upon the introduction of a location indicator to the store.

FIGS. 44A-44B illustrate automatic updating of a location map in response to loss of a location indicator.

FIGS. 45A-45B illustrate an example store including a plurality of items and an item adjacency map indicating adjacency of the items.

FIGS. 46A-46C illustrate example item scan time data and item adjacency maps generated based on the item scan time data.

FIG. 47 illustrates a method describing operation of an MSD configured to generate an item adjacency map indicating adjacency of a plurality of items.

FIG. 48 illustrates an example store including a plurality of items.

FIG. 49 illustrates an example item adjacency map indicating adjacency of a plurality of items included in a store.

FIG. 50 illustrates a method describing operation of an MSD configured to display a plurality of items based on an associated item adjacency map.

FIG. 51 illustrates an example CCS that generates tables and maps based on scan data from a plurality of MSDs.

FIG. 52 illustrates an example method for generating an item adjacency map.

FIGS. 53A-53B illustrate example clusters of items.

FIG. 54 illustrates an example method for generating, using, and updating an item adjacency map.

FIG. 55 illustrates an example method for using an item association table, location map, and item adjacency map.

FIGS. 56A-56D illustrate an example implementation of the OFS that uses location indicators and item adjacency mapping.

FIGS. 57A-57D illustrate an example implementation of the OFS that uses item adjacency and directionality to display items.

### DETAILED DESCRIPTION

An order filling system (OF S) of the present disclosure may be used to fill orders (e.g., customer orders) for a variety of different products. The OFS may be implemented in a variety of different locations (e.g., a retail store, a warehouse, an outdoor market, etc.). Although the OFS is generally described herein as being implemented in a store (e.g., a grocery store) to fill customer orders, the OFS may be implemented in other locations to fill other types of orders. For example, the OFS may be implemented in a warehouse or other building to fill warehouse orders. As used herein, a “store” may generally refer to any location in which the OFS may be implemented (e.g., a retail store, grocery store, warehouse, outdoor market, etc.).

The OFS of the present disclosure may include a central computing system (CCS) and one or more mobile scanning devices (MSDs). In some implementations, the OFS may include one or more location indicators. Although the OFS may include one or more location indicators, some features of the OFS described herein may not require location indicators. Although various features (e.g., various computing operations) of the OFS may be attributed to the CCS and one or more MSDs, the CCS and MSDs may generally implement any of the OFS features (e.g., various computing operations) alone or in combination. For example, one or more MSDs may implement features attributed to the CCS herein. As another example, the CCS may implement one or more features attributed to the MSDs herein.

The CCS may receive electronic customer orders from customer computing devices (CCDs) via a computer network, such as the Internet. The CCDs may include any type of computing device used by customers to place orders with the CCS. For example, the CCDs may include cell phones, tablet computers, laptop computers, desktop computers, wearable computers, or other computing devices. Each of the customer orders may include one or more items located in the store (e.g., arranged on racks). An item may generally refer to any type of product that may be picked from the store (e.g., items for purchase by a customer and/or inventory included in a factory/warehouse). For example, an item may be a food product, a personal hygiene product, an electronic product, or any other product in inventory in the store.

The CCS, which may be located within/outside the store, may wirelessly transmit the customer orders to one or more of the MSDs. For example, the CCS may include wireless communication functionality (e.g., Bluetooth, IEEE 802.11, cellular, etc.) for wirelessly transmitting the customer orders to the MSDs. The MSDs, which may be transported throughout the store by users, may wirelessly receive the customer orders and display the customer orders to the users so that the users may fill the customer orders transmitted to the MSDs. In general, the users may be employees (e.g., store employees/contractors) that transport the MSDs around the store while filling the customer orders displayed on the MSDs. In some examples, the MSDs may be configured to be held in the users' hands. In other examples, the MSDs may be placed in carts (e.g., a shopping cart, basket, or similar cart for carrying items), which may be pushed around the store by users while the users gather items to fill customer orders. In still other examples, the MSDs may be configured to attach to a user (e.g., around the forearm of a user or as a display worn on a user's head). In some implementations, the CCS is present in a location other than the store. In these implementations, the CCS transmits the customer orders to the MSDs in a similar manner as described herein using any of a variety of different wireless transmission techniques (e.g., via the Internet and an intermediate computing device that is located within the store or via cellular communication).

In some cases, the customer may use an MSD owned by the store to pick their own customer orders. In some cases, the functionality of the MSD may be included on a CCD (e.g., a customer's smartphone). In these cases, the customer may place the order using their own CCD and then pick the order using their own CCD, which may have the functionality of an MSD described herein. In other cases, the customer may place their order using a first CCD (e.g., their laptop or desktop computer) and then pick the order using a second CCD (e.g., their smartphone).

The users may begin filling the customer orders by gathering (i.e., picking) the items displayed on the MSDs. After gathering the items, one or more of the users may assemble (e.g., pack) the customer orders from the gathered items (e.g., in a store packing area). Subsequently, the customer that placed the customer order with the CCS may receive the filled customer order. In some examples, the customer may pick up the filled customer order at the store. In other examples, the filled customer order may be delivered to the customer (e.g., at the customer's home).

Each of the items in the store may be associated with an item indicator (e.g., a barcode/sticker/RFID), which may be located along with the item, such as on the item (e.g., a barcode), attached to the item (e.g., a sticker/tag), or located with the item (e.g., an RFID tag within the item's box). In general, an item indicator may be any object or device that the MSDs/CCS can use to identify (e.g., uniquely identify) the item. For example, the item indicators may be barcodes or analogous indicators. In some examples, the MSDs may scan the item indicators (e.g., scan the barcodes) and identify the items based on the scanned item indicators. In other examples, the item indicators may generate item signals (e.g., via a RFID device). For example, the item indicators may wirelessly transmit the item signals. The MSDs may receive the transmitted item signals and determine one or more items located within the store based on the detected item signals. The item indicators may be scanned by the MSDs or transmit item signals in a variety of different ways. Similarly, the MSDs may be configured to scan the item indicators or detect the transmitted item signals in a variety of different ways. Examples of item indicators, item signals, and of scanning the item indicators or detecting the item signals by an MSD are described hereinafter in more detail. In some examples, an item indicator is associated with a single item. In other examples, an item indicator is associated with multiple items. In still other examples, multiple item indicators are associated with a single item.

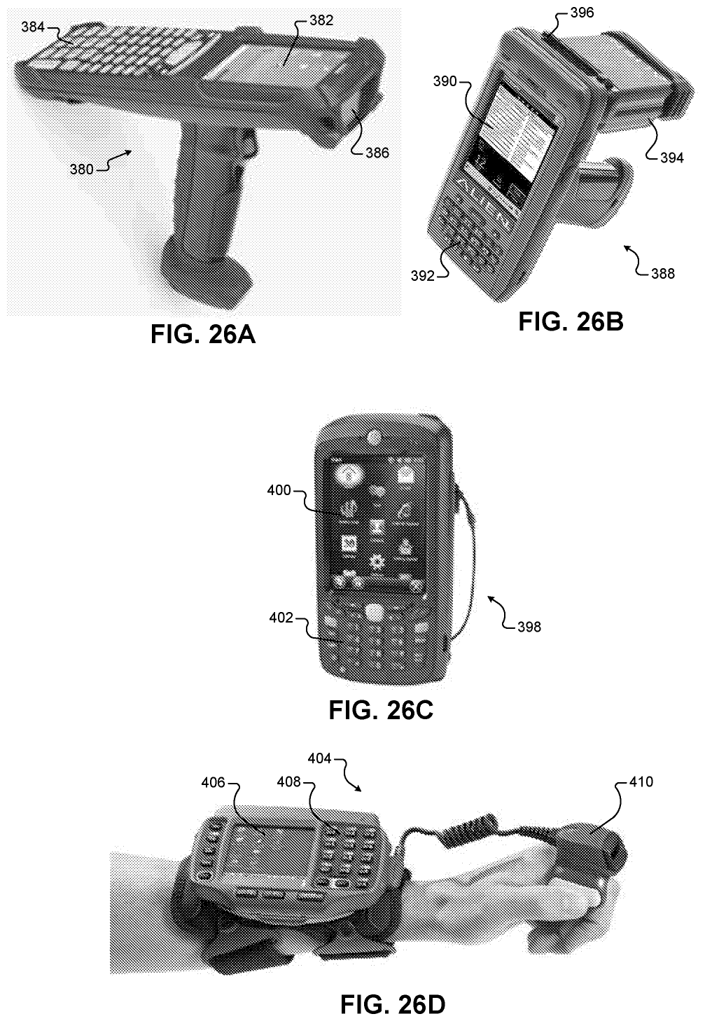

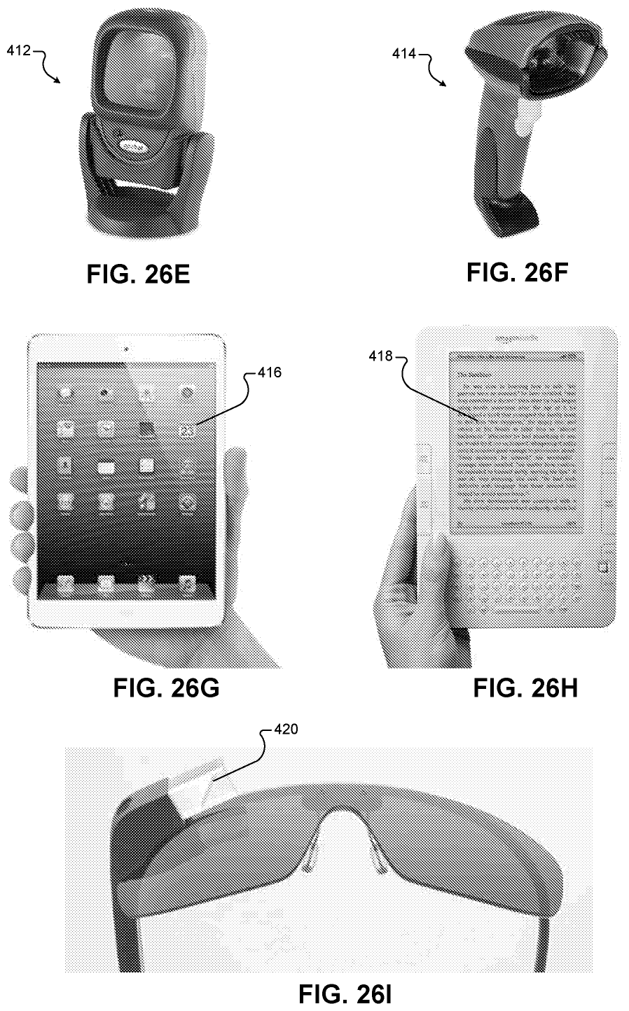

The MSDs may have a variety of different configurations. For example, the MSDs may have a variety of different form factors and different functionalities, depending on how the OFS is implemented in the store. As described herein, the MSDs may have handheld form factors and/or be configured to be placed in carts and pushed by a user. Example form factors are illustrated and described in FIGS. 26A-26I.

The MSDs may include wireless communication functionality (e.g., IEEE 802.11, Bluetooth, cellular, etc.) for communicating with the CCS, other MSDs, and/or other wireless devices. For example, the MSDs may receive customer orders wirelessly from the CCS/Internet and indicate to the CCS and/or other MSDs when items from the customer orders have been scanned.

An MSD may also include a display for displaying information to the user. In some examples, the display may be a liquid crystal display (LCD), an organic light-emitting diode (OLED) display, an electrophoretic display, or be implemented using other display technologies. For example, an MSD having a handheld form factor may include an LCD display. In other examples, an MSD having a head-mounted form factor may include a head-mounted display.

The MSD display may display the items of the customer orders to the users. Additionally, the MSD display may display information to the users other than the customer orders. The users may view the items on the display and subsequently pick the items from racks or other containers in the store. The users may then scan the items (e.g., scan barcodes on the items) and take the items to an area in the store (e.g., a collection/packing area) where the orders may be bagged for customer pickup or delivery.

A customer order may include one or more items. For example, an item included in a customer order may be any product that a customer may purchase at the store. In some examples, the customer order may include a plurality of grocery items, such as cereal, canned food, chicken, milk, ice cream, eggs, fruits, vegetables, etc. In some examples, a customer order may include other items available at a retail store, such as personal hygiene items (e.g., shampoo, razor blades, and soap). A customer order may also include items such as movies, videogames, and electronic devices.

An item indicator corresponding to an item located within the store may be associated with an item identification code (hereinafter, “item ID code”). An item ID code, as used herein, may generally refer to any code (e.g., alphanumeric or other type of code) that may be associated with an item located within the store that serves to identify that item (e.g., uniquely identifies the item). Each item in the store may be associated with, or identified by, an item ID code. In some examples, an item ID code corresponding to an item may be acquired by scanning an item indicator associated with the item, such as a barcode (e.g., 1 or 2 dimensional barcode) present on the item. The barcode may be printed on packaging of the item and/or or printed on a sticker attached to packaging of the item. In other examples, the item ID code may be retrieved from an item signal transmitted by the item indicator, such as an RFID device (e.g., an RFID tag or other RFID form factor) attached to packaging of the item and/or included in packaging of the item. In still other examples, the item ID code may be a number (e.g., a product look-up code) printed on the item indicator (e.g., an adhesive label attached to the item) that may be entered manually by a user. Such a code may be used to identify produce items (e.g., fruits and vegetables), for example.

An MSD may acquire an item ID code in a variety of different ways, depending on the type of item ID code associated with the item. As described herein, an item ID code may be acquired from a barcode, an RFID tag, or may be manually entered by a user. In some examples, an MSD may include a scanning module configured to scan barcodes to retrieve the item ID code. In some examples, an MSD may include a scanning module configured to acquire item ID codes from RFID tags. For example, as described herein, the MSD may scan/acquire an item ID code corresponding to a particular item by detecting an item signal transmitted by an RFID tag associated with the item. In some examples, an MSD may include a user interface (e.g., touchscreen and/or buttons) configured to receive user input, such as manually-entered item ID codes. Although an item ID code may be acquired via a barcode, an RFID tag, or be manually-entered in some examples, it is contemplated that other types of item ID codes and modes of acquisition may be implemented. It is also contemplated that an MSD may be configured to acquire other types of item ID codes.

A customer order may be identified by a customer order identification number (hereinafter, “order ID number”). An order ID number may generally refer to any code (e.g., alphanumeric or other type of code) that may be associated with a customer order that serves to identify that customer order (e.g., uniquely identifies the customer order). In some examples, the CCS may assign each customer order a different order ID number that may uniquely identify that customer order. Each of the items included in the customer order may also be associated with the order ID number.

A store may include location indicators that indicate locations in the store. In some implementations, location indicators may transmit location signals that indicate the location within the store, such as a location within an aisle. In some implementations, location indicators (e.g., readable location indicators) may be objects (e.g., printed barcodes) including codes that indicate a location within a store. An MSD may scan (e.g., read) a readable location indicator to determine a location in the store associated with the location indicator.

The CCS and/or MSDs may generate item association tables that indicate the location of items relative to location indicators. For example, the item association tables may include items and associated location values determined from the location indicators near the items. The CCS and/or MSDs may also generate location maps that indicate how areas associated with location indicators (e.g., near location indicators) are arranged relative to one another in the store. The CCS and/or MSDs may map the store using the item association tables and location maps. The MSDs may use the item association tables and location maps to efficiently pick items from customer orders.

Additionally, or alternatively, the CCS and/or MSDs may generate item adjacency maps that indicate the location of items relative to one another. In some cases, the CCS and/or MSDs may generate the item adjacency maps based on scan times between consecutively scanned items. For example, scanning two items within less than a threshold amount of time may indicate that the items are near each other (e.g., less than a threshold distance from one another). The CCS and/or MSDs may generate and update item adjacency maps to indicate the items that are adjacent to one another. The CCS and/or MSDs may map the store using the item adjacency maps alone, or in combination with the item association tables and location maps. The CCS and/or MSDs may also use the item adjacency maps alone, or in combination with the item association tables, to efficiently pick items from customer orders.

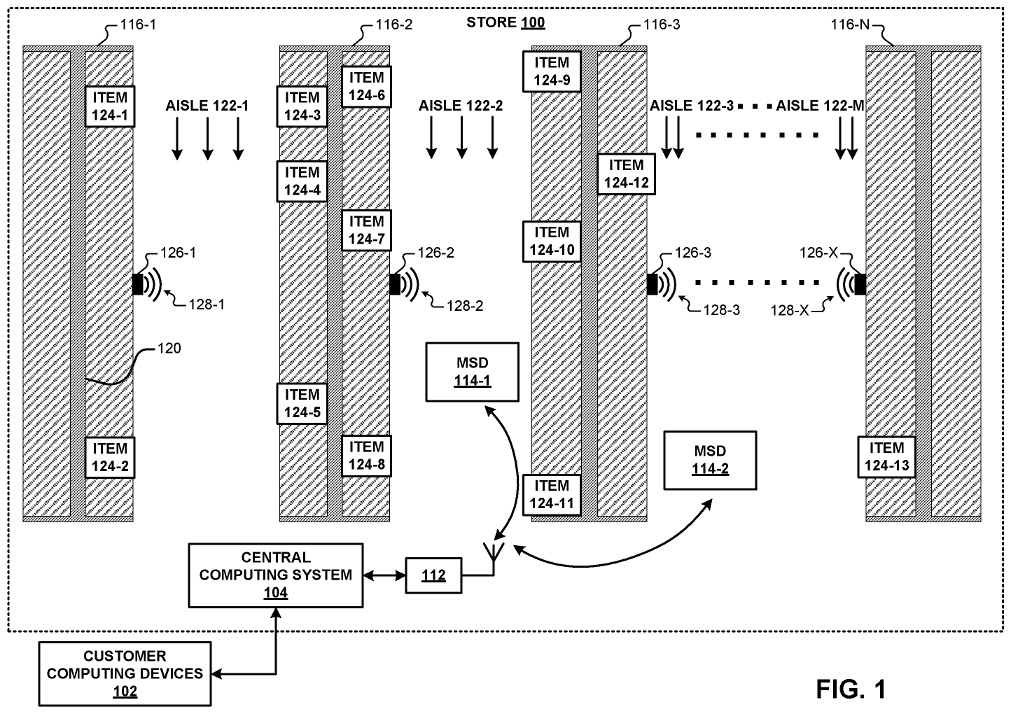

FIG. 1 shows an example implementation of an OFS implemented in a store 100. Store 100 is illustrated as a dotted box. Store 100 may represent any building structure that may house the items described herein. Although store 100 is generally described herein as a grocery store, supermarket, big-box store, hypermarket, etc., it is contemplated that the systems and methods for filling orders described herein may be applicable to other types of businesses and buildings, such as warehouses (e.g., a manufacturer or retailer warehouse), factories, distribution centers (e.g., a manufacturing or retail company distribution center), convenience stores, shopping plazas, or outdoor markets.

Customers may place customer orders to have filled at store 100 using CCDs 102. A CCS 104 may receive the customer orders from CCDs 102. A CCD 102 may include any electronic device that a customer may use to place a customer order. For example, a CCD 102 may include a desktop computer or a mobile computing device such as a laptop computer, smart phone, or tablet computer. In some examples, CCDs 102 may be devices that are located external to store 102. In these examples, CCS 104 may be configured to receive the customer orders from CCDs 102 via the Internet, or other computer network. In other examples, CCDs 102 may be located in store 100. For example, CCDs 102 may be mobile computing devices that customers have brought into store 100. As an additional example, store 100 may include CCDs 102 (e.g., desktops or kiosks) that may be used by the customers to place customer orders.

CCS 104 may implement a variety of different functions. In general, CCS 104 may refer to one or more of a variety of computing devices configured to provide the functionality described herein. For example, CCS 104 may include computer networks, servers (e.g., web servers), data stores, routers, software, etc. Although CCS 104 is illustrated as included in store 100 (e.g., FIG. 1), a portion of CCS 104, or all of CCS 104, may be located outside of store 100 in some examples. Put another way, CCS 104 may include one or more different computing devices that are located at one or more locations within or outside of store 100.

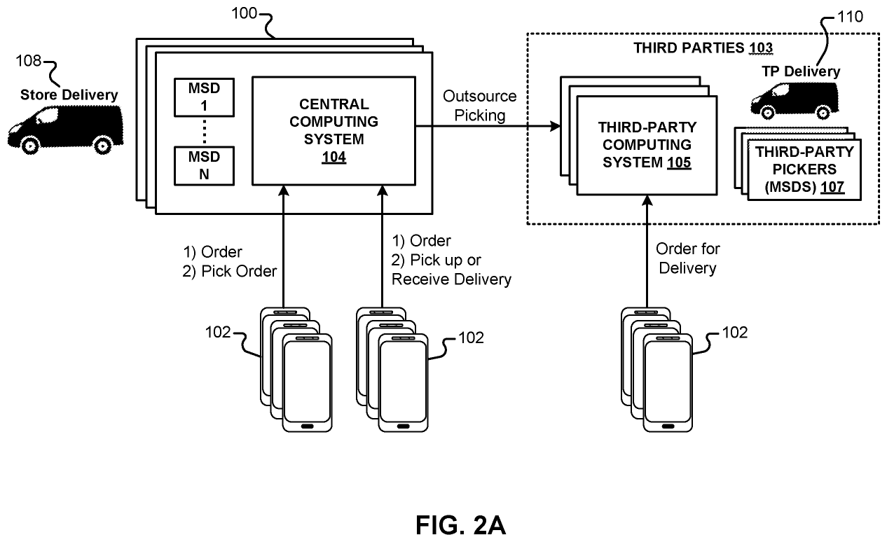

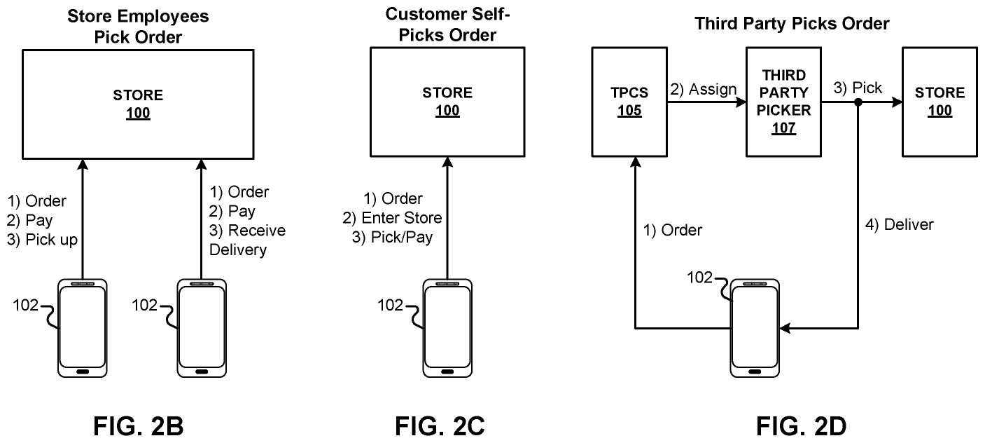

Referring to FIG. 2A, CCS 104 may be configured to communicate with a plurality of CCDs 102 via a computer network (e.g., the Internet). CCS 104 may provide electronic commerce (i.e., ecommerce) functionality so that customers may use CCDs 102 to place customer orders with store 100. In some examples, CCS 104 may provide online shopping functionality. For example, CCS 104 may provide a shopping website to CCDs 102 or provide other data to an application running on CCDs 102 so that customers may place electronic customer orders with store 100 using CCDs 102. The shopping website or other data provided to CCDs 102, may include information related to items the customer may order at store 100, such as item names, prices, availability, and reviews.

A customer may place an electronic customer order that includes one or more items. In some examples, the customer may place a customer order via a website accessed using a CCD 102. In other examples, a customer may place a customer order via a dedicated software application (e.g., an “app”) running on a CCD 102, such as a mobile phone or a tablet computer. CCS 104 may be configured to accept payment for the customer order (e.g., using a credit card). Additionally, or alternatively, a customer may pay for the customer order in store 100 (e.g., using a credit card, check, or cash).

After a customer order is placed, CCS 104 may transmit (e.g., wirelessly transmit) the customer order to one or more MSDs. The users in store 100 may then pick each of the items of the customer order and pack the items of the customer order for customer pickup or delivery. In some examples, CCS 104 may notify the customer that the customer order has been picked by sending a notification to a CCD 102 (e.g., a text message, email, and/or notification via a shopping application).

FIG. 2A illustrates a plurality of stores 100 that may each include a CCS 104 and MSDs for picking items. In some implementations, third parties 103 (e.g., business other than the store) may operate third-party computing systems 105 (“TPCS 105”) that include similar functionality as the CCS 104. TPCS 105 may be configured to communicate with CCDs 102 via a computer network (e.g., the Internet). TPCS 105 may provide electronic commerce (i.e., ecommerce) functionality so that customers may use CCDs 102 to place customer orders with the third parties. For example, TPCS 105 may provide online shopping functionality, such as a shopping website or other application running on CCDs 102 so that customers may place electronic customer orders with the third parties using CCDs 102. A customer may place an electronic customer order that includes one or more items with TPCS 105.

After a customer order is placed with TPCS 105, TPCS 105 may transmit the customer order to one or more third-party MSDs 107 being used by third-party pickers (e.g., employees/contractors of the third-party businesses). The third-party MSDs 107 may include similar form factors and functionality as MSDs used by the store 100. For example, third-party MSDs 107 may include personal computing devices (e.g., smartphones or tablets) and/or specific hardware for picking customer orders. The third-party pickers may be located remotely from the store 100 when the customer order is received. In these cases, third-party MSDs 107 may receive customer orders via the Internet or other communication system. After receiving a customer order, a third-party picker may pick each of the items of the customer order and pack the items of the customer order for delivery by the third party. For example, the third-party picker may deliver the picked order or have another third party delivery service 110 deliver the order. In some cases, a customer may pick up an order at the store 100 that was picked by a third party. In some examples, TPCS 105 may notify the customer that the customer order has been picked by sending a notification to a CCD 102.

FIGS. 2A-2D illustrate a plurality of scenarios in which customer orders may be picked by one or more parties. In one example, a customer may use a CCD 102 to place a customer order with the CCS 104 and subsequently pick the order from the store. In this example, the customer may use their CCD that placed the customer order (or another CCD) as an MSD to pick the order. Alternatively, a customer may use an MSD provided by the store to pick their own order. In another example, a customer may use a CCD to place a customer order with the CCS that is then picked by users (e.g., employees) in the store 100. The customer may then pick up the filled customer order or have the order delivered. FIGS. 2B-2C further illustrate these scenarios.

In another example, the customer may use a CCD 102 to place a customer order with a TPCS 105. The TPCS 105 may assign the order to a third-party MSD 107 (e.g., a third-party picker) that may pick the items from the store 100. The third-party picker may then deliver the filled customer order to the customer. FIG. 2D further illustrates the scenario of a third-party picking service being used by the customer. FIG. 2A illustrates another example scenario in which the customer places a customer order with the CCS 104, and the CCS 104 subsequently outsources the picking of the order to a third party via the TPCS 105.

Note that FIG. 2A illustrates a plurality of delivery options. In some implementations, the store 100 may operate a delivery service 108 that delivers customer orders to the customers. In other implementations, the third-party pickers 107 may deliver the customer orders to the customers. In other implementations, third parties may operate delivery services 110 (e.g., delivery-only services) that deliver customer orders for the store 100 and/or other third-party pickers.

The various features (e.g., mapping/picking) of the OFS attributed to the CCS and/or MSDs herein may also be provided by the TPCS, third-party MSDs, and CCDs. For example, the TPCS may receive customer orders, store one or more tables and maps for one or more stores, and send the tables and maps to store MSDs, third-party MSDs, and/or CCDs. As another example, any features of the CCS and/or MSDs described herein, such as processing and communication features, may be implemented by the TPCS and/or the third-party MSDs. As another example, the CCS and/or TPCS may communicate with the MSDs, third-party MSDs, and/or CCDs in a similar manner described herein with respect to the CCS and the MSDs.

Referring back to FIG. 1, the OFS may include a wireless communication system 112 (hereinafter “communication system 112”) configured to provide wireless communication functionality within store 100. Communication system 112 may represent electronic hardware and software that provides wireless communication functionality with a plurality of wireless devices within store 100. For example, communication system 112 may include one or more wireless routers, antennas, and other devices that facilitate communication with wireless devices in store 100. In some examples, communication system 112 may provide wireless communication using Bluetooth, IEEE 802.11, and/or another wireless communication technology. In some examples, the one or more MSDs may communicate via a communication system that includes components that are external to store 100, such as via cellular communication.

The OFS includes one or more MSDs (e.g., MSD 114-1 and/or MSD 114-2). MSD 114-1 and MSD 114-2 may be referred to collectively as “MSDs 114.” MSDs 114 may be transported throughout store 100 by users. Although two MSDs 114 are illustrated in FIG. 1, it is contemplated that more than two MSDs may be included in the OFS of the present disclosure. It is also contemplated that only a single MSD may be used in some implementations of the OFS of the present disclosure.

Communication system 112 may communicate with MSDs 114. For example, communication system 112 may transmit data (e.g., customer orders) to MSDs 114 and receive data from MSDs 114. Communication system 112 may also communicate with CCS 104. For example, communication system 112 may receive data from CCS 104 and transmit the received data to MSDs 114. As another example, communication system 112 may receive data from MSDs 114 and transmit data to CCS 104. Accordingly, MSDs 114 may communicate (e.g., transmit/receive data) with CCS 104 via communication system 112. In some implementations, CCS 104 may communicate with MSDs 114 via communication systems outside of store 100, such as via cellular communication.

In some implementations, the users (e.g., pickers) and their MSDs (e.g., cell phones) may be located outside of the store. For example, the users may be employees of the store that are offsite performing other services, such as delivering filled orders. As another example, the users may be store employees/contractors that pick/deliver items for the one or more stores. In these cases, a user MSD may receive a customer order from the Internet (e.g., via a cellular connection) and use their MSD (e.g., cell phone) in the store to pick the customer order.

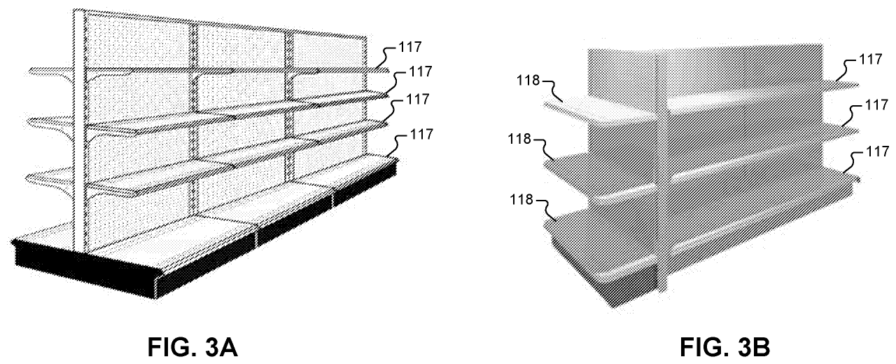

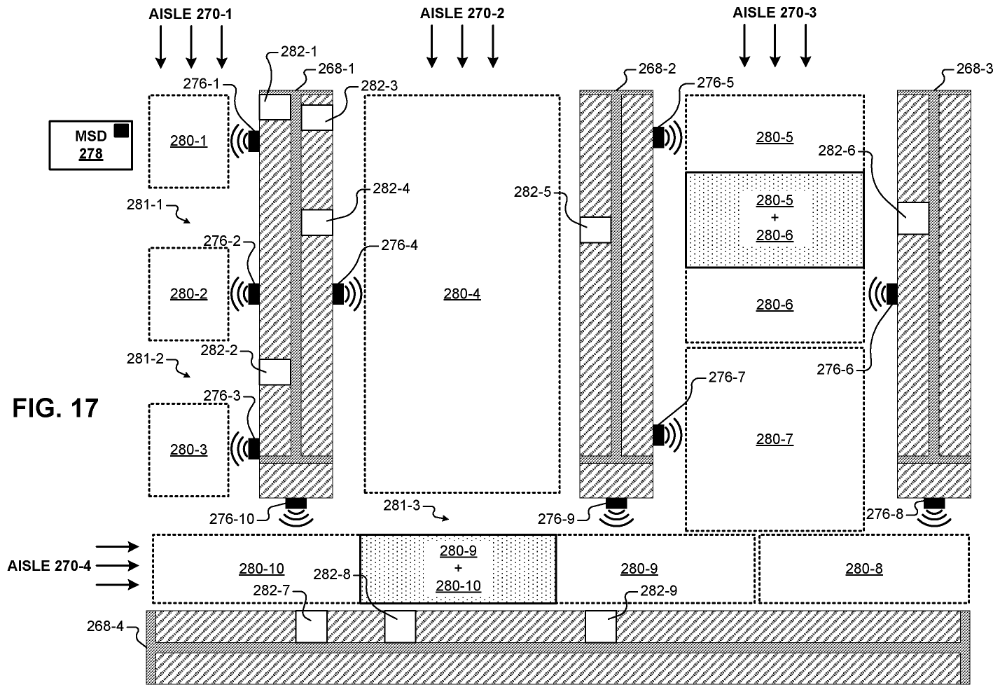

Store 100 includes racks 116-1, 116-2, 116-3, . . . , and 116-N (collectively “racks 116”). Racks 116 may represent any type of structure used to hold items. Racks 116 in FIG. 1 are illustrated from a top down perspective. The material (e.g., metal) that forms racks 116 is represented by gray shaded areas. Space on racks 116 for the storage of items is illustrated as hashed regions. In some figures (e.g., FIG. 1), specific items included in customer orders are illustrated and labeled (e.g., items 124-1 to 124-13 in FIG. 1). Illustrations of racks 116 herein are meant to represent a top down view of racks/shelving that are typically found in retail and grocery stores. Example 3D perspective views of racks 116 are shown in FIG. 3A and FIG. 3B. FIG. 3A shows a perspective view of racks 116 illustrated in FIG. 1 that include space on shelves 117 for storage of items. FIG. 3B shows a similar rack that includes shelves 117 and an end portion 118. The rack shown in FIG. 3B is illustrated in a top down perspective in FIG. 17, for example.

Racks (e.g., racks 116) described herein are not limited to the types of racks illustrated in FIG. 3A and FIG. 3B. Instead, racks 116 may represent any type of structure used to hold items, such as shelving, bins, baskets, pallets, and hooks. Racks 116 may also represent refrigerated storage units including, but not limited to, beverage refrigerators, display coolers/freezers, and walk-in refrigerators/freezers. In some examples, racks 116 may be mobile. For example, racks 116 may include pallets or carts having wheels.

Each of racks 116 illustrated in FIG. 1 include space for items (hashed regions) and a dividing portion (e.g., dividing portion 120 of rack 116-1) that divides the spaces for items. The hashed regions of racks 116 represent one or more shelves on which items may be placed. The number of shelves included on a rack may vary. In some examples, racks may include a single shelf. In other examples, racks may include a plurality of shelves which may be spaced evenly from one another or may be variably spaced. The dividing portions (e.g., portion 120) of racks may separate the shelves. Typically, when items on one side of a rack are accessible to a user, items on the other side of the rack are out of reach of the user due to the dividing portion.

Store 100 may include open floor space where a user (e.g., store employee and/or store customer) may move. In some examples, open floor space between racks may be referred to as aisles, such as aisles 122-1, 122-2, . . . , and 122-M (collectively “aisles 122”). Although FIG. 1 illustrates racks 116 as linear and illustrates aisles 122 as linear portions of open floor space defined by racks 116, it is contemplated that store 100 may include racks and aisles having a variety of different geometries. The techniques of the present disclosure are not limited to any specific type of rack and aisle layout, but instead, the techniques may be implemented in any variety of different rack and aisle layouts.

As described above, the hashed regions on racks 116 illustrate space on racks where items are stored. Some portions of the hashed regions on racks 116 include white boxes labeled with item numbers. For example, racks 116 include items 124-1 to 124-13. The boxes labeled as items 124-1 to 124-13 illustrate the location of items on shelves. For example, items 124-1, 124-2, 124-3, 124-4, 124-5 are included on rack 116-1 and rack 116-2. Items 124-1, 124-2, 124-3, 124-4, 124-5 are accessible by a user that is located in aisle 122-1. Similarly, items 124-6, 124-7, . . . , 124-11 are accessible by a user that is located in aisle 122-2.

Similar types of items may be grouped together along an aisle in a typical store. For example, the items located along aisle 122-1 (i.e., the items accessible in aisle 122-1 from rack 116-1 and rack 116-2) may be items of a similar type. In one example, the items along aisle 122-1 may be cereal items (e.g., bags or boxes of cereal). In another example, items along aisle 122-1 may be beverage items such as soft drinks and water. In another example, items along aisle 122-1 may be frozen items such as frozen entrees, pizzas, and ice cream. In examples where items along aisle 122-1 are frozen items, rack 116-1 and rack 116-2 may be refrigerated storage units (e.g., display coolers/freezers). Although the techniques of the present disclosure may be implemented in stores in which similar types of items are grouped together (e.g., in a typical grocery store), the techniques of the present disclosure do not require that similar types of items be grouped along the same aisle.

Store 100 includes location indicators 126-1, 126-2, 126-3, . . . , and 126-X (collectively “location indicators 126”). Location indicators 126 may include any device or object that indicates a location in store 100. In some examples, location indicators 126 may indicate a location within store 100 by transmitting location signals that indicate the location within store 100. For example, location indicator 126-1 may transmit location signal 128-1 that may indicate a location within aisle 122-1. Similarly, location indicator 126-2 may transmit location signal 128-2 that may indicate a location within aisle 122-2. Although location signals (e.g., 128-1, 128-2) are illustrated as transmitted in a cone radiation pattern having approximately a 90 degree angle, the illustration of location signals (e.g., 128-1, 128-2) in this manner is merely meant to indicate that location indicators of the present disclosure are transmitting/emitting signals. It is contemplated that the location signals may be transmitted in a variety of different radiation patterns and distances. Additionally, the location indicators described herein may be mounted to racks, or other structures (e.g., walls, floors, ceilings), at different angles in order to direct the transmission of location signals in different directions.

In other examples, location indicators may be objects (e.g., printed barcodes) including codes that indicate a location within a store. For example, location indicator 126-1 may be replaced by a location indicator including a code (e.g., a printed barcode) indicating a location within aisle 122-1. Similarly, location indicator 126-2 may be replaced by a location indicator including a code (e.g., a printed barcode) indicating a location within aisle 122-2. Such location indicators including codes (e.g., barcodes) may be scanned by MSDs (e.g., using barcode scanners included in the MSDs).

MSDs 114 may be configured to determine a location within store 100 in a variety of different ways, depending on the type of device or object used as a location indicator. In examples where location indicators 126 wirelessly transmit location signals that indicate a location within store 100, MSDs 114 may be configured to acquire the location signals and determine locations within store 100 based on the acquired location signals. In examples where location indicators are objects that include codes (e.g., barcodes), MSDs 114 may be configured to scan the codes on the location indicators and determine a location within store 100 based on the scanned codes.

Location indicators 126 may be configured to transmit location signals using any type of wireless transmission technology. In some examples, location indicators 126 may include an antenna (e.g., a metal antenna) that transmits location signals. In some examples, location indicators 126 may include a light emitting device (e.g., an LED or other photonic devices) that transmit location signals. In some examples, location indicators 126 may include an acoustic device that transmits location signals (e.g., sound waves).

The distance over which location indicators 126 transmit location signals 128, and the area covered by location signals 128, may vary depending on a variety of different factors including, but not limited to, the amount of power used to generate location signals 128, the location of location indicators 126 within store 100, and the technology included in location indicators 126 (e.g., an antenna, an LED, or acoustic device). In some examples, location indicators 126 may be configured to transmit location signals 128 over a relatively short distance and a small area within store 100. In other examples, location indicators 126 may be configured to transmit location signals 128 over longer distances and larger areas within store 100. For example, location indicators 126 may be configured to transmit location signals 128 from a few centimeters up to distances of tens of meters (e.g., 100 meters). In some examples, location indicators 126 may transmit location signals 128 along the length of an aisle or even across the length of store 100.

Location indicators 126 may transmit location signals 128 in a variety of different patterns which are described hereinafter with respect to location indicator 126-1. In some examples, location indicator 126-1 may transmit a location signal 128-1 along a line. For example, location indicator 126-1 may include a laser that transmits a laser beam along a straight line. In other examples, location indicator 126-1 may include an antenna that radiates location signal 128-1 in a directional manner. For example, location indicator 126-1 may include an antenna that radiates location signals having lobes and nulls. In other examples, location indicator 126-1 may transmit location signal 128-1 in nearly all directions. For example, location indicator 126-1 may include an antenna that generally radiates in all directions, or an LED that emits light in nearly all directions. It is contemplated that the directionality and power of the location signals may be adjusted to adjust the area of store 100 covered by the location signals. For example, the amount of power used to generate a location signal may be increased in order to transmit the location signal a greater distance.

The location of location indicators 126 within store 100 may affect the distance and area covered by location signals 128. As described herein, location indicators 126 may be placed in a variety of different locations in store 100. For example, location indicators 126 may be attached to the walls of store 100, mounted on shelves (e.g., near the floor or head height), placed on the floor, mounted overhead of the users, connected to the ceiling, or located at any other location within store 100.

Referring to FIG. 1, location indicator 126-1 transmits location signal 128-1 into aisle 122-1. Location indicator 126-1 is illustrated as connected to rack 116-1. Location indicator 126-1 may be connected to rack 116-1 in a variety of different locations. In some examples, location indicator 126-1 may be attached to, or placed on, any one of a plurality of shelves of rack 116-1. In some examples, location indicator 126-1 may be placed where rack 116-1 meets the floor. In other examples, location indicator 126-1 may be connected to rack 116-1 overhead of users. For example, rack 116-1 may include a piece that overhangs aisle 122-1. Although location indicators 126 are illustrated as connected to racks 116 in FIG. 1, location indicators 126 may be placed in other locations (e.g., on the floor, attached to the ceiling, etc.).

The area covered by location signals 128 may depend on the location of location indicators 126. With respect to FIG. 1, if location indicator 126-2 is attached to a shelf of rack 116-2, location signal 128-2 may be transmitted throughout aisle 122-2. In other words, if location indicator 126-2 is attached to a shelf of rack 116-2, location signal 128-2 may cover some or all of aisle 122-2. Depending on the directionality and power of location signal 128-2, location signal 128-2 may cover only a portion of aisle 122-2, or may cover all of aisle 122-2 and even spill outside of aisle 122-2 to floor space adjacent to aisle 122-2. If location indicator 126-2 is attached to a shelf of rack 116-2, location signal 128-2 may not penetrate racks 116-2, 116-3 and/or the items on racks 116-2, 116-3 in some examples. In these examples, location signal 128-2 may not cover floor space in aisles 122-1 and 122-3, and, therefore, location signal 128-2 may not be detectable in these areas in some examples. In other examples, location signal 128-2 may be detectable in aisles 122-1, 122-3. For example, location signal 128-2 may penetrate racks 116-2, 116-3 and items on racks 116-2, 116-3 such that location signal 128-2 covers some area in aisles 122-1, 122-3. As an additional example, location signal 128-2 may be detectable by MSDs 114 in aisles 122-1, 122-3 if gaps exist in racks 116-2, 116-3 and between items on racks 116-2, 116-3. Furthermore, in some examples, location signal 128-2 may be detectable by MSDs 114 in aisles 122-1, 122-3 if location signal 128-2 exits aisle 122-2 and reflects back into aisles 122-1, 122-3.

The location indicators may be arranged throughout the store. In general, a location indicator may be any object or device that indicates a location within the store. In some examples, the location indicators may generate location signals. For example, the location indicators may wirelessly transmit the location signals. The MSDs may receive the transmitted location signals and determine a location within the store based on the detected location signal(s). The location indicators may transmit location signals and the MSDs may be configured to detect the transmitted location signals in a variety of different ways. Although the location indicators may transmit location signals in some examples, in other examples, the location indicators may be objects that may be read by the MSDs. For example, the location indicators may be barcodes attached to racks in the store. Furthermore, although the MSDs may determine a location within the store based on location signals generated by location indicators within the store, in other examples, the MSDs may determine a location within the store in response to signals generated outside of the store, such as in response to global positioning system (GPS) signals received from GPS satellites. In still other examples, the MSDs may determine a location within the store using other techniques and technologies. For example, the MSDs may determine a location using a Wi-Fi signal transmitted within the store.

The MSDs may be configured to detect the location signals transmitted from the location indicators and perform various operations in response to detecting the location signals. A location signal received by an MSD may be thought of as indicating a particular location within the store. For example, assuming that a first aisle of the store includes a first location indicator that transmits a first location signal and a second aisle includes a second location indicator that transmits a second location signal, an MSD may determine that the MSD is located in the first or second aisle when the MSD detects the first or second location signal, respectively. The location signals may also be thought of as indicating which items included in the store are in proximity to an MSD at a given time. For example, since each of the items in the store may be associated with one or more location signals (i.e., a location value), an MSD may, upon detection of a location signal, determine which one or more of the items are in the vicinity of the MSD. As described herein, based on this determination, the MSD may further arrange items included in a customer order on a display of the MSD.

Using location indicators and/or location signals, an MSD may determine a location within, or outside of, the store. In some examples, an MSD may determine a location value based on detected location signals. As described herein, a location value may generally refer to any value or plurality of values (e.g., alphanumeric values) determined by an MSD that indicate a location of the MSD within, or outside of, the store. A location value determined by an MSD based on a location indicator and/or a location signal may depend on the types of location indicators and/or location signals used in the store.

An MSD may acquire location signals from location indicators as the MSD is transported throughout the store by a user. The location indicators may be set up throughout the store in various configurations. In some examples, the location indicators are set up such that the MSD picks up a location signal at any location within the store. In these examples, the location indicators are set up such that the location signals generated by the location indicators overlap to varying degrees and an MSD may acquire multiple location signals simultaneously in some locations. Additionally, or alternatively, the location indicators may be arranged such that the location signals do not quite overlap, but instead abut one another or are separated by a short distance. In these examples, an MSD may detect a first location signal in a first location and then abruptly detect a second location signal upon moving out of range of the first location signal. In other examples, the location indicators are set up such that an MSD does not pick up location signals at some locations within the store. In these examples, there may be dead zones in which an MSD may not acquire location signals because location signals may be absent, or not be sufficiently strong. Various configurations of location indicators within a store are illustrated and described herein.

In some implementations, the techniques of this disclosure may make use of location indicators and/or location signals in conjunction with the item indicators, item signals, and/or an item adjacency map. As described herein, an MSD may perform a variety of different operations based on a location and a corresponding location value determined by the MSD, irrespective of whether the location and location value are determined using location indicators/signals alone or in conjunction with item indicators/signals.

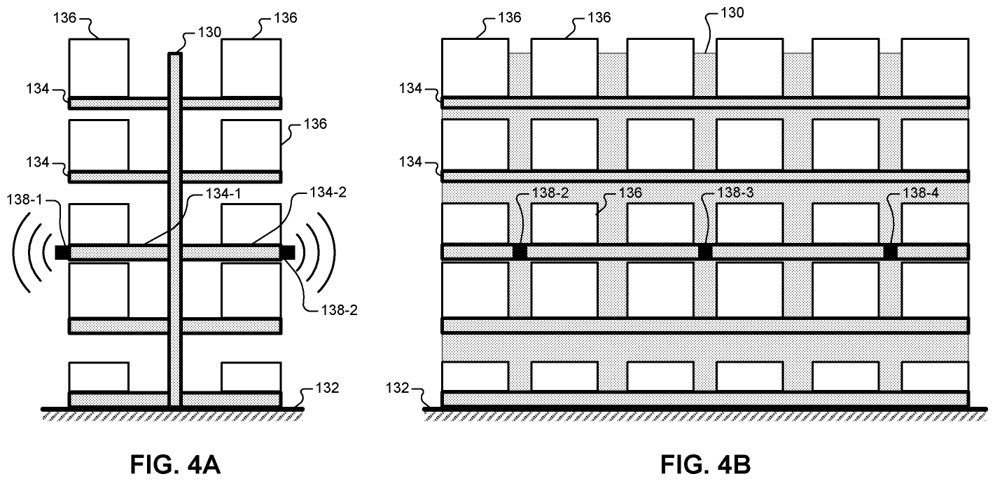

FIGS. 4A-9 show example racks including location indicators in different locations. FIGS. 4A-4B show an example rack 130 on floor 132. Rack 130 includes shelves 134. Items 136 (illustrated as white boxes) are arranged on shelves 134. In some implementations, rack 130 may be approximately 6 feet high. Shelves 134 may be approximately 1-2 feet apart. FIG. 4A shows a view of rack 130 from the end of rack 130 such that rack 130 would extend into and out of the page. FIG. 4B shows a view of rack 130 as would be viewed from an aisle.

In FIGS. 4A-4B, location indicators 138-1, 138-2, 138-3, 138-4 are attached to shelves 134-1, 134-2. Shelves 134-1, 134-2 may be approximately waist height (e.g., approximately 3 feet from floor 132). Accordingly, location indicators 138-1, 138-2 are located at approximately waist height and may transmit location signals from approximately waist height.

Location indicators of the present disclosure may be arranged along racks at a variety of different distances. With respect to FIG. 4B, location indicators 138-2, 138-3, 138-4 are evenly separated along rack 130. Although location indicators 138-2, 138-3, 138-4 are evenly separated in FIG. 4B, in other examples, location indicators 138-2, 138-3, 138-4 may be separated by varying distances. Although 3 location indicators 138-2, 138-3, 138-4 are illustrated in FIG. 4B, in some examples, more or less than 3 location indicators may be arranged along rack 130.

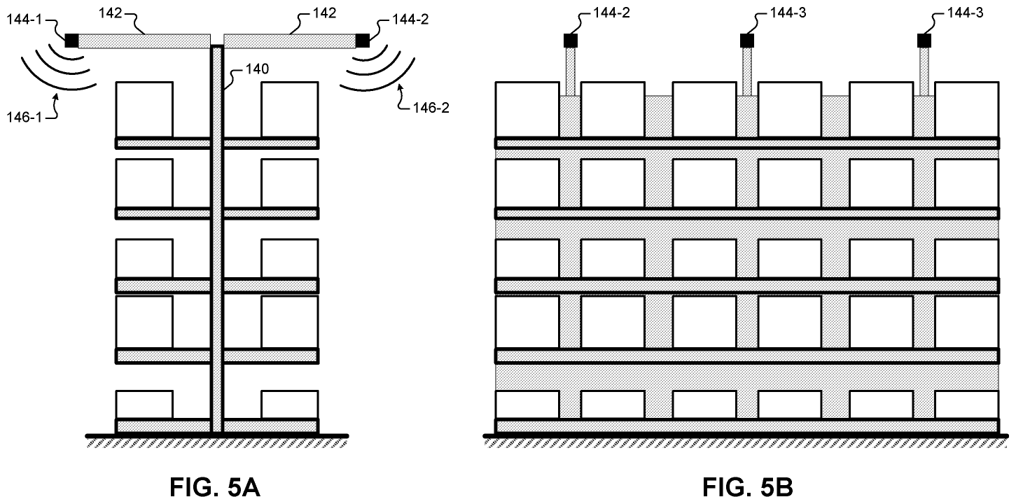

FIGS. 5A-5B show another example arrangement of location indicators along a rack. In FIGS. 5A-5B, rack 140 includes supporting members 142 configured to hold location indicators 144-1, 144-2, 144-3, 144-4 above rack 140 (e.g., over customer heads). In some examples, supporting members 142 may include metal rods that may be connected (e.g., clamped) to rack 140. Supporting members 142 may also be used to hold other objects, such as signs indicating what items are included in the aisle. Location indicators 144-1, 144-2, 144-3, 144-4 are connected to supporting members 142 and configured to generate location signals (e.g., 146-1, 146-2) that cover areas of the store adjacent to rack 140. For example, location indicators 144-1, 144-2, 144-3, 144-4 may be configured to point downward toward areas adjacent to rack 140 such that an MSD located in the aisle adjacent to rack 140 may detect one of location signals 146-1, 146-2.

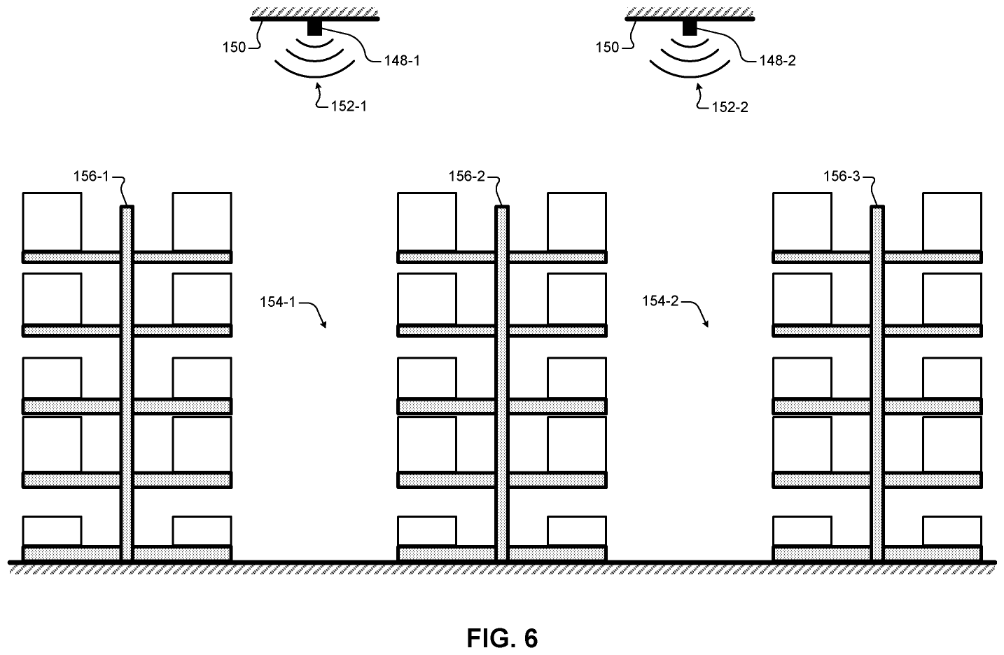

FIG. 6 shows another example arrangement of location indicators in which location indicators are located above racks. For example, location indicators 148-1, 148-2 may be attached to ceiling 150 (e.g., rafters or lighting) of the store. In this example, location indicators 148-1, 148-2 may transmit location signals 152-1, 152-2 into aisles 154-1, 154-2 between racks 156-1, 156-2, 156-3. In some implementations, lighting in the store may implement similar functionality as the location indicators (e.g., lighting may transmit location signals in a manner that is not perceptible by a user).

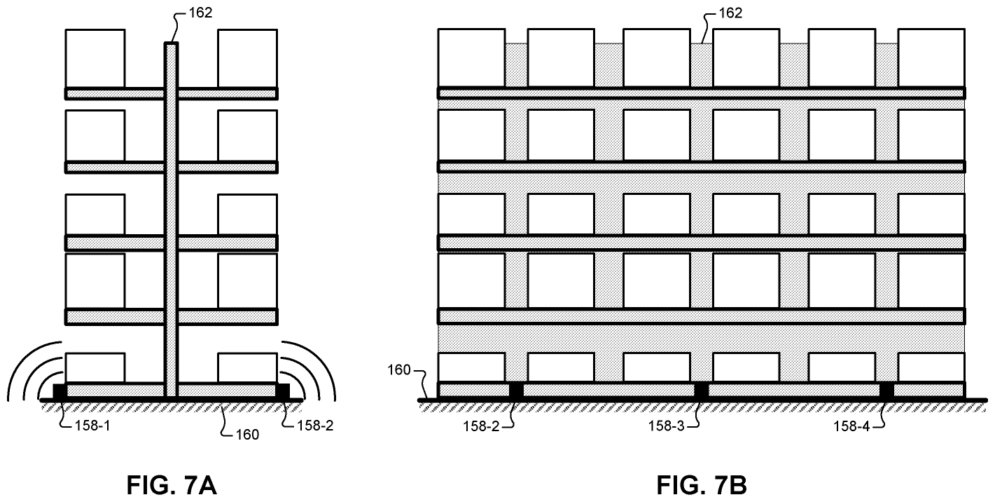

FIGS. 7A-7B show another example arrangement of location indicators. In FIGS. 7A-7B, location indicators 158-1, 158-2, 158-3, 158-4 are located near floor 160. For example, location indicators 158-1, 158-2, 158-3, 158-4 may be attached to the bottom shelves of rack 162 or connected to floor 160 near the bottom of rack 162. In some examples, location indicators 158-1, 158-2, 158-3, 158-4 may be embedded in floor 160. Although location indicators 158-2, 158-3, 158-4 are evenly separated in FIG. 7B, in other examples, location indicators 158-2, 158-3, 158-4 may be separated by varying distances. Although 3 location indicators 158-2, 158-3, 158-4 are illustrated in FIG. 7B, in some examples, more or less than 3 location indicators may be arranged along rack 162.

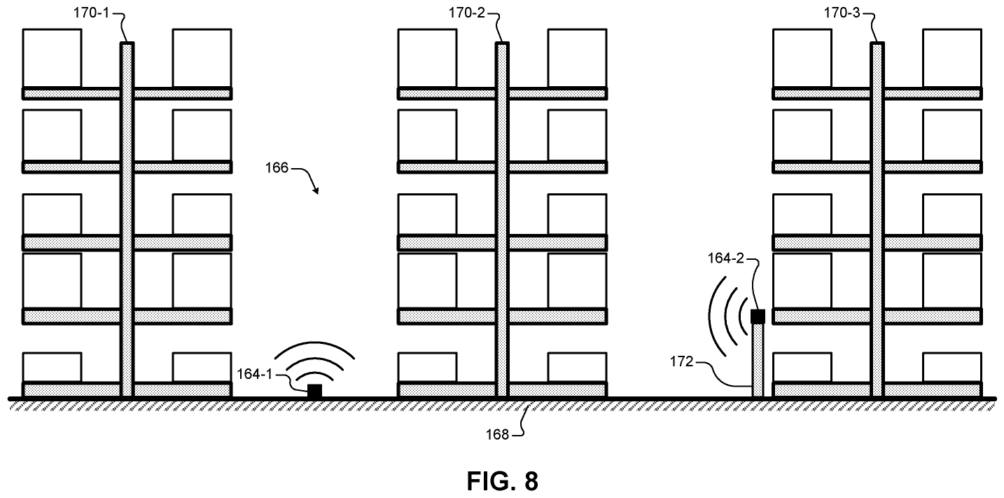

FIG. 8 shows other example arrangements of location indicators. In FIG. 8, location indicator 164-1 is located in aisle 166 on floor 168. Although location indicator 164-1 is illustrated as centrally located in aisle 166, location indicator 164-1 may instead be located nearer to one of racks 170-1, 170-2. Location indicator 164-1 may be attached to the surface of floor 168 in some examples. In other examples, location indicator 164-1 may be embedded in floor 168. For example, location indicator 164-1 may be embedded flush with floor 168 or embedded under floor 168 such that location indicator 164-1 is not visible.

In FIG. 8, location indicator 164-2 is connected to a supporting member 172. Supporting member 172 may rest on floor 168 or be connected to floor 168. Supporting member 172 may be a pole, tripod, or other device configured to hold location indicator 164-2. Accordingly, supporting member 172 may be configured to hold location indicator 164-2 at one end and connect to floor 168, or rest on floor 168, at the other end. Using supporting member 172 to hold location indicator 164-2 may allow placement of location indicator 164-2 in any location within the store, regardless of the location of racks, walls, or other structures in the store that may also be used for mounting location indicator 164-2.

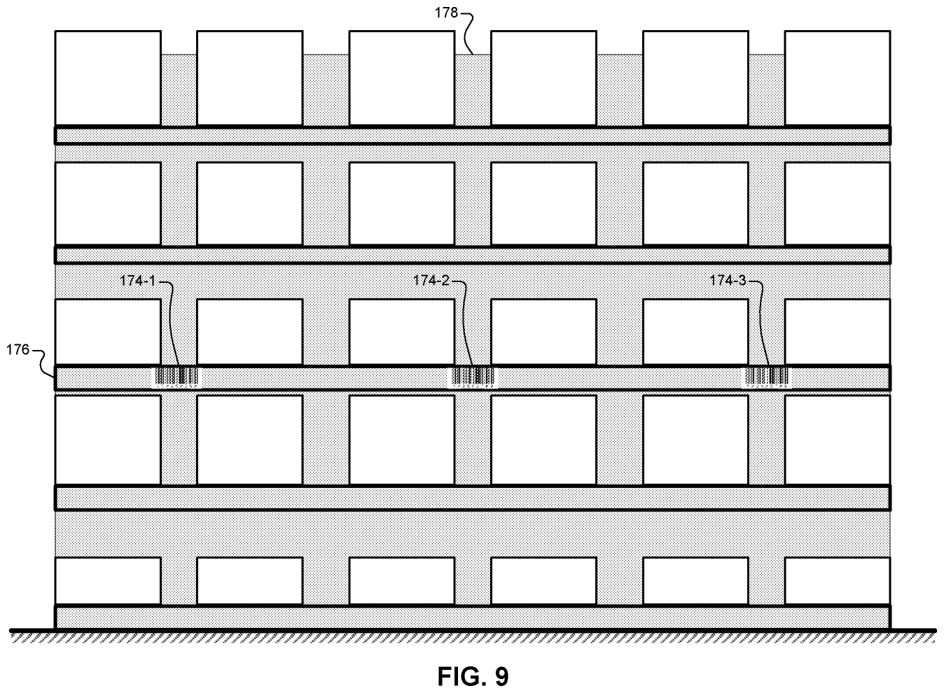

FIG. 9 shows an example arrangement of location indicators that include readable codes (e.g., printed barcodes). In FIG. 9, location indicators 174-1, 174-2, 174-3 are barcodes that are attached to shelf 176 of rack 178. Since location indicators 174-1, 174-2, 174-3 are barcodes, location indicators 174-1, 174-2, 174-3 may not transmit location signals. Instead, as described hereinafter, a user may use an MSD to scan location indicators 174-1, 174-2, 174-3 using a barcode scanner to determine a current location. Location indicators 174-1, 174-2, 174-3 may include different barcode values that indicate different locations to MSDs. In some examples, a store may include only location indicators that have readable codes (e.g., barcodes). In other words, in these examples, the store may not include location indicators that transmit location signals. In other examples, a store may not include location indicators with readable codes. Instead, in these examples, the store may include only location indicators that transmit location signals. In still other examples, a store may include both location indicators that have readable codes and location indicators that transmit location signals.

Although location indicators 174-1, 174-2, 174-3 are illustrated as attached to a shelf in FIG. 9, other arrangements of readable location indicators are contemplated. For example, readable location indicators may be attached to lower shelves or higher shelves, the wall of a store, the ceiling of the store, and/or attached to the floor. In general, readable location indicators may be attached in any location in a store that may be read by an MSD. It is contemplated that a store may include location indicators in any of the locations described with respect to FIGS. 4A-9. Additionally, a store may include location indicators in other locations which may not be explicitly illustrated in FIGS. 4A-9.

The number of location indicators and the arrangement of location indicators in a store may vary. In some examples, a larger store may include more location indicators to cover the larger area of the store. The density of location indicators (e.g., the number of location indicators per area of the store) may also vary. In some examples, a greater number of location indicators per area of store may create more locations per area of store, which may result in smaller zones (i.e., a higher location resolution).

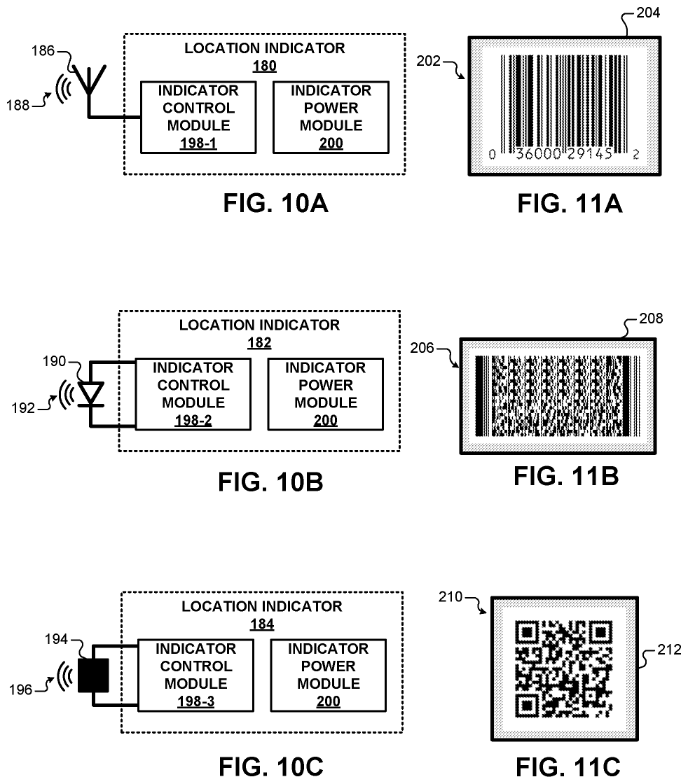

Example location indicators are described hereinafter with reference to FIGS. 10A-10C. Location indicators may include one or more different technologies for wirelessly transmitting location signals. For example, location indicators 180, 182, 184 of FIGS. 10A-10C may transmit location signals via an antenna, an LED, or an acoustic device. Additionally, location indicators of the present disclosure may encode location signals in a variety of different formats. In general, location indicators may be configured so that each location indicator transmits a different location signal. For example, when location indicators encode location signals using different frequency content, each location indicator may transmit a location signal having different frequency content. MSDs may be configured to acquire the different location signals and discriminate between the different location signals.

Location indicators may include a variety of different technologies. FIGS. 10A-10C illustrate some example technologies that may be used in location indicators that transmit location signals. FIG. 10A shows an example location indicator 180 that includes an antenna 186 for transmitting location signal 188. In some implementations, the location indicator 180 may include Bluetooth communication functionality (e.g., Bluetooth low energy (BLE)). In these implementations, the location indicator 180 may transmit location signals (e.g., as a Bluetooth beacon) using the Bluetooth communication functionality. MSDs (e.g., a mobile phone, tablet, or a dedicated computing device configured for use in the store) may communicate (e.g., receive transmissions) with the location indicators including Bluetooth functionality to determine location values. FIG. 10B shows an example location indicator 182 that includes an LED 190 for emitting location signal 192. In some implementations, the location indicator 182 (e.g., an LED) that emits light may be included in overhead lighting fixtures (e.g., FIG. 6) that provide lighting to the store. In these implementations, the location indicator 182 may transmit location signals and may also provide the store with lighting. The location signals may be undetectable by the human eye, but may be detected by the MSDs (e.g., a mobile phone, tablet, or a dedicated computing device configured for use in the store). FIG. 10C shows an example location indicator 184 that includes an acoustic device 194 for emitting location signal 196. Although FIGS. 10A-10C illustrate location indicators 180, 182, 184 using an antenna 186, LED 190, and acoustic device 194, it is contemplated that other types of devices may be used to transmit location signals within a store.

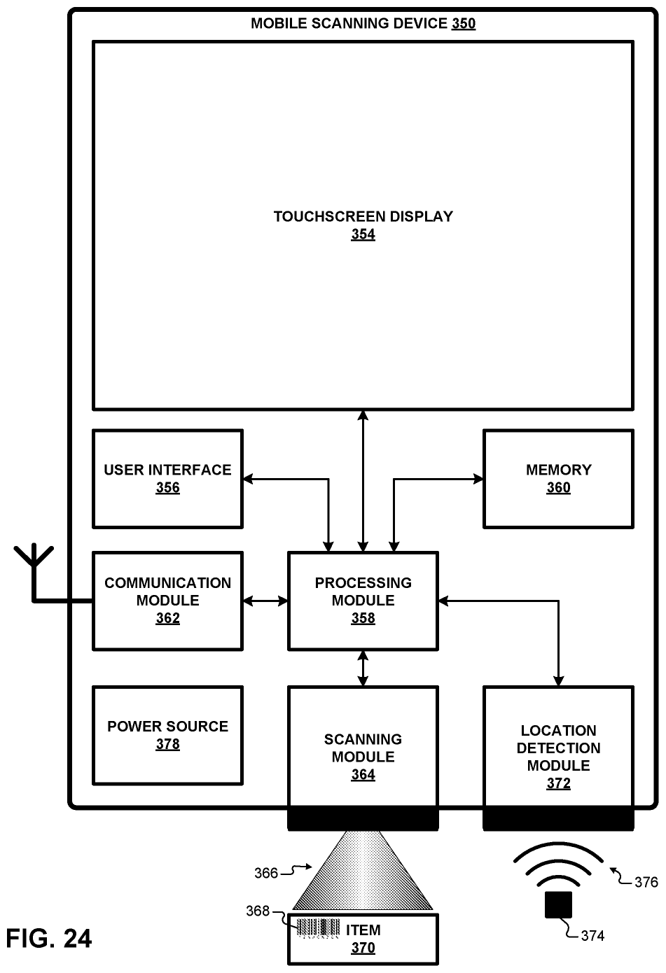

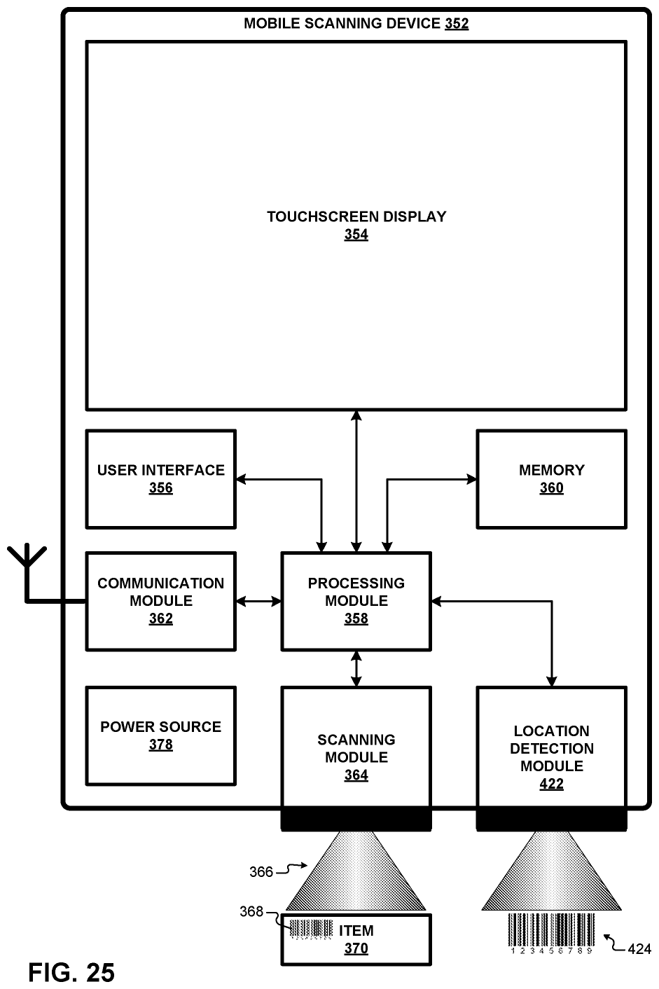

As described herein, MSDs may include location detection modules (e.g., location detection modules 372, 422 of FIGS. 24-25) that are configured to acquire location signals transmitted by location indicators. For example, when location indicators transmit location signals via an antenna, location detection modules of MSDs may include antennas configured to receive the transmitted location signals. As an additional example, when location indicators transmit location signals from an LED, location detection modules of MSDs may include devices configured to detect the transmitted light (e.g., an LED, or other light detection circuit). In still other examples, when location indicators transmit location signals from an acoustic device (e.g., sound waves), location detection modules of MSDs may include devices configured to detect the sound waves (e.g., a sound detection device). Although location indicators may include antennas, light emitting devices, and acoustic devices for transmitting location signals, other types of technologies may be included in location indicators for transmitting location signals. Accordingly, MSDs may include other types of location detection modules that are configured to detect location signals transmitted by other types of technologies used in location indicators.

In some examples, a single type of location indicator technology may be implemented in a store. For example, all location indicators may include light emitting devices (e.g., LEDs) and all MSDs may include light detection devices for detecting location signals. As an additional example, all location indicators may include an antenna for transmitting location signals and all MSDs may include antennas for receiving the transmitted location signals. In other examples, different location indicators may include different technologies within the store. For example, some of the location indicators may include light emitting devices, while other ones of the location indicators may include antennas. In still other examples, some of the location indicators may include multiple different technologies. For example, a location indicator may include both an antenna and a light emitting device.

Location indicators 180, 182, 184 include indicator control modules 198-1, 198-2, 198-3 that are configured to control operation of location indicators 180, 182, 184. In general, indicator control modules 198-1, 198-2, 198-3 may represent electronic hardware and software/firmware included in location indicators 180, 182, 184 that controls the transmission of location signals 188, 192, 196. Location indicators 180, 182, 184 may also include an indicator power module 200 configured to provide power to location indicators 180, 182, 184. Indicator power module 200 may include a variety of different electronic components that provide power to location indicators 180, 182, 184.

In some examples, location indicators 180, 182, 184 may be powered by mains power systems. In these examples, indicator power module 200 may include a connector to receive mains power (e.g., a three pronged plug or other connector) and power supply electronics for receiving mains power and delivering power to the electronics of location indicators 180, 182, 184 (e.g., indicator control modules 198-1, 198-2, 198-3). In other examples, location indicators 180, 182, 184 may be powered by batteries. In these examples, indicator power module 200 may include sockets for holding batteries and/or connectors for receiving battery power via wires. Additionally, in these examples, indicator power module 200 may include electronics for receiving power from batteries and delivering power to electronics of location indicators 180, 182, 184 (e.g., indicator control modules 198-1, 198-2, 198-3). In other examples, indicator power module 200 may include other power sources such as solar panels or a capacitor used for energy storage. In other examples, location indicators may receive power from MSDs. For example, a location indicator (e.g., an RFID tag) may include an antenna that receives energy transmitted by an MSD.

FIG. 10A shows an example location indicator 180 that includes an antenna 186. Indicator control module 198-1 may transmit location signal 188 via antenna 186. It is contemplated that antenna 186 may be implemented using a variety of different antenna structures. In some examples, antenna 186 may include a metal wire (e.g., monopole antenna, dipole antenna, a helical antenna, etc.) mounted to a printed circuit board (PCB) of location indicator 180. In other examples, antenna 186 may be included on traces of the PCB of location indicator 180. Although a single antenna is illustrated in FIG. 10A, it is contemplated that location indicators described herein may include more than one antenna in some examples.

As described above, location indicator 180 includes an indicator control module 198-1 (e.g., electronic hardware, firmware, and/or software) configured to transmit location signal 188 via antenna 186. Indicator control module 198-1 may also include memory that includes instructions that, when executed by indicator control module 198-1, cause indicator control module 198-1 to perform various functions attributed to indicator control module 198-1 described herein. Memory of indicator control module 198-1 may store programs and other operating parameters that define properties (e.g., codes, frequency parameters, etc.) of location signal 188.

The components of location indicator 180 may be enclosed in a housing. For example, the housing may enclose a PCB, antenna 186, indicator control module 198-1, and indicator power module 200, along with other components. The housing may have a variety of different form factors, depending on where location indicator 180 is to be located within a store. For example, the housing may be configured for resting or mounting on a shelf or wall, mounting on the floor, mounting on the ceiling, or embedding in the floor.

Location indicator 180 may encode location signal 188 in a variety of different formats. For example, location signal 188 may include one or more frequency components over a range of frequencies from approximately DC frequencies up to GHz frequencies. In some examples, indicator control module 198-1 may be configured to transmit one or more waveforms via antenna 188, such as on/off signals, sine waves, triangle waves, square waves, etc. In some examples, indicator control module 198-1 may be configured to generate carrier signals and modulate the carrier signal using analog modulation techniques (e.g., amplitude modulation) and/or digital modulation techniques (e.g., amplitude-shift keying). In some examples, indicator control module 198-1 may encode digital data (e.g., multiple bits) using modulation techniques.

MSDs may be configured to receive location signal 188 (e.g., via an antenna) and differentiate location signal 188 from location signals transmitted by other location indicators. For example, MSDs may be configured to detect parameters (e.g., frequency content) of location signal 188 and/or the digital data encoded by location signal 188. As described hereinafter, MSDs may detect location signal 188 and determine a location value based on location signal 188. In some examples, the location values may be unique. In other examples, some location values determined throughout the store may be the same.

Location indicator 180 of FIG. 10A may represent an RFID tag in some examples, such as an active RFID tag, a passive RFID tag, or other type of RFID tag. If location indicator 180 is an RFID tag, antenna 186 may represent one or more antennas of the RFID tag that transmit signals to an MSD and/or wirelessly receives energy from an MSD. Indicator power module 200 may include circuits that receive energy via an antenna in some examples. In other examples, indicator power module 200 may represent a battery included in the RFID tag. Indicator control module 198-1 may represent circuits that transmit RFID data via antenna 186. For example, indicator control module 198-1 may include an identification number that is transmitted via antenna 186 when the RFID tag is interrogated by an MSD. In some examples, an RFID tag may include a power source and be configured to transmit location signal 188. In other examples, an RFID tag may be “awoken” by an MSD and may transmit a location signal in response to being awoken by the MSD. In examples where RFID tags harvest power from MSDs, the location indicators may not require mains or battery power.

FIG. 10B shows an example location indicator 182 that includes a light emitting device 190 (e.g., one or more LEDs or other photonic devices). Location indicator 182 includes an indicator control module 198-2 (e.g., electronic hardware, software, and/or firmware) configured to transmit location signal 192 via light emitting device 190. Indicator control module 198-2 may also include memory that includes instructions that cause indicator control module 198-2 to perform various functions attributed to indicator control module 198-2 described herein. Memory of indicator control module 198-2 may store programs and other operating parameters that define properties (e.g., codes, frequency parameters, etc.) of location signal 192.

The components of location indicator 182 may be enclosed in a housing. For example, the housing may enclose a PCB, light emitting device 190, indicator control module 198-2, and indicator power module 200, along with other components. The housing may have a variety of different form factors, depending on where location indicator 182 is to be located within a store. For example, the housing may be configured for resting or mounting on a shelf or wall, mounting on the floor, mounting on the ceiling, or embedding in the floor.

Location indicator 182 may encode location signal 182 in a variety of different formats. For example, location signal 192 may include one or more frequency components over a range of frequencies from approximately DC frequencies up to GHz frequencies. In some examples, indicator control module 198-2 may be configured to transmit one or more waveforms via light emitting device 190, such as sine waves, triangle waves, square waves, etc. In some examples, indicator control module 198-2 may be configured to generate carrier signals and modulate the carrier signal using analog modulation techniques (e.g., amplitude modulation) and/or digital modulation techniques (e.g., amplitude-shift keying). In some examples, indicator control module 198-2 may encode digital data (e.g., multiple bits) using modulation techniques.

MSDs may be configured to receive location signal 192 (e.g., via a light detection device such as a photodiode, phototransistor, or other device) and differentiate location signal 192 from location signals transmitted by other location indicators. For example, MSDs may be configured to detect parameters (e.g., frequency content) of location signal 192 and/or the digital data encoded by location signal 192. As described hereinafter, MSDs may detect location signal 192 and determine a location value based on location signal 192.

FIG. 10C shows an example location indicator 184 that includes an acoustic device 194 that transmits location signal 196 by transmitting sound waves. Location indicator 184 includes an indicator control module 198-3 (e.g., electronic hardware, software, and/or firmware) configured to transmit location signal 196 via acoustic device 194. Indicator control module 198-3 may also include memory that includes instructions that cause indicator control module 198-3 to perform various functions attributed to indicator control module 198-3 described herein. Memory of indicator control module 198-3 may store programs and other operating parameters that define properties (e.g., codes, frequency parameters, etc.) of location signal 196.

The components of location indicator 184 may be enclosed in a housing. For example, the housing may enclose a PCB, acoustic device 194, indicator control module 198-3, and indicator power module 200, along with other components. The housing may have a variety of different form factors, depending on where location indicator 184 is to be located within a store. For example, the housing may be configured for resting or mounting on a shelf or wall, mounting on the floor, mounting on the ceiling, or embedding in the floor.

Location indicator 184 may encode location signal 196 in a variety of different formats. For example, location signal 196 may include one or more frequency components over a range of frequencies (e.g., audible to inaudible frequencies). In some examples, indicator control module 198-3 may be configured to transmit one or more waveforms via acoustic device 194, such as sine waves, triangle waves, square waves, etc. In some examples, indicator control module 198-3 may be configured to generate carrier signals and modulate the carrier signal using analog modulation techniques (e.g., amplitude modulation) and/or digital modulation techniques (e.g., amplitude-shift keying). In some examples, indicator control module 198-3 may encode digital data (e.g., multiple bits) using modulation techniques.

MSDs may be configured to receive location signal 196 (e.g., via an acoustic detection device) and differentiate location signal 196 from location signals transmitted by other location indicators. For example, MSDs may be configured to detect parameters (e.g., frequency content) of location signal 196 and/or the digital data encoded by location signal 196. As described hereinafter, MSDs may detect location signal 196 and determine a location value based on location signal 196.

In some examples, location indicators may include readable codes. For example, the readable codes may be printed onto objects (e.g., labels) and attached to shelves, walls, the floor, etc. FIGS. 11A-11C show different example readable codes which may be used as location indicators. FIG. 11A shows a location indicator 202 that includes a bar code (e.g., a UPC-A barcode) attached to a label 204. Label 204 may be a paper label including an adhesive for attaching label 204 to shelves, walls, etc. In other examples, label 204 may be a metal tab that may be attached to shelves, walls, etc. FIG. 11B shows a location indicator 206 that includes a different type of readable code (e.g., a PDF417) attached to a label 208. FIG. 11C shows a location indicator 210 that includes a different type of readable code (e.g., a QR code) attached to a label 212.

Readable codes on location indicators (e.g., 202, 206, 210) may encode a variety of different data. For example, the readable codes may represent alphanumeric codes. Different location indicators in a store may have different codes. In examples where location indicators include readable codes, each location indicator within a store may have a different readable code. MSDs may scan the readable codes on the location indicators to determine a location within the store. Since each location indicator may have a different readable code, the MSDs may uniquely identify a location within the store based on the readable code that is scanned from the location indicator.

MSDs (e.g., MSDs 114 of FIG. 1) may be configured to determine a location value based on one or more received location signals (e.g., location signals 128 of FIG. 1) and/or scanned readable codes (e.g., readable codes 174-1, 174-2, 174-3). In general, a location value may refer to any value or plurality of values (e.g., alphanumeric values) determined by an MSD that indicate a location of the MSD within, or outside of, a store. The location values determined by MSDs may depend on the types of location indicators used in a store. In examples where location indicators transmit location signals, MSDs may determine a location value based on one or more received location signals. In examples where location indicators include readable codes (e.g., barcodes), MSDs may scan the readable codes and determine a location value based on the scanned readable codes.

As describe above, a location value may refer to any value or plurality of values that indicate a location of the MSD within, or outside of, a store. In some examples, an MSD may determine a location value based on a location signal that was transmitted by a location indicator in proximity to the MSD. In other examples, an MSD may determine a location value by scanning a location indicator (e.g., a readable code) in proximity to the MSD. Accordingly, an MSD may determine a location value in an area of the store in proximity to the location indicator that indicates that location value. In a sense, an area in a store adjacent to a location indicator may be associated with that location indicator and the location value associated with that location indicator. An area of a store (e.g., the floor space) associated with a location value may also be referred to herein as a “zone” of the store.

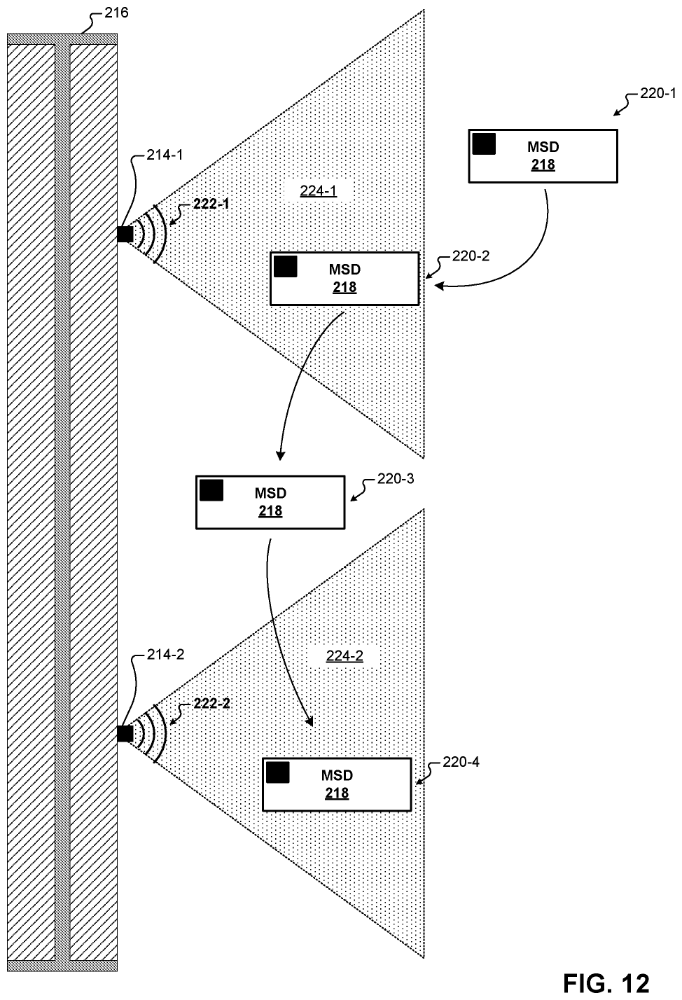

FIGS. 12-18 illustrate example arrangements of location indicators and associated location values that are associated with different areas of a store. Referring now to FIG. 12, location indicators 214-1, 214-2 are connected to rack 216. MSD 218 is moved along rack 216. The movement of MSD 218 is indicated by callouts 220-1, 220-2, 220-3, 220-4. As described hereinafter, MSD 218 includes a location detection module that is configured to acquire location signals 222-1, 222-2. The location detection module of MSD 218 is represented as a black box on MSD 218 in FIG. 12.

Initially, MSD 218 is located at position 220-1. At position 220-1, MSD 218 is outside of the range of location signal 222-1. Accordingly, MSD 218 may not be detecting a location signal at position 220-1. As described herein, an area in which an MSD does not acquire a location signal may be referred to as a “dead zone.” The areas covered by location signals 222-1, 222-2 are illustrated in FIG. 12 as shaded areas (e.g., shaded triangular areas). MSDs may acquire location signals within the areas covered by the location signals. In another example, the areas covered by location signals are illustrated as dotted rectangles (e.g., in FIG. 17).

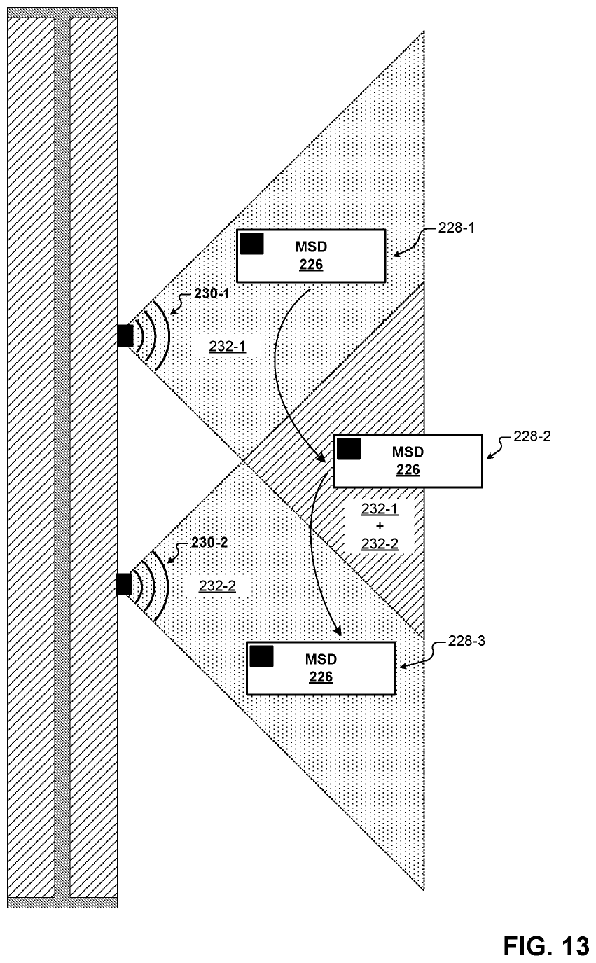

MSD 218 is moved from position 220-1 to position 220-2. MSD 218 begins acquiring location signal 222-1 as MSD 218 is moved to position 220-2. MSD 218 may determine a location value of 224-1 based on received location signal 222-1. A convention used herein is to assign the same reference numbers for location values and the areas in which MSDs determine the location values. For example, in FIG. 12, MSD 218 receives location signal 222-1 and determines a location value 224-1 in area 224-1 (i.e., zone 224-1). Similarly, MSD 218 receives location signal 222-2 and determines location value 224-2 in area 224-2 (i.e., zone 224-2) in FIG. 12. As an additional example, MSD 226 receives location signals 230-1, 230-2 and determines location value “232-1+232-2” in area “232-1+232-2” in FIG. 13.

Referring back to FIG. 12, MSD 218 is moved from position 220-2 to position 220-3. MSD 218 does not detect a location signal at position 220-3 (i.e., position 220-3 is a “dead zone”). Accordingly, when moving from position 220-2 to position 220-3, MSD 218 moves from a position in which a location signal is detected to a position in which location signals are not detected. MSD 218 is then moved from position 220-3 to position 220-4. MSD 218 acquires location signal 222-2 in position 220-4. MSD 218 may determine a location value of 224-2 in area 224-2 based on received location signal 222-2.

FIG. 13 shows an example in which an MSD is moved through a portion of a store in which location signals overlap in some regions. Initially, MSD 226 is located at position 228-1. MSD 226 detects location signal 230-1 at position 228-1. MSD 226 may determine a location value of 232-1 in area 232-1 based on detected location signal 230-1. MSD 226 is then moved from position 228-1 to position 228-2. When moving from position 228-1 to position 228-2, MSD 226 moves from a position in which a single location signal is detected to a position in which multiple location signals are detected.

Location signal 230-1 overlaps with location signal 230-2 at position 228-2 (as indicated by the triangular hashed region). Put another way, location signals 230-1, 230-2 cover the same area such that MSD 226 may detect multiple location signals at position 228-2. In areas where MSDs detect multiple location signals, the location values and the areas are illustrated in the figures and described in the text as a sum of values within quotes. For example, at position 228-2, MSD 226 may detect location signals 230-1, 230-2 and determine a location value of “232-1+232-2” in area “232-1+232-2” based on detected location signals 230-1, 230-2. MSD 226 is then moved from position 228-2 to position 228-3. MSD 226 acquires location signal 230-2 in position 228-3. MSD 226 may determine a location value of 232-2 in area 232-2 based on received location signal 230-2.

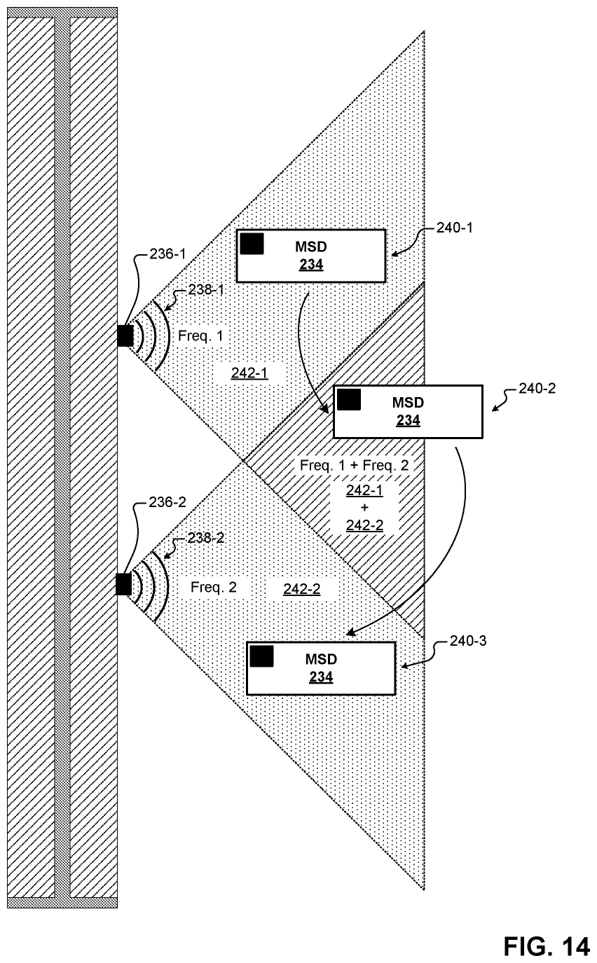

FIG. 14 shows an example in which an MSD 234 is moved through a portion of a store in which location indicators 236-1, 236-2 transmit location signals 238-1, 238-2 having different frequency content. For example, location indicator 236-1 may transmit a location signal 238-1 having a first frequency component (“Freq. 1” in FIG. 14) that is different from a frequency component included in location signal 238-2. Similarly, location indicator 236-2 may transmit a location signal 238-2 having a second frequency component (“Freq. 2” in FIG. 14) that is different from a frequency component included in location signal 238-1.

In one example, location signal 238-1 and location signal 238-2 may be sine wave signals having first and second frequencies, respectively. In this example, the first frequency may be different than the second frequency. For example, location signal 238-1 may be a sine wave having a frequency of 1 kHz and location signal 238-2 may be a sine wave having a frequency of 2 kHz. MSD 238 may detect the different frequencies and differentiate between location signals 238-1, 238-2 based on the different frequencies. In examples where a store includes an additional plurality of location indicators, each of the location indicators may transmit sine waves having different frequencies. In these examples, MSD 234 be configured to detect the different frequencies and differentiate between the different frequencies of sine waves transmitted by the additional location indicators.

Initially, MSD 234 is located at position 240-1. MSD 234 detects location signal 238-1 having a first frequency component at position 240-1. MSD 234 may determine a location value of 242-1 in area 242-1 based on detected location signal 238-1 having the first frequency component. MSD 234 is then moved from position 240-1 to position 240-2. When moving from position 240-1 to position 240-2, MSD 234 moves from a position in which only a first frequency component is detected to a position in which first and second frequency components are detected.

Location signal 238-1 overlaps with location signal 238-2 at position 240-2 such that MSD 234 may detect first and second frequency components at position 240-2. Accordingly, at position 240-2, MSD 234 may detect first and second frequency components of location signals 238-1, 238-2 and determine a location value of “242-1+242-2” in area “242-1+242-2” based on the detected frequency components of location signals 238-1, 238-2. MSD 234 is then moved from position 240-2 to position 240-3. MSD 234 acquires the second frequency component of location signal 238-2 in position 240-3, but may not detect the first frequency component of location signal 238-1. Accordingly, MSD 234 may determine a location value of 242-2 in area 242-2 based on the detected second frequency component of location signal 238-2.

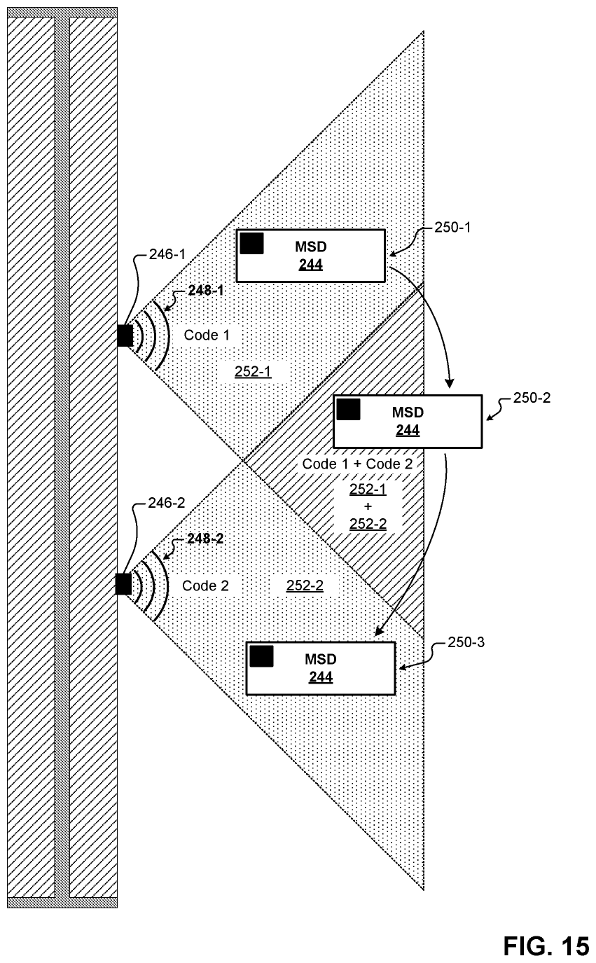

FIG. 15 shows an example in which an MSD 244 is moved through a portion of a store in which location indicators 246-1, 246-2 transmit location signals 248-1, 248-2 including different coded values. For example, location indicator 246-1 may transmit a location signal 248-1 including a first code (“Code 1” in FIG. 15) that is different from a second code included in location signal 248-2. Similarly, location indicator 246-2 may transmit a location signal 248-2 having a second code (“Code 2” in FIG. 15) that is different from the first code included in location signal 248-1. The codes transmitted by location indicators 246-1, 246-2 may be digital codes (e.g., alphanumeric codes) in some examples.

MSD 244 may detect the different codes and differentiate between location signals 248-1, 248-2 based on the different codes. In examples where a store includes an additional plurality of location indicators, each of the location indicators may transmit different codes. In these examples, MSD 244 may be configured to detect the different codes and differentiate between the different codes transmitted by the additional location indicators.

Initially, MSD 244 is located at position 250-1. MSD 244 detects location signal 248-1 including a first code at position 250-1. MSD 244 may determine a location value of 252-1 in area 252-1 based on detected location signal 248-1 having the first code. MSD 244 is then moved from position 250-1 to position 250-2. When moving from position 250-1 to position 250-2, MSD 244 moves from a position in which only the first code is detected to a position in which first and second codes are detected.

Location signal 248-1 overlaps with location signal 248-2 at position 250-2 such that MSD 244 may detect first and second codes at position 250-2. Accordingly, at position 250-2, MSD 244 may detect first and second codes and determine a location value of “252-1+252-2” in area “252-1+252-2” based on the detected codes of location signals 248-1, 248-2. MSD 244 is then moved from position 250-2 to position 250-3. MSD 244 acquires the second code in position 250-3, but may not detect the first code. Accordingly, MSD 244 may determine a location value of 252-2 in area 252-2 based on the detected second code.

As described herein, location values may be associated with stocked items. For example, each stocked item in the store may be associated with a location value. Each location value may be associated with multiple different stocked items. In general, a stocked item may be associated with a location value that may be determined by an MSD in proximity to that stocked item. In the case where a first location indicator generates a first location signal including a first location value, items in proximity to the first location signal may be associated with the first location value. In the case where a first location indicator includes a first readable code including a first location value, items in proximity to the first location indicator including the readable code may be associated with the first location value. The associations between location values and items may be generated manually by a user in some examples. In other examples, the associations between location values and items may be generated automatically (e.g., by one or more MSDs and/or the CCS). The associations between location values and stocked items may be stored in one or more MSDs and/or the CCS.

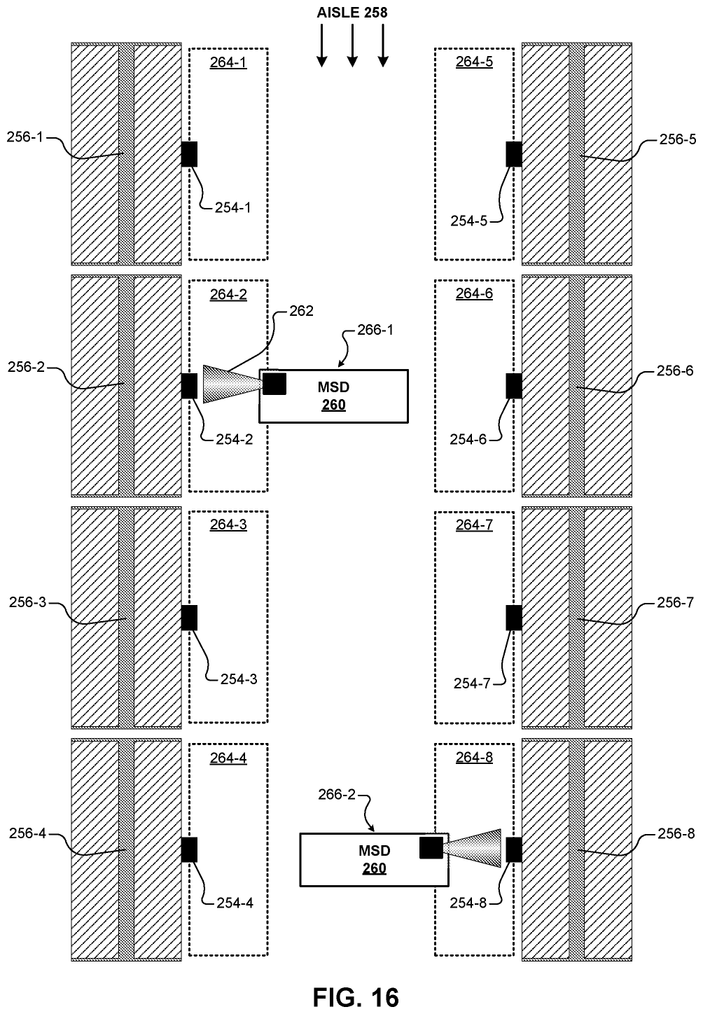

FIG. 16 illustrates example arrangements of location indicators and associated location values that are associated with different areas of a store. Location indicators 254-1, 254-2, . . . , 254-8 (hereinafter “location indicators 254”) may include readable codes. For example, location indicators 254 may be readable codes printed onto objects (e.g., labels) and attached to racks 256-1, 256-2, . . . , 256-8 along aisle 258. The readable codes may represent a variety of different data, such as alphanumeric codes.

MSD 260 may scan readable codes on location indicators 254 to determine location values associated with location indicators 254. As described hereinafter, MSD 260 includes a location detection module (e.g., location detection module 422 of FIG. 25) that is configured to scan readable codes of location indicators 254. Scanning by MSD 260 is illustrated as a shaded cone 262. Each of location indicators 254 may have different readable codes such that MSD 260 determines different location values for each of location indicators 254. Since each of location indicators 254 may have a different readable codes, MSD 260 may uniquely identify a location within the store based on the readable code that is scanned from the location indicator.

The area of the store associated with a location value of a readable code may be the area of the store in proximity to the readable code. For example, in FIG. 16, each of racks 256 includes a single location indicator (e.g., a single location value) that may be associated with the areas in front of racks 256. The areas associated with location indicators 254 are illustrated as dotted rectangles in FIG. 16. In one example, MSD 260 may scan location indicator 254-1 to determine location value 264-1 for area 264-1. Similarly, MSD 260 may scan location indicator 254-7 to determine location value 264-7 for area 264-7.

Initially, MSD 260 is located at position 266-1. At position 266-1, MSD 260 scans location indicator 254-2 and determines location value 264-2 in area 264-2. MSD 260 is moved from position 266-1 to position 266-2. At position 266-2, MSD 260 scans location indicator 254-8 and determines location value 264-8 in area 264-8. As described hereinafter, location value 264-2 may be associated with items on rack 256-2 that may be accessible in area 264-2. Similarly, location value 264-8 may be associated with items on rack 256-8 that may be accessible in area 264-8.

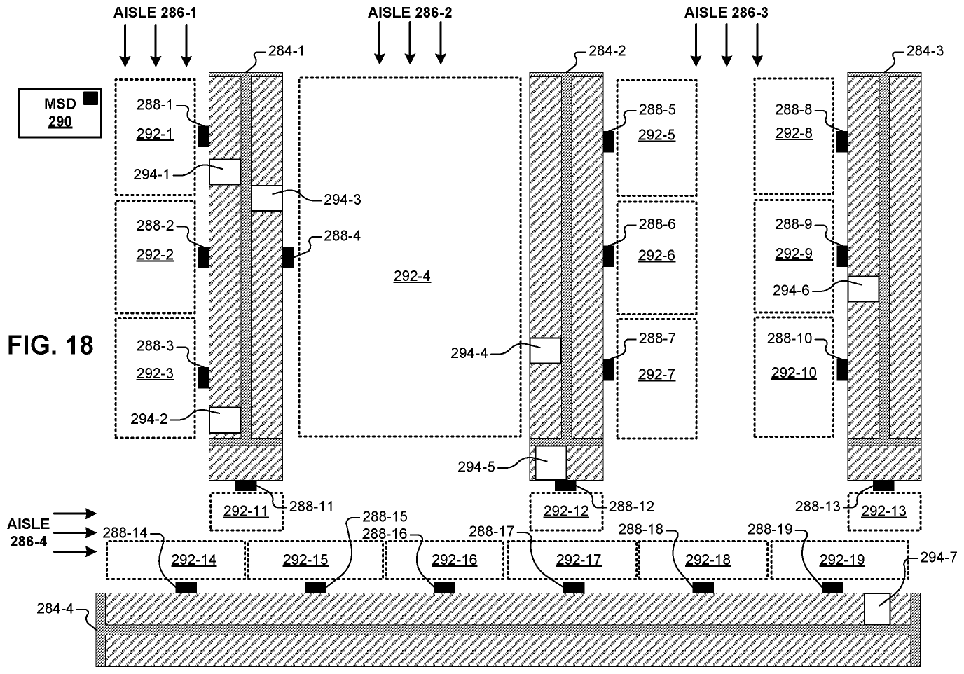

FIGS. 17-18 show example store layouts including a variety of location indicators and items. As described herein, items may be associated with location values. For example, the CCS, MSDs, and/or other computing devices may store associations between items and location values. In general, when the MSD determines a location value, items associated with that location value may be in proximity to the MSD. Put another way, an item may be associated with a location value that would be determined by an MSD in proximity to that item. In some examples, the associations between the items and the location values may be entered manually by a user. In other examples, the associations between the items and the location values may be automatically generated.

FIG. 17 shows a store layout including four racks 268-1, 268-2, 268-3, 268-4 (collectively “racks 268”) that define four aisles 270-1, 270-2, 270-3, 270-4 (collectively “aisles 274”). The store of FIG. 17 includes location indicators 276-1, 276-2, . . . , 276-10 (collectively “location indicators 276”) that transmit location signals. MSD 278 may determine location values 280-1, 280-2, . . . , 280-10, “280-5+280-6”, “280-9+280-10” (collectively “location values 280”) based on detected location signals. The areas covered by location signals are illustrated in FIG. 17 as dotted rectangles. Areas in which multiple location signals are detected are illustrated as shaded rectangles in FIG. 17. The store of FIG. 17 also includes dead zones 281-1, 281-2, 281-3.

The store of FIG. 17 includes items 282-1, 282-2, . . . , 282-9 (collectively “items 282”). Items 282 are associated with location values 280 (i.e., areas) of the store. The associations between items 282 and location values 280 may be stored in the CCS, one or more MSDs, and/or other computing devices. In general, items are associated with location signals (i.e., areas) in proximity to the items. For example, item 282-1 may be associated with location value 280-1. Items 282-3, 282-4, 282-5 may be associated with location value 280-4. Item 282-6 may be associated with location value “280-5+280-6”. Item 282-7 and item 282-9 may be associated with location value 280-10 and location value 280-9, respectively. Item 282-8 may be associated with location value “280-9+280-10”.

In FIG. 17, it may be assumed that MSD 278 has received a customer order including items 282. As described hereinafter in greater detail, MSD 278 may include a display that displays some, or all, of items 282 to a user. MSD 278 may arrange the displayed items based on which of location signals are detected. In general, MSD 278 may arrange the displayed items such that the items in proximity to MSD 278 (i.e., in proximity to the user) are viewable by the user on the display. In one example, MSD 278 may arrange items on the display such that those items in proximity to the user are more prominently displayed than those items that are farther away from MSD 278. For example, MSD 278 may display items in the current area at the top of the display. Additionally, or alternatively, MSD 278 may display the items in bold and/or colored text to indicate those items that are in proximity to the user. Displaying of items based on the currently determined location value is described hereinafter in greater detail.

FIG. 18 shows a store layout including four racks 284-1, 284-2, 284-3, 284-4 (collectively “racks 284”) that define four aisles 286-1, 286-2, 286-3, 286-4 (collectively “aisles 286”). The store of FIG. 18 includes location indicators 288-1, 288-2, . . . , 288-19 (collectively “location indicators 288”) that include readable codes. MSD 290 may scan location indicators 288 to determine location values 292-1, 292-2, . . . , 292-19 in areas 292-1, 292-2, . . . , 292-19 (collectively “areas 292”). Areas 292 in proximity to location indicators 288 are illustrated as dotted rectangles. For example, MSD 290 may scan location indicator 288-1 to determine location value 292-1 for area 292-1. Similarly, MSD 290 may scan location indicator 288-19 to determine location value 292-19 for area 292-19.

The store of FIG. 18 includes items 294-1, 294-2, . . . , 294-7 (collectively “items 294”). Items 294 are associated with location values 292 (i.e., areas) of the store. The associations between items 294 and location values 292 may be stored in the CCS, one or more MSDs, and/or other computing devices. In general, items are associated with location values (i.e., areas) in proximity to the items. For example, item 294-1 and item 294-2 may be associated with location value 292-1 and location value 292-3, respectively. Similarly, items 294-3, 294-4 may be associated with location value 292-4. As another example, item 294-5 may be associated with location value 292-12.

In FIG. 18, it may be assumed that MSD 290 has received a customer order including items 294. As described hereinafter in greater detail, MSD 290 may include a display that displays some, or all, of items 294 to a user. MSD 290 may arrange the displayed items based on which of location values 292 are determined. In general, MSD 290 may arrange the displayed items such that the items in proximity to MSD 290 (i.e., in proximity to the user) are viewable by the user on the display. In one example, MSD 290 may arrange items on the display such that those items in proximity to the user are more prominently displayed than those items that are farther away from MSD 290. For example, MSD 290 may display items in the current area at the top of the display. Additionally, or alternatively, MSD 290 may display the items in bold and/or colored text to indicate those items that are in proximity to the user.

One or more computing devices may store a location map that defines the spatial relationships between different areas of the store. For example, a location map may define the relative distances between different areas of the store. In some examples, two areas may be adjacent to one another. For example, the two areas may be touching one another. In other examples, two areas may not be adjacent to one another. Instead, one or more additional areas may be located between the two areas.

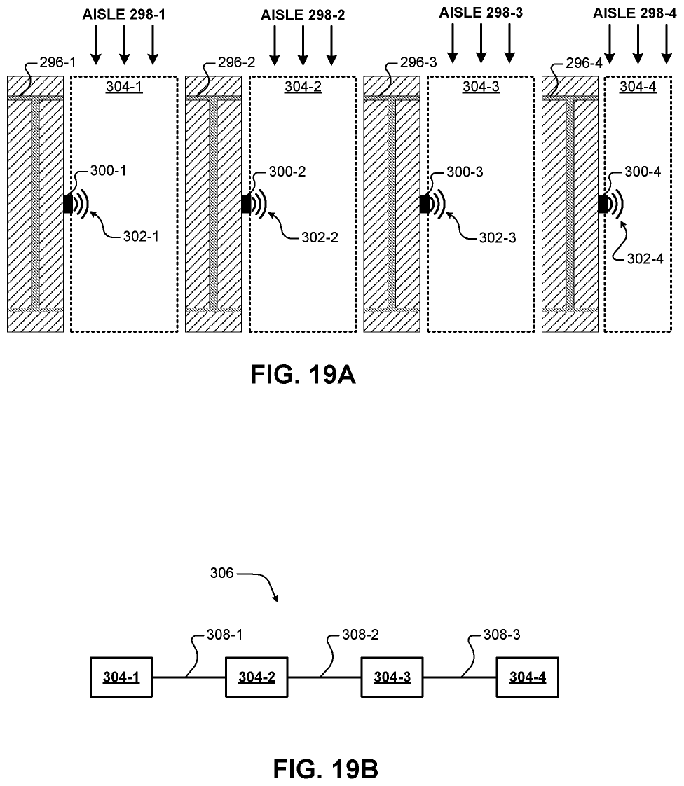

Example location maps are illustrated and described with respect to FIGS. 19A-22B. Location maps are graphically represented herein using boxes to represent different areas in the store. The boxes are connected to one another using one or more junctions (e.g., 308-1, 308-2 of FIG. 19B). The areas that are adjacent to one another may be connected using a single junction. For example, in FIG. 19B, area 304-1 is connected to area 304-2 by junction 308-1. Areas that are separated from one another (e.g., by another junction) may be connected via one or more junctions. For example, area 304-1 is connected to area 304-3 via junction 308-1 and junction 308-2 in FIG. 19B because area 304-2 is located between area 304-1 and area 304-3 in FIG. 19A. Location maps may be generated manually by a user in some examples. In other examples, the location maps may be generated automatically (e.g., by one or more MSDs and/or the CCS). The location maps may be stored in one or more MSDs and/or the CCS.

In general, location maps may define the spatial relationships between different areas of the store. In examples where location indicators transmit location signals, the location map may define how the areas of the store covered by the location signals are arranged relative to one another. For example, the location map may define the distances between the areas of the store covered by the location signals. In examples where the location indicators include readable codes, the location map may define the location of each of the location indicators (i.e., readable codes) relative to one another. For example, the location map may define the distances between different readable codes.

Since items may be associated with location values, and the location map may indicate the distance between areas in which the location values are determined by an MSD, an MSD may determine the distance between items using the location map. After an MSD determines the distance between ordered items using the location map, the MSD may arrange the items on the display based on the distance of each of the items from the current location of the MSD (i.e., the user).

Referring now to FIGS. 19A-19B, the store of FIG. 19A includes four racks 296-1, 296-2, 296-3, 296-4 (collectively “racks 296”) that define four aisles 298-1, 298-2, 298-3, 298-4 (collectively “aisles 298”). The store of FIG. 19A includes location indicators 300-1, 300-2, 300-3, 300-4 (collectively “location indicators 300”) that transmit location signals 302-1, 302-2, 302-3, 302-4 (collectively “location signals 302”). An MSD may determine location values 304-1, 304-2, 304-3, 304-4 based on detected location signals 302-1, 302-2, 302-3, 302-4, respectively. Areas 304-1, 304-2, 304-3, 304-4 (collectively “areas 304”) covered by location signals 302 are illustrated in FIG. 19A as dotted rectangles.

In FIG. 19A, area 304-1 is adjacent to area 304-2. Area 304-2 is adjacent to area 304-1 and area 304-3. Area 304-3 is adjacent to area 304-2 and area 304-4. Area 304-4 is adjacent to area 304-3. Location map 306 of FIG. 19B may represent the relative distances between areas 304. For example, area 304-1 is connected to area 304-2 by a single junction 308-1 to represent that area 304-1 is adjacent to area 304-2. Similarly, area 304-2 is connected to area 304-3 by a single junction 308-2 to represent that area 304-2 is adjacent to area 304-3. Area 304-1 and area 304-4 are the areas of FIG. 19A that are farthest apart. The distance between area 304-1 and area 304-4 may be represented by the three junctions 308-1, 308-2, 308-3 that separate area 304-1 and area 304-4 in location map 306.

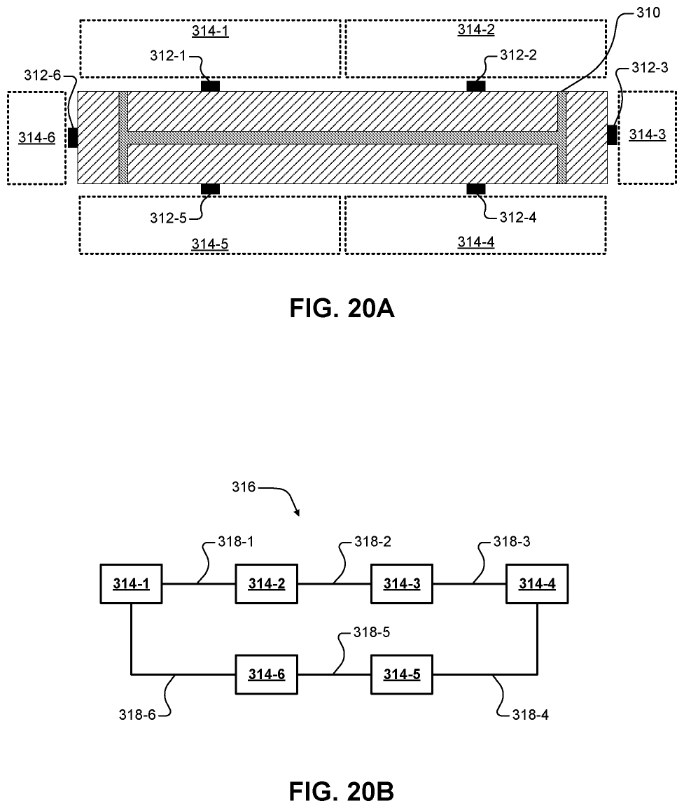

FIGS. 20A-20B show another example location indicator layout. FIG. 20A includes rack 310 that may be accessed from all sides. Rack 310 includes location indicators 312-1, 312-2, . . . , 312-6 (collectively “location indicators 312”) having readable codes. A MSD may scan location indicators 312 to determine location values 314-1, 314-2, . . . , 314-6. Areas 314-1, 314-2, . . . , 314-6 (collectively “areas 314”) surround rack 310 such that the location indicator layout in FIG. 20A results in a location map 316 in which each of areas 314 are adjacent to two other areas.

Junctions 318-1, 318-2, . . . , 318-6 may represent the relative distances between areas 314. For example, area 314-1 is connected to area 314-2 by a single junction 318-1 to represent that area 314-1 is adjacent to area 314-2. Similarly, area 314-2 is connected to area 314-3 by a single junction 318-2 to represent that area 314-2 is adjacent to area 314-3. The distance between area 314-1 and area 314-4, which are not adjacent, may be represented by the three junctions 318-1, 318-2, 318-3 that separate area 314-1 and area 314-4 in location map 316. Similarly, the distance between area 314-3 and area 314-6 may be represented by the three junctions 318-3, 318-4, 318-5 that separate area 314-3 and area 314-6 in location map 316. Alternatively, a user may travel from area 314-3 to area 314-6 via areas 314-1, 314-2. The distance between area 314-3 and area 314-6 via areas 314-1, 314-2 may be represented by three junctions 318-1, 318-2, 318-6 that separate area 314-3 and area 314-6.

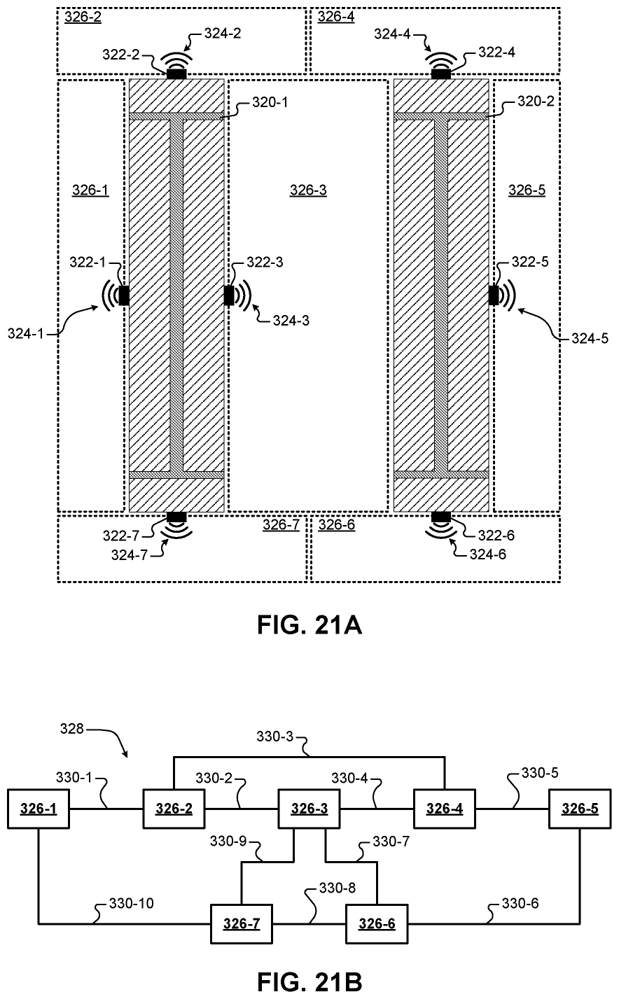

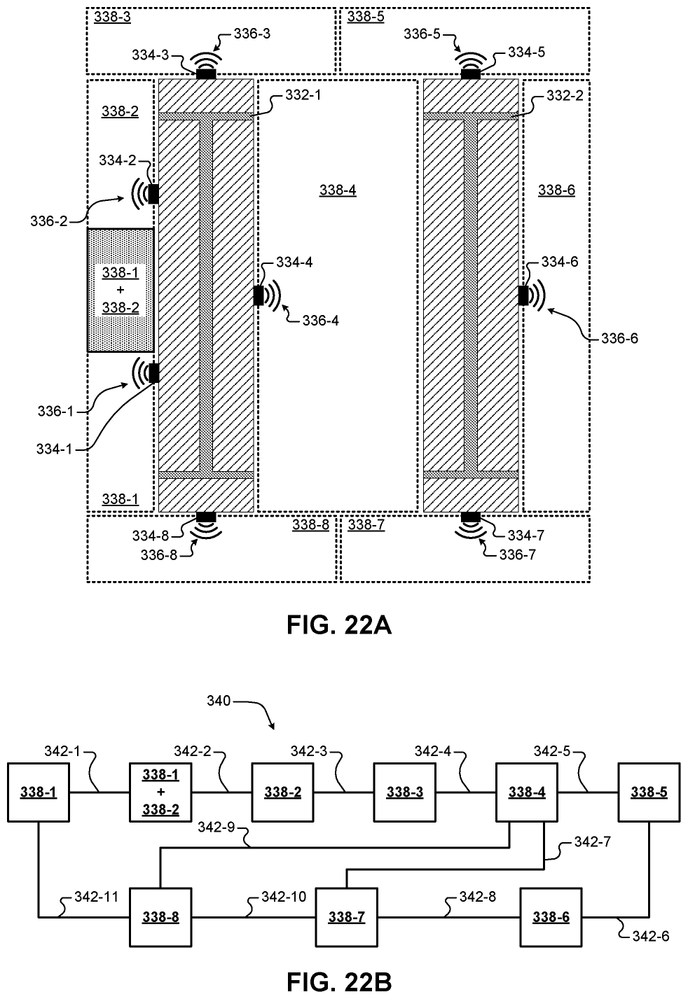

FIGS. 21A-22B illustrate location indicator layouts which are more elaborate than those layouts illustrated in FIGS. 19A-20B. The store of FIG. 21A includes racks 320-1, 320-2. The store of FIG. 21A includes location indicators 322-1, 322-2, . . . , 322-7 (collectively “location indicators 322”) that transmit location signals 324-1, 324-2, . . . , 324-7 (collectively “location signals 324”). An MSD may determine location values 326-1, 326-2, . . . , 326-7 based on detected location signals 324 in areas 326-1, 326-2, . . . , 326-7 (collectively “areas 326”).

The layout of location indicators in FIG. 21A may be considered to be more elaborate than the layout of location indicators in FIGS. 19A-20B in that the store of FIG. 21A includes a greater number of areas. Furthermore, areas 326 in FIG. 21A may be adjacent to up to four other areas. For example, area 326-3 is adjacent to areas 326-2, 326-4, 326-6, 326-7. Multiple other areas are also adjacent to three other areas. For example, area 326-2 is adjacent to areas 326-1, 326-3, 326-4.

Location map 328 includes junctions 330-1, 330-2, . . . , 330-10 (collectively “junctions 330”). Junctions 330 may represent distances between areas 326. For example, adjacent areas (i.e., those connected by one junction) may be closer to one another than non-adjacent areas. However, since areas 322 are not all of equal size, all of junctions 330 may not represent equal distances. For example, areas 326-1, 326-3, 326-5 are slightly larger than areas 326-2, 326-4, 326-6, 326-7. Therefore, any path through location map 328 including areas 326-1, 326-3, 326-5 may represent a slightly longer distance than paths that do not include areas 326-1, 326-3, 326-5. For example, a path from area 326-6 to area 326-4 via area 326-5 (i.e., via junctions 330-6, 330-5) may represent a slightly greater distance than a path from area 326-5 to area 326-7 via area 326-6 (i.e., via junctions 330-6, 330-8).

As described above with respect to FIGS. 21A-21B, the number of junctions between areas may generally represent the distance between areas. However, in some examples, the distance represented by a junction may vary depending on the amount of area covered by a location indicator. Accordingly, it follows that the arrangement of location indicators and the areas covered by location signals may be adjusted in order to adjust the information conveyed by a location map stored within a computing device. For example, when location indicators are arranged at approximately equal distances from one another, the junctions of a location map may represent approximately equal distances between different areas of the store.

FIGS. 22A-22B illustrate a location indicator layout in which two location signals overlap to form an area of the store in which an MSD detects multiple location signals. The store of FIG. 22A includes racks 332-1, 332-2. The store of FIG. 22A includes location indicators 334-1, 334-2, . . . , 334-8 (collectively “location indicators 334”) that transmit location signals 336-1, 336-2, . . . , 336-8 (collectively “location signals 336”). An MSD may determine location values 338-1, 338-2, . . . , 338-8, and “338-1+338-2” based on detected location signals 336 in areas 338-1, 338-2, . . . , 338-8, and “338-1+338-2” (collectively “areas 338”). Note that location map 340 of FIG. 22B includes an area “338-1+338-2” in which two location signals 336-1, 336-2 are detected by an MSD. In this example, area “338-1+338-2” is mapped as an area that is adjacent to area 338-1 and area 338-2. Location map 340 includes junctions 342-1, 342-2, . . . , 342-11 (collectively “junctions 342”). Junctions 342 may represent distances between areas 338. Each of junctions 342 may not represent equal distances, as described above with respect to FIGS. 21A-21B.

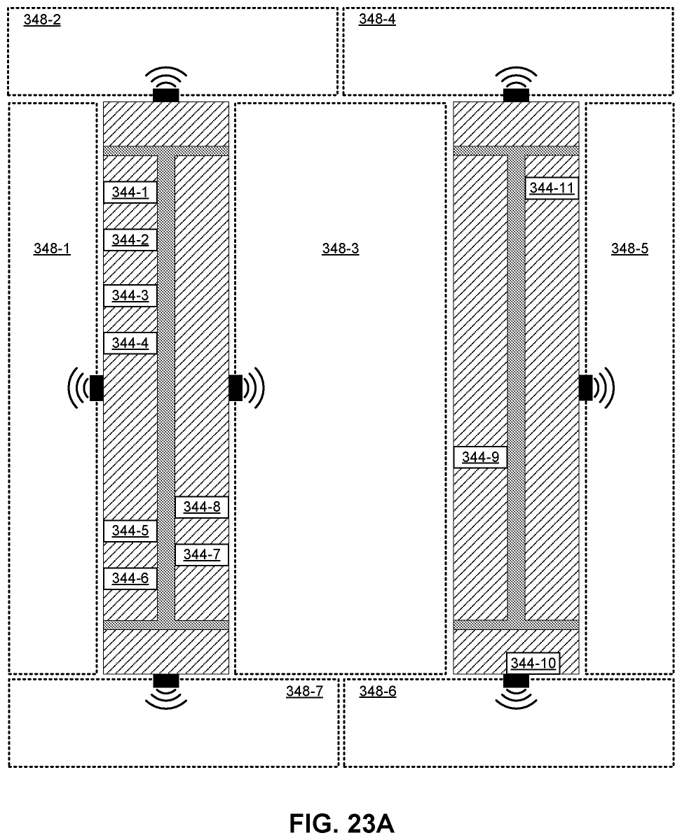

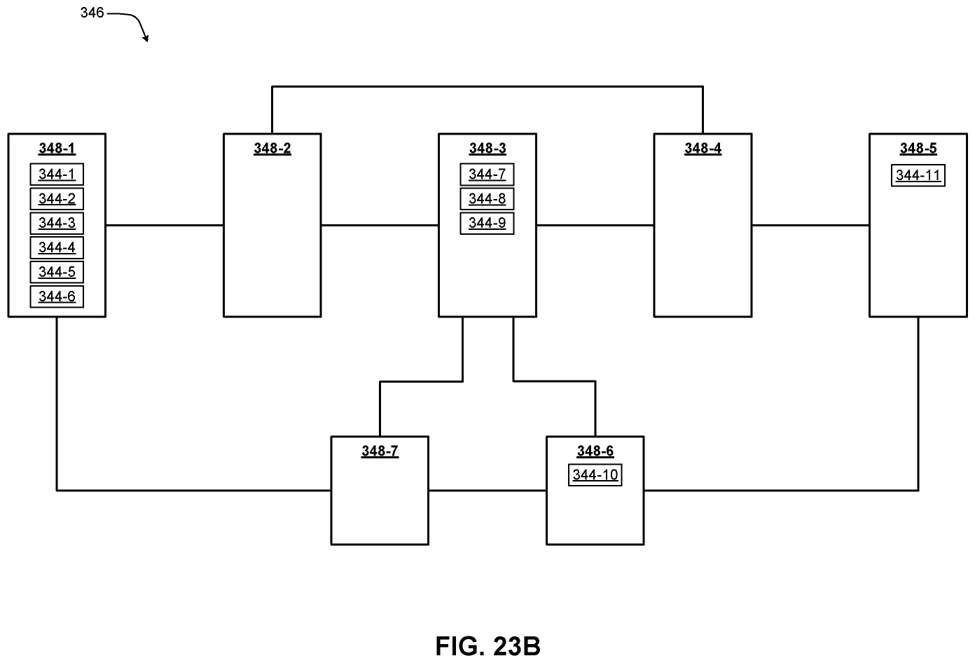

FIG. 23A shows an example store including items 344-1, 344-2, . . . , 344-11 (collectively “items 344”). FIG. 23B shows a location map 346 including items 344. Location map 346 illustrates the association between location values 348 and items 344. Note that the layout of the location indicators and the location map 346 of FIGS. 23A-23B have been described with reference to FIGS. 21A-21B.

Each of items 344 is associated with a location value. For example, items 344-1, 344-2, . . . , 344-6 are proximate to area 348-1 and associated with location value 348-1. Items 344-7, 344-8, 344-9 are proximate to area 348-3 and associated with location value 348-3. Item 344-10 is proximate to area 348-6 and associated with location value 348-6. Item 344-11 is proximate to area 348-5 and associated with location value 348-5. As described hereinafter, items may be displayed on an MSD based on a location map and a currently determined location value. For example, an MSD may include a location map which the MSD may use to arrange ordered items on the display of the MSD.

FIGS. 24-25 show functional block diagrams of example MSDs. MSD 350 of FIG. 24 is configured to receive location signals and determine location values based on received location signals. MSD 352 of FIG. 25 is configured to scan location indicators that include readable objects and determine location values based on the scanned readable objects. MSDs 350,352 may be implemented using a variety of different form factors.

Referring now to FIG. 24, MSD 350 includes a touchscreen display 354 and a user interface 356. Touchscreen display 354 may include a combination display (e.g., an LCD or OLED display) and a touchscreen. Touchscreen display 354 may display information (e.g., ordered items) to a user. Touchscreen display 354 may also receive user touch input, such as tapping, swiping, and multi-finger input. Although MSDs 350, 352 include touchscreen display 354, in other examples, the display of an MSD may not include touchscreen capabilities.

User interface 356 may represent user interface components, other than touchscreen display 354, which may provide a user interface experience. A user may interact with MSD 350 using user interface 356. User interface 356 may include input components which a user may use to input information into MSD 350, such as touch controls (e.g., capacitive touch buttons, a touchpad, and/or a touch wheel), a keypad (e.g., alphanumeric keys), buttons, a directional pad, an analog stick, switches, a scroll wheel, a track ball, accelerometers, a microphone, or other user interface components. User interface 356 may also include one or more feedback components that provide feedback to a user. Feedback components may include a speaker that provides audible feedback, a vibrating device that provides tactile feedback, and/or visual feedback devices (e.g., LEDs).

A user may interact with MSD 350 using touchscreen display 354 and/or user interface 356. For example, a user may view items included in customer orders along with other information on touchscreen display 354. A user may also swipe their finger across touchscreen display 354 to scroll through the items displayed on touchscreen display 354. As described herein, the items displayed on touchscreen display 354 may be arranged based on a current location of MSD 350.

MSD 350 includes a processing module 358 and memory 360. Processing module 358 may take the form of one or more microprocessors, microcontrollers, digital signal processors (DSPs), application-specific integrated circuits (ASICs), field-programmable gate arrays (FPGAs), programmable logic circuitry, or the like. The functions attributed to processing module 358 herein may be embodied as hardware, firmware, software or any combination thereof. Processing module 358 may provide any of the functionality ascribed herein to MSD 350, or otherwise perform any of the methods described herein.

Memory 360 may store instructions that cause processing module 358 to provide the functionality ascribed to MSD 350 herein. Memory 360 may include any fixed or removable media. For example, memory 360 may include magnetic or electrical media, such as RAM, ROM, magnetic disks, EEPROM, or the like. Memory 360 may also include a removable memory portion that may be used to provide memory updates or increases in memory capacities.

MSD 350 includes a communication module 362 that may provide wireless communication functionality. MSD 350 may communicate with other computing devices using communication module 362, which may be coupled to an internal antenna or an external antenna. For example, MSD 350 may send data to other computing devices using communication module 362. Additionally, MSD 350 may receive data from other computing devices using communication module 362. Examples of wireless communication techniques that may be employed to facilitate communication between MSD 350 and other computing devices using communication module 362 may include communication according to 802.11 or Bluetooth specification sets, infrared communication (e.g., according to the IrDA standard), near-field communication (NFC), cellular communication, or other standard or proprietary communication protocols.

In some examples, MSD 350 may communicate directly with other MSDs. For example, MSD 350 may transmit data from communication module 362 to a communication module of another MSD. Similarly, MSD 350 may receive data from one or more MSDs via communication module 362. In other examples, MSD 350 may communicate with other MSDs via a communication system of a store (e.g., communication system 112 of FIG. 1). In these examples, MSD 350 may transmit data to the communication system from communication module 362. The transmitted data may then be sent from the communication system to other MSDs.

In some examples, MSD 350 may communicate with a CCS of a store (e.g., CCS 104 of FIG. 1) via a communication system (e.g., communication system 112 of FIG. 1) of the store. For example, MSD 350 may transmit data from communication module 362 to the communication system. The communication system may then send the data to the CCS. MSD 350 may also receive data from the communication system. For example, the CCS may send data to the communication system which then wirelessly transmits the data to communication module 362.

MSD 350 includes a scanning module 364 that may represent any devices (e.g., electronic hardware, software/firmware) configured to scan item ID codes. For example, scanning module 364 may be configured to scan printed codes, such as barcodes (e.g., linear, 2D, or QR barcodes). Scanning module 364 may include one or more types of technology for scanning item ID codes. In some examples, scanning module 364 may include one or more photodiodes and associated electronics/software for reading light and dark portions of an item ID code on the item. In some examples, scanning module 364 may include one or more lasers and associated electronics/software for scanning back and forth across an item ID code to read the item ID code. In some examples, scanning module 364 may include one or more charge-coupled device readers (“CCD readers”) and associated electronics/software for reading light and dark portions of an item ID code on the item. In some examples, scanning module 364 may include a small camera (e.g., CCD readers or CMOS imaging) and associated image processing electronics/software for interpreting the item ID code. Shading 366 included in FIGS. 24-25 is meant to illustrate the scanning of item ID code 368 (e.g., a barcode) on item 370 (e.g., using a photodiode, one or more lasers, or other technology).

Scanning module 364 may be configured to scan item ID codes in response to user input. For example, a user may press a key (e.g., pull a trigger) on user interface 356 to cause scanning module 364 to scan an item ID code. Example form factors of MSD 350 including a key (e.g., a trigger) which may be pressed by a user to initiate an item scan are illustrated in FIGS. 26A, 26B, 26D, 26F. In other examples, scanning module 364 may not require user input to operate. Instead, scanning module 364 may constantly operate. In these examples, a laser, or other technology included in scanning module 364 may constantly operate and may scan an item ID code when the user places the item including the item ID code in front of scanning module 364.

In some examples, item ID codes may not be included on items as printed codes. Instead, items may include RFID tags that include the item ID codes. It is contemplated that scanning module 364 may include an RFID tag reader in addition to, or instead of, optical scanning technology in order to allow scanning module 364 to scan RFID tags. Accordingly, scanning module 364 may also represent RFID reader electronics/software for scanning RFID tags.

MSD 350 includes a location detection module 372 that receives a location signal and determines a location value based on the received location signal. A location indicator 374 that transmits location signal 376 is included in FIG. 24 to indicate that location detection module 372 is configured to receive location signals. Location detection module 372 may generally represent any devices (e.g., electronic hardware and software) capable of receiving location signals and generating location values described herein. In some examples, location detection module 372 may include an antenna for receiving location signals transmitted by antennas included on location indicators. In other examples, location detection module 372 may include a light detection device for receiving location signals transmitted by light emitting devices (e.g., LEDs or other photonic devices). In other examples, location detection module 372 may include an acoustic device for receiving location signals (e.g., sound waves) transmitted by an acoustic device. In other examples, where location indicators in the store include RFID tags, location detection module 372 may be configured to scan the RFID tags and determine a location value based on the data retrieved from the RFID tags. Additionally, in some examples, location detection module 372 may be configured to transmit energy to energize RFID tags so that the RFID tags may transmit data to location detection module 372.

MSD 350 includes a power source 378 that delivers operating power to the components of MSD 350. Power source 378 may include a fixed or removable battery in some examples. In some examples, power source 378 may include an adapter for charging the battery.

Processing module 358 may receive input and data from various components of MSD 350. For example, processing module 358 may receive user input from user interface 356 and touchscreen display 354. Additionally, processing module 358 may receive data from communication module 362 (e.g., received wireless data and customer orders), scanning module 364 (e.g., item IDs), and location detection module 372 (e.g., location values). Processing module 358 may also receive data from memory 360 (e.g., a location map and associations between items and location values).

Processing module 358 may also send data to components of MSD 350. For example, processing module 358 may store a list of items in memory 360 from the customer orders that have been placed. Processing module 358 may store the items of customer orders in memory 360 as follows. When a customer order is placed, a communication system (e.g., communication system 112) may transmit the customer order to communication module 362. Processing module 358 may then store the received customer order in memory 360. Processing module 358 may then update the customer orders in memory 360 as new customer orders are placed.

Processing module 358 may also control components of MSD 350, such as touchscreen display 354 and scanning module 364. For example, processing module 358 may control the image (e.g., the ordered items) displayed on touchscreen display 354. Additionally, processing module 358 may control when scanning module 364 scans an item. For example, when processing module 358 detects a user pushing a scan button (e.g., a trigger) of user interface 356, processing module 358 may instruct scanning module 364 to scan an item ID code. After scanning module 364 scans an item ID code, scanning module 364 may send the item ID code to processing module 358. As described hereinafter, processing module 358 may keep track of which items have been scanned by MSD 350 and other MSDs. For example, processing module 358 may remove the item ID code from the list of currently ordered items in memory 360 after the item has been scanned.

Although the MSDs are illustrated in FIGS. 24-25 as rectangular, MSD 350 may be configured into a variety of different form factors. In general, MSD 350 may have a form factor that may be transported by a user throughout the store. In some examples, MSD 350 may have a handheld form factor. In other examples, MSD 350 may be configured to be placed in, or attached to, a cart and moved around the store by a user.

In some examples, components of MSD 350 may be included in a single housing (e.g., a molded plastic housing). For example, touchscreen display 354, user interface 356, memory 360, communication module 362, processing module 358, scanning module 364, location detection module 372, and power source 378 may be housed in a single housing. When housed in the single housing, in some examples, MSD 350 may be embodied as a hand-held computing device that a user may easily transport throughout the store.

Although the MSDs in FIGS. 24-25 are illustrated as included in a single rectangular housing, it is contemplated that components of MSDs may be housed in multiple different housings. In these examples, the different components of MSDs may be wired together or may wirelessly communicate with one another. Example MSD form factors are illustrated in FIGS. 26A-26I.

FIG. 26A shows an example from factor 380 in which an MSD of the present disclosure may be implemented. The example device pictured in FIG. 26A is an XG100 W mobile computer available from Janam Technologies. Form factor 380 includes a display 382, keypad 384, and an example scanning module 386 (e.g., barcode reader). Although not shown in FIG. 26A, form factor 380 may be configured to include an internal communication module, memory, processing module, and power source according to the present disclosure. In examples where a store includes location indicators that have readable codes, scanning module 386 may also act as a location detection module. In examples where location indicators transmit location signals, additional components may be added to form factor 380 so that form factor 380 is configured to receive transmitted location signals. For example, an antenna, a light detection device, an acoustic device, and/or an RFID reader may be added to the form factor to receive transmitted location signals.

FIG. 26B shows an example from factor 388 in which an MSD of the present disclosure may be implemented. The example device of FIG. 26B is an Alien ALH-9000 handheld RFID reader available from Alien Technology. Form factor 388 includes a display 390, keypad 392, an example location detection module 394 (e.g., an RFID reader), and an example scanning module 396 (e.g., a barcode reader). Although not shown in FIG. 26B, form factor 388 may be configured to include an internal communication module, memory, processing module, and power source according to the present disclosure.

FIG. 26C shows an example from factor 398 in which an MSD of the present disclosure may be implemented. The example device of FIG. 26C is an MC55A0 handheld terminal available from Motorola. Form factor 398 includes a display 400, keypad 402, and an example scanning module (not shown) (e.g., barcode reader). Although not shown in FIG. 26C, form factor 398 may be configured to include an internal communication module, memory, processing module, and power source according to the present disclosure. In examples where a store includes location indicators that have readable codes, the scanning module may also act as a location detection module. In examples where location indicators transmit location signals, additional components may be added to form factor 398 so that form factor 398 is configured to receive transmitted location signals. For example, an antenna, a light detection device, an acoustic device, and/or an RFID reader may be added to the form factor to receive transmitted location signals.

FIG. 26D shows an example from factor 404 in which an MSD of the present disclosure may be implemented. The example device of FIG. 26D is a WT4090 wearable terminal available from Motorola. Form factor 404 includes a display 406, keypad 408, and an example scanning module 410 (e.g., barcode reader). Although not shown in FIG. 26D, form factor 404 may be configured to include an internal communication module, memory, processing module, and power source according to the present disclosure. In examples where a store includes location indicators that have readable codes, scanning module 410 may also act as a location detection module. In examples where location indicators transmit location signals, additional components may be added to form factor 404 so that form factor 404 is configured to receive transmitted location signals. For example, an antenna, a light detection device, an acoustic device, and/or an RFID reader may be added to the form factor to receive transmitted location signals.

FIGS. 26E-26I show example components that may be included in MSDs according to the present disclosure. FIGS. 26E-26F show example scanning modules 412, 414 (e.g., barcode scanners) that may be included in an MSD. For example, scanning modules 412, 414 may be connected to (e.g., wired/wirelessly) other components of an MSD of the present disclosure. The example devices of FIG. 26E-26F represent typical barcode scanners.

FIG. 26G shows an example touchscreen display 416 that may be included in an MSD. For example, such a touchscreen display 416 may be connected to (e.g., wired/wirelessly) other components of a MSD of the present disclosure. The example device of FIG. 26G is an iPad mini available from Apple. FIG. 26H shows an example display 418 (e.g., an electrophoretic display) that may be included in an MSD. For example, such a display 418 may be connected to (e.g., wired/wirelessly) other components of an MSD of the present disclosure. The example device of FIG. 26H is a Kindle available from Amazon. FIG. 26I shows another example display 420 that may be included in an MSD. Display 420 is a heads-up display that may be worn on a user's head (e.g., as a pair of glasses). Display 420 may be connected to (e.g., wired/wirelessly) other components of an MSD of the present disclosure. The example device of FIG. 26I is a Google Glass device available from Google. Although not illustrated in FIGS. 26A-26I, MSDs may also include other computing devices, such as smart phones (e.g., cell phones). Smart phones may include components that provide functionality attributed to the MSDs described herein. For example, smartphones may detect location signals, such as Bluetooth-based location signals, light transmissions from LEDs (e.g., using a camera), and acoustic location signals (e.g., using a microphone). Additionally, smartphones may include a camera or other device that can be used to scan an item ID code (e.g., a barcode). Accordingly, in some implementations, the customers may use their own smart phone devices to pick their own orders according to the present disclosure. Additionally, third party pickers may also use their smart phones (or devices provided by the third party to the pickers) to pick orders.

FIG. 25 shows another example MSD 352. MSD 352 of FIG. 25 is similar to MSD 350 of FIG. 24, except that location detection module 422 of FIG. 25 is different than location detection module 372 of FIG. 24. Location detection module 422 is configured to scan location indicators that include readable codes (e.g., location indicator 424) and determine a location value based on the scanned readable code. In some examples, the scanning functionality of scanning module 364 and location detection module 422 may be combined. For example, if location indicators include barcodes, MSD 352 may include barcode scanning hardware/software that may scan barcodes included on items and scan barcodes included on location indicators.

Location detection module 422 may represent any devices (e.g., electronic hardware, software/firmware) configured to scan readable codes. For example, location detection module 422 may be configured to scan readable codes (e.g., FIGS. 11A-11C) such as barcodes (e.g., linear, 2D, or QR barcodes). Location detection module 422 may include one or more types of technology for scanning readable codes. In some examples, location detection module 422 may include one or more photodiodes and associated electronics/software for reading light and dark portions of a readable code. In some examples, location detection module 422 may include one or more lasers and associated electronics/software for scanning back and forth across readable codes to read the readable codes. In some examples, location detection module 422 may include one or more CCD readers and associated electronics/software for reading light and dark portions of a readable code. In some examples, location detection module 422 may include a camera (e.g., CCD readers or CMOS imaging) and associated image processing electronics/software for interpreting the readable code. For example, location detection module 422 may acquire an image and identify a readable code in the image, even when the image includes other objects, such as items.

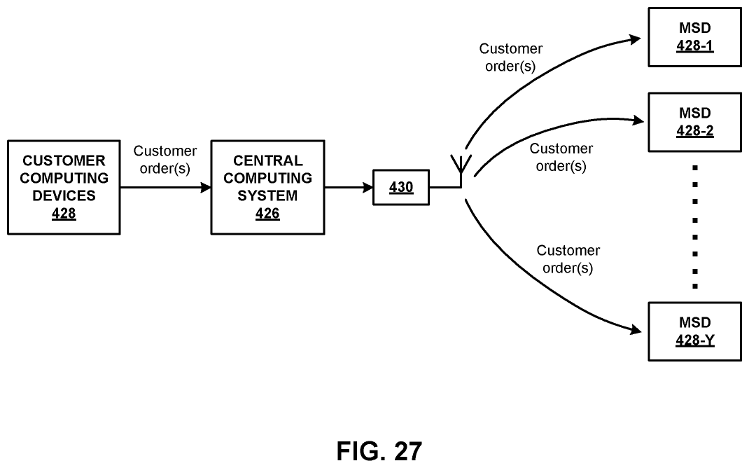

As described above, customers may place customer orders with a CCS. FIG. 27 shows the placement of customer orders with CCS 426 using CCDs 428. In FIG. 27, CCS 426 is configured to wirelessly transmit customer orders to MSDs 428-1, 428-2, . . . , 428-Y (collectively “MSDs 428”) via communication system 430. Each of MSDs 428 may receive the customer orders. Each of MSDs 428 may store the received customer orders in their respective memories.

Each of MSDs 428 may also display at least some of the ordered items on their respective displays. The arrangement of items displayed on each of MSDs 428 may depend on the locations of the MSDs. Arrangement of items on an MSD is described in further detail herein.

Although multiple MSDs 428 are illustrated in FIG. 27, in some examples, a store may include only a single MSD. For example, a store may include only MSD 428-1. In this example, CCS 426 may wirelessly transmit customer orders to MSD 428-1. MSD 428-1 may store the received customer orders in memory. Additionally, MSD 428-1 may determine a location value based a received location signal (or scanned readable code) and arrange the items (e.g., some of the items) of customer orders on the display according to the determined location value.

A store may include any number of MSDs. As described above, a store may include a single MSD in some examples. In other examples, a store may include two or more MSDs. For example, a store may include 10 or more MSDs in some examples.

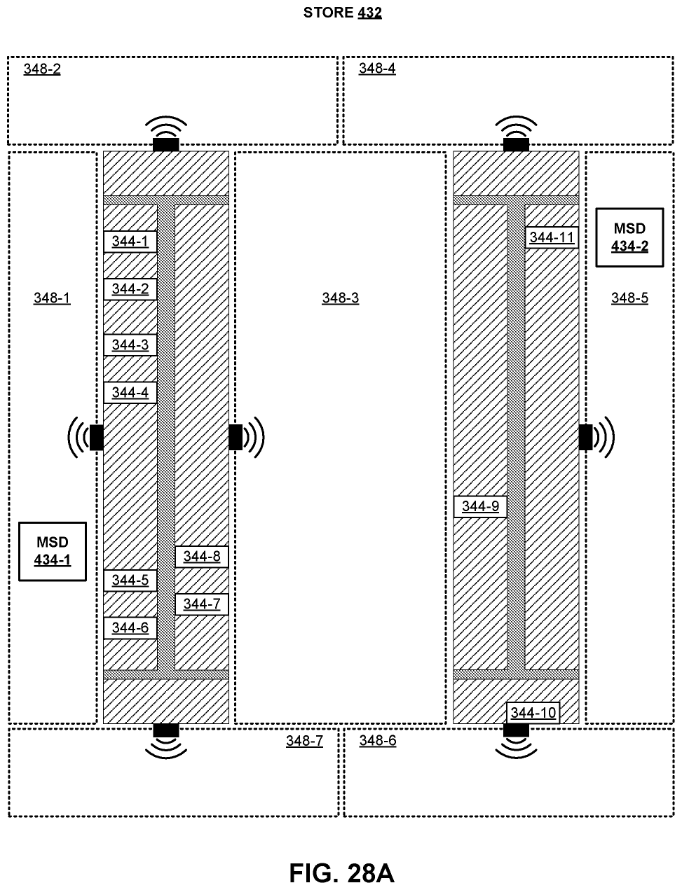

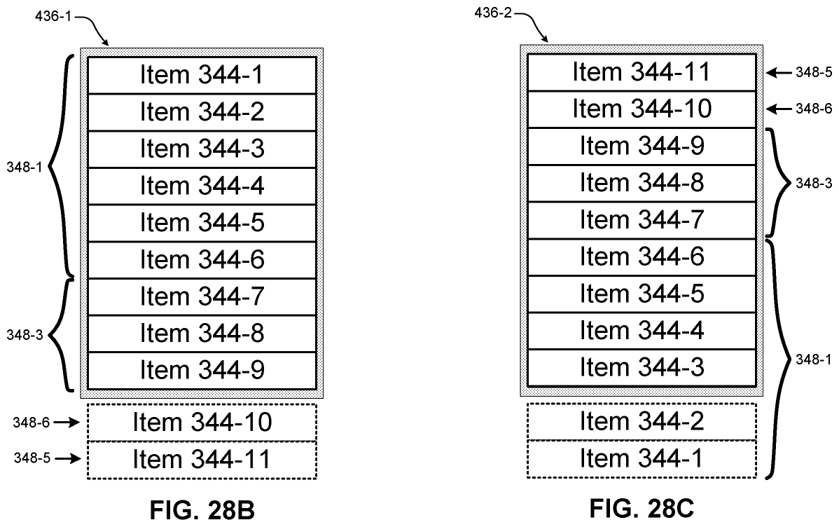

FIGS. 28A-C show how multiple MSDs may display customer orders to users. In FIG. 28A, store 432 includes two MSDs 434-1, 434-2. It can be assumed that each of MSDs 434-1, 434-2 has received one or more customer orders including items 344-1, 344-2, . . . , 344-11 (collectively “items 344”) from a communication system. For example, a single customer order may have included all items 344. As another example, a first customer order may have included items 344-1, 344-2, and a second customer order may have included the remaining items 344-3, 344-4, . . . , 344-11. It may also be assumed that each of the memories of MSDs 434-1, 434-2 include items 344, a location map of store 432, and associations between items 344 and location values 348. The location map 346 of store 432 including items 344 is illustrated in FIG. 23B.

As shown in FIG. 28A, MSD 434-1 is in zone 348-1 which includes items 344-1, 344-2, . . . , 344-6. Accordingly, MSD 434-1 is likely to be nearest to items 344-1, 344-2, . . . , 344-6. According to location map 346, MSD 434-1 is near zone 348-3 including items 344-7, 344-8, 344-9. The next nearest zones including items of customer orders are zones 348-6, 348-5, which include items 344-10, 344-11. Based on the proximity of the zones described above with respect to location map 346, it may be most efficient for a user of MSD 434-1 to pick items from zone 348-1, then zone 348-3, then zone 348-6 and zone 348-5.

MSD 434-2 is in zone 348-5, which includes item 344-11. Accordingly, MSD 434-2 is likely to be nearest to item 344-11. According to location map 346, MSD 434-2 is near zone 348-6 including item 344-10. The next nearest zones including items of customer orders are zone 348-3 and zone 348-1, which include items 344-7, 344-8, 344-9 and items 344-1, 344-2, . . . , 344-6, respectively. Based on the proximity of the zones described above with respect to location map 346, it may be most efficient for a user of MSD 434-2 to pick items from zone 348-5, then zone 348-6, zone 348-3, and zone 348-1.

FIG. 28B shows an example display 436-1 of MSD 434-1 before MSD 434-1 has picked any of items 344. FIG. 28C shows an example display 436-2 of MSD 434-2 before MSD 434-2 has picked any of items 344. In FIG. 28B, display 436-1 of MSD 434-1 has items 344 arranged such that the items nearest to MSD 434-1 are located at the top of display 436-1. In FIG. 28C, display 436-2 of MSD 434-2 has items 344 arranged such that the items nearest to MSD 436-2 are located at the top of display 436-2. The zones that include each of the items are indicated next to displays 436-1, 436-2. Items in dotted boxes under displays 436-1, 436-2 represent those items that may not fit onto displays 436-1, 436-2. Items in dotted boxes may appear on displays 436-1, 436-2 when MSDs 434-1, 434-2 are moved throughout store 432 and/or MSDs 434-1, 434-2 scan one or more of items 344. In some examples, a user may swipe displays 436-1, 436-2 to scroll down the items 344 to reveal those items that are currently not displayed.

It is contemplated that many customer orders (e.g., dozens of orders) may be placed with a store over a relatively short period of time. Each of the customer orders placed may include many items (e.g., dozens of items). Accordingly, the display of an MSD may not be able to sufficiently display all of the items that are currently ordered. Displaying those items which are likely closest to the users of MSDs, as illustrated in FIGS. 28B-28C, may allow the users to easily determine which items to pick. For example, if more than 100 items are currently ordered by customers, each MSD in a store may display 10-20 of the closest items so that the user can focus on picking those 10-20 items. In examples where more items are ordered than may be displayed on a display, the MSDs may determine an order in which to display those ordered items which are not currently displayed. For example, MSDs may arrange the items in memory based on the distances of the items from the MSDs (e.g., using a location map).

As described above, users may scan item IDs of ordered items using MSDs. In general, a user may scan an item ID using an MSD when the user picks the item off a rack. After scanning the item ID code, the user may place the item in a cart and take the item to a collection area of the store where the items of a customer order are put together for customer pickup or delivery. An MSD may communicate to other computing devices that the MSD has scanned an item. For example, an MSD may communicate to the CCS and/or other MSDs that an item ID code has been scanned. Accordingly, the CCS and/or the MSDs may determine which items of the current customer orders have already been picked by other MSDs.

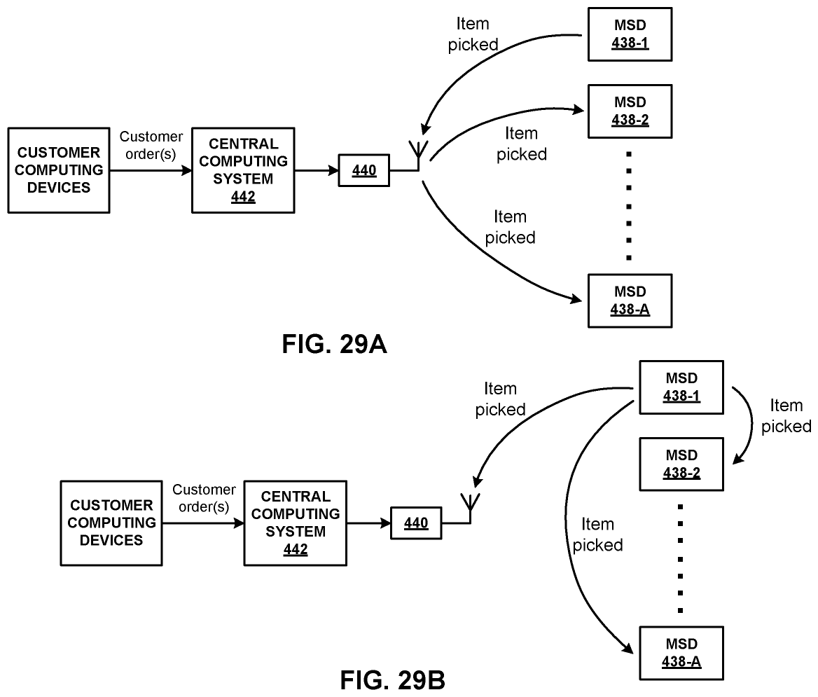

FIGS. 29A-29B show example communications between MSDs and a CCS. In FIGS. 29A-29B, it may be assumed that MSDs 438-1, 438-2, . . . , 438-A (collectively “MSDs 438”) have received customer orders for one or more items. In FIG. 29A, MSD 438-1 scans an item ID code and communicates back to communication system 440 that the item has been picked. Communication system 440 may indicate to CCS 442 that the item has been picked. Based on this information, CCS 442 may update the status of the customer orders in CCS 442 to indicate that the item has been picked. Additionally, or alternatively, CCS 442 may indicate to MSDs 438-2, . . . , 438-A that the item has been picked. MSDs 438 may update their memories to indicate that the item has been picked. For example, MSDs 438 may delete the item from memory and/or remove the items from their displays because users of MSDs 438 no longer need to pick the item.

In FIG. 29B, MSD 438 scans an item ID code and communicates back to communication system 440 and MSDs 438-2, . . . , 438-A that the item has been picked. In FIG. 29B, MSDs 438 are configured to communicate with one another, which may allow any of MSDs 438 to indicate to any other one of MSDs 438 that an item has been picked. MSD 438-1 may also indicate to CCS 442, via communication system 440, that the item has been picked so that CCS 442 may keep track of which items are currently picked. MSDs 438 may update their memories to indicate that the item has been picked. For example, MSDs 438 may delete the item from memory and/or remove the items from their displays because users of MSDs 438 no longer need to pick the item.

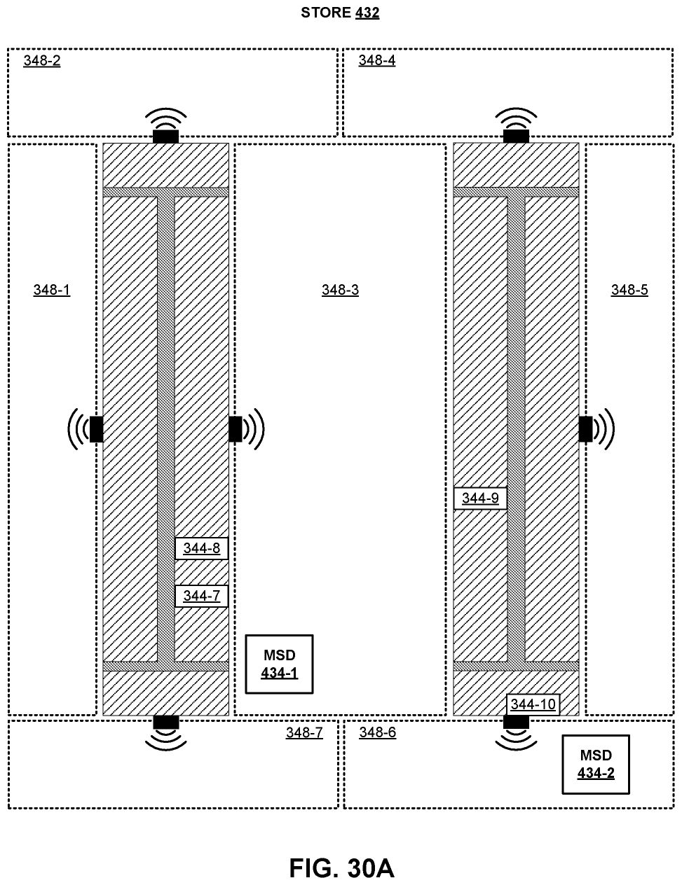

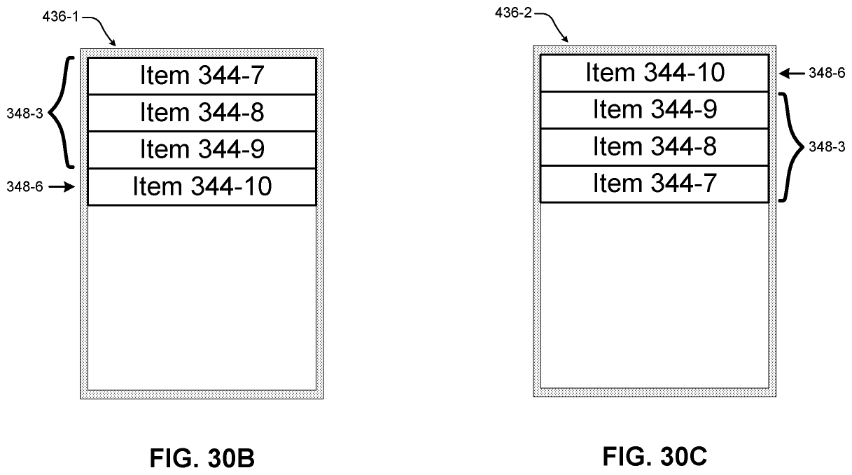

FIGS. 30A-30C show store 432 and MSDs 434-1, 434-2 of FIGS. 28A-28C after MSDs 434-1, 434-2 have moved through store 432 and picked some items. In FIG. 30A, MSD 434-1 has scanned items 344-1, . . . , 344-6 and been moved from zone 348-1 to zone 348-3. In FIG. 30A, MSD 434-2 has scanned item 344-11 and been moved from zone 348-5 to zone 348-6.

As shown in FIG. 30A, MSD 434-1 is in zone 348-3 which includes items 344-7, 344-8, 344-9. Accordingly, MSD 434-1 is likely to be nearest to items 344-7, 344-8, 344-9. According to location map 346, MSD 434-1 is near zone 348-6 including item 344-10. Based on the proximity of the zones described above with respect to location map 346, it may be most efficient for a user of MSD 434-1 to pick items from zone 348-3, then zone 348-6. In FIG. 30B, display 436-1 of MSD 434-1 has items 344-7, 344-8, 344-9, 344-10 arranged such that the items nearest to MSD 434-1 are located at the top of display 436-1, while the items farthest from MSD 434-1 (e.g., item 344-10) are located farther down display 436-1.

As shown in FIG. 30A, MSD 434-2 is in zone 348-6 which includes item 344-10. Accordingly, MSD 434-2 is likely to be near item 344-10. According to location map 346, MSD 434-2 is near zone 348-3 including items 344-7, 344-8, 344-9. Based on the proximity of the zones described above with respect to location map 346, it may be most efficient for a user of MSD 434-2 to pick items from zone 348-6 and then zone 348-3. In FIG. 30C, display 436-2 of MSD 434-2 has items 344-7, 344-8, 344-9, 344-10 arranged such that the items nearest to MSD 434-2 are located at the top of display 436-2, while the items farthest from MSD 434-2 (e.g., item 344-7, 344-8, 344-9) are located farther down the display.

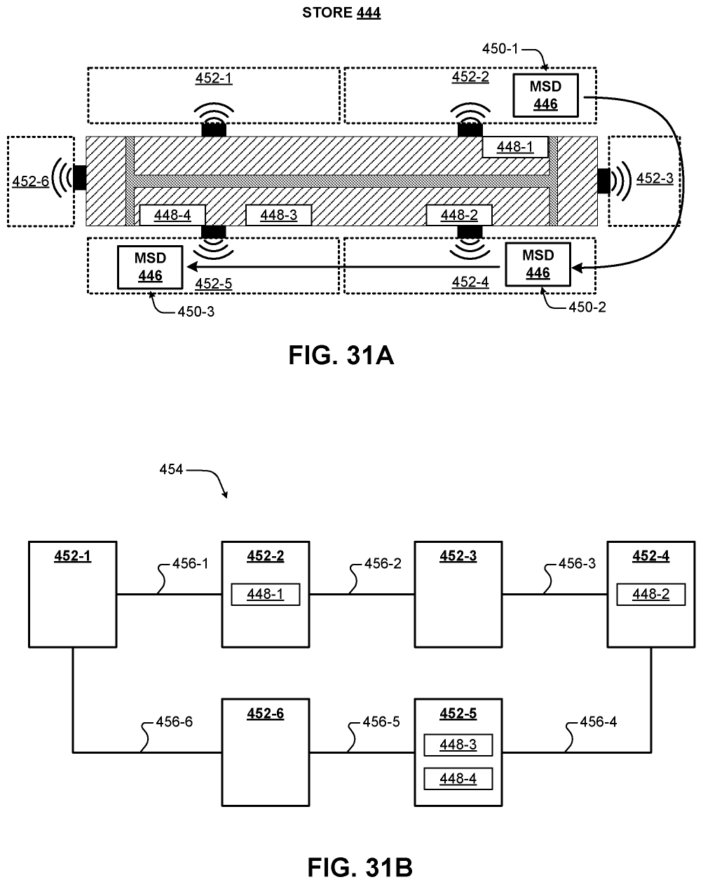

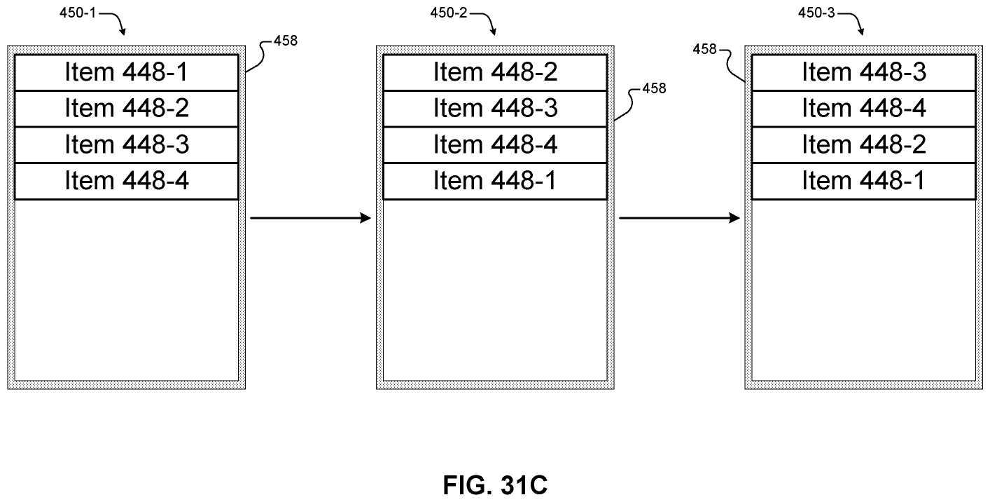

FIGS. 31A-31C show how a display of an MSD may be updated as the MSD is moved throughout a store. FIG. 31A shows a store 444 including an MSD 446. It may be assumed that MSD 446 has received a customer order including items 448-1, 448-2, 448-3, 448-4 (collectively “items 448”). In FIG. 31A, MSD 446 is moved throughout store 444 without picking items 448. Arrows show the path of MSD 446 through store 444. Initially, MSD 446 is at position 450-1 in zone 452-2. MSD 446 then moves to position 450-2 in zone 452-4. Subsequently, MSD 446 moves to position 450-3 in zone 452-5.

FIG. 31B shows a location map 454 of store 444. Location map 454 may be stored in MSD 446 in some examples. Location map 454 includes zones 452-1, 452-2, . . . , 452-6 and junctions 456-1, 456-2, . . . , 456-6. FIG. 31C shows display 458 of MSD 446 at different positions 450-1, 450-2, 450-3 in store 444. MSD 446 may arrange items 448 on display 458 based on location map 454. For example, MSD 446 may arrange items that are nearest to MSD 446 at the top of display 458. MSD 446 may arrange those items that are farther from MSD 446 toward the bottom of display 458. In some circumstances (not illustrated in FIG. 31A), more items may be ordered by customers than could be displayed on display 458. In these circumstances, MSD 446 would include some of the ordered items on display 458 and, as MSD 446 is moved throughout store 444, items that were not originally displayed on display 458 may appear on display 458 as MSD 446 is moved into a zone including those items.

Initially, MSD 446 is located at position 450-1. MSD 446 may determine location value 452-2 in zone 452-2. According to location map 454, item 448-1 is located in zone 452-2. Accordingly, as illustrated in FIG. 31C, MSD 446 may display item 448-1 at the top of display 458. MSD 446 may determine that item 448-2 is the next nearest ordered item since item 448-2 is two junctions 456-2, 456-3 from zone 452-2. Accordingly, item 448-2 may be displayed below item 448-1 on display 458 when MSD 446 is at position 450-1. Items 448-3, 448-4, which are located farthest from zone 452-2 may be displayed at the bottom of the items displayed on display 458 since those items are farthest from zone 452-2.

As illustrated in FIG. 31A, MSD 446 is moved from position 450-1 to position 450-2. MSD 446 may determine location value 452-4 at position 450-2. In zone 452-4, MSD 446 may determine that item 448-2 is nearest to MSD 446. MSD 446 may also determine that items 448-3, 448-4 are the next nearest ordered items because zone 452-5 is adjacent to zone 452-4. Additionally, MSD 446 may determine that item 448-1 is farthest from MSD 446. Accordingly, as illustrated in FIG. 31C, items 448-2, 448-3, 448-4, 448-1 are arranged from the top of display 458 to the bottom of display 458 when MSD 446 is at position 450-2.

As illustrated in FIG. 31A, MSD 446 is moved from position 450-2 to position 450-3. MSD 446 may determine location value 452-5 at position 450-3. In zone 452-5, MSD 446 may determine that items 448-3, 448-4 are nearest to MSD 446. MSD 446 may also determine that item 448-2 is the next nearest ordered item because zone 452-4 is adjacent to zone 452-5. Additionally, MSD 446 may determine that item 448-1 is farthest from MSD 446. Accordingly, as illustrated in FIG. 31C, items 448-3, 448-4, 448-2, 448-1 are arranged from the top of display 458 to the bottom of display 458 when MSD 446 is at position 450-3.

Although an MSD may arrange items nearest to the MSD near the top of the display, the items nearest to the MSD may be indicated on the display in another manner. For example, an MSD may arrange the nearest items near the bottom of the display. In other examples, the MSD may display the nearest items in bold font. In other examples, the MSD may display the nearest items in larger font. In still other examples, the MSD may display the nearest items in different colors.

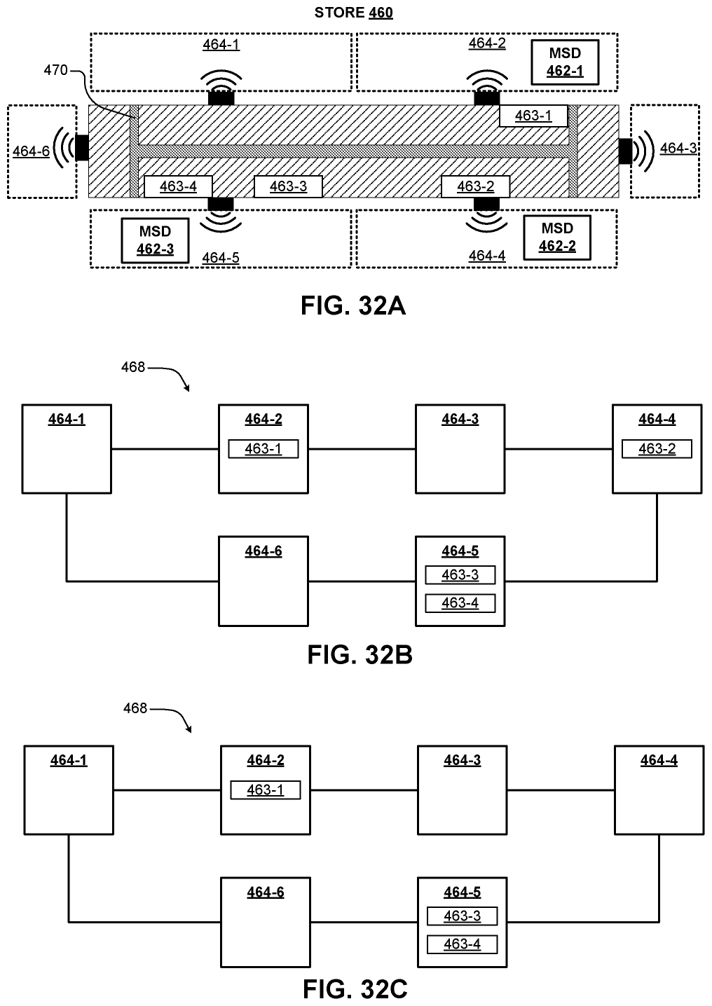

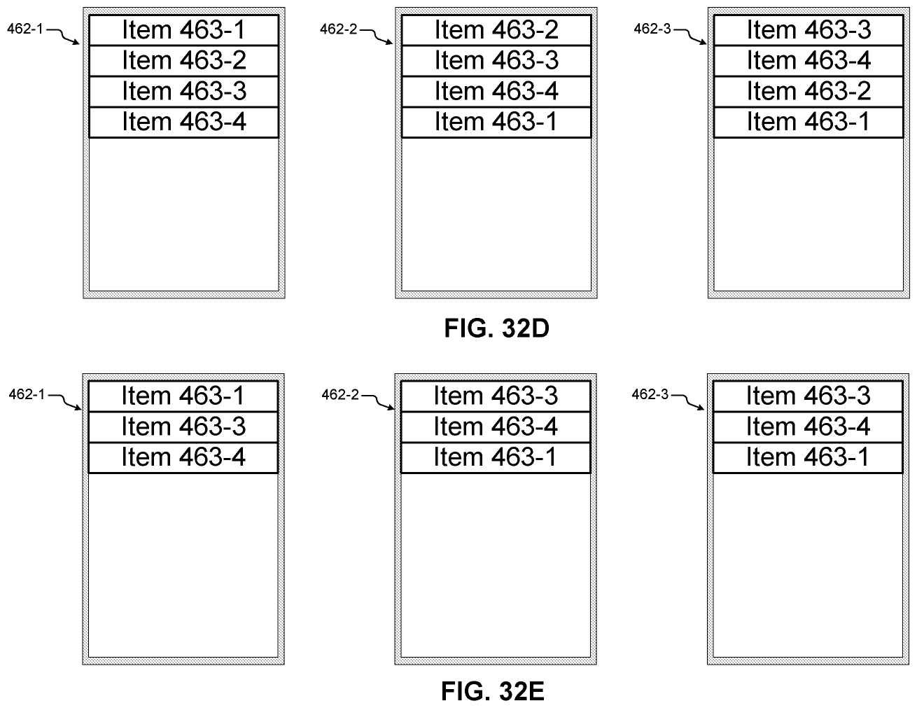

FIGS. 32A-32E show displays of multiple MSDs and how the displays are updated when items are picked. FIG. 32A shows a store 460 including MSDs 462-1, 462-2, 462-3. It may be assumed that MSDs 462-1, 462-2, 462-3 have received a customer order including items 463-1, 463-2, 463-3, 463-4 (collectively “items 463”). In FIGS. 32A-32E, it may be assumed that each of MSDs 462-1, 462-2, 462-3 is maintained in the zones illustrated in FIG. 32A. For example, MSD 462-1 is maintained in zone 464-2. MSD 462-2 is maintained in zone 464-4. MSD 462-3 is maintained in zone 464-5.

FIG. 32B shows a location map 468 before any of items 463 are scanned. FIG. 32D shows displays of each of MSDs 462-1, 462-2, 462-3 before any of items 463 are scanned. Referring back to FIG. 32A, MSD 462-2 may scan the item ID code of item 463-2. For example, a user may pick item 463-2 from rack 470, scan a barcode on item 463-2 using MSD 462-2, and place item 463-2 into a cart. MSD 462-2 may transmit data to other MSDs 462-1, 462-3 indicating that item 463-2 has been picked. For example, MSD 462-2 may transmit an indication to the communication system that item 463-2 has been picked. The communication system may then indicate to MSDs 462-1, 462-3 that item 463-2 has been picked. In response to such an indication, MSDs 462-1, 463-3 may remove item 463-2 from their displays. In examples where MSD 462-2 may directly communicate with MSDs 462-1, 462-3, MSD 462-2 may wirelessly transmit data to other MSDs 462-1, 462-3 indicating that item 463-2 has been picked. In response to such an indication from MSD 462-2, MSDs 462-1, 462-3 may remove item 463-2 from their displays.

FIG. 32C shows an updated location map 468 in which item 463-2 has been removed after item 463-2 has been picked. Location map 468 of FIG. 32C including items 463-1, 463-3, 463-4 may be representative of a location map included in MSDs 462-1, 462-2, 462-3 after MSDs 462-1, 462-3 are notified that item 463-2 has been picked. For example, location map 468 of FIG. 32C may represent the location map of MSD 462-2 after MSD 462-2 scans item 463-2. Similarly, location map 468 of FIG. 32C may represent the location maps of MSDs 462-1, 462-3 after MSDs 462-1, 462-3 have received indications that item 463-2 has been picked. FIG. 32E shows updated displays of MSDs 462-1, 462-2, 462-3 in which MSDs 462-1, 462-2, 462-3 have removed item 463-2 from their displays.

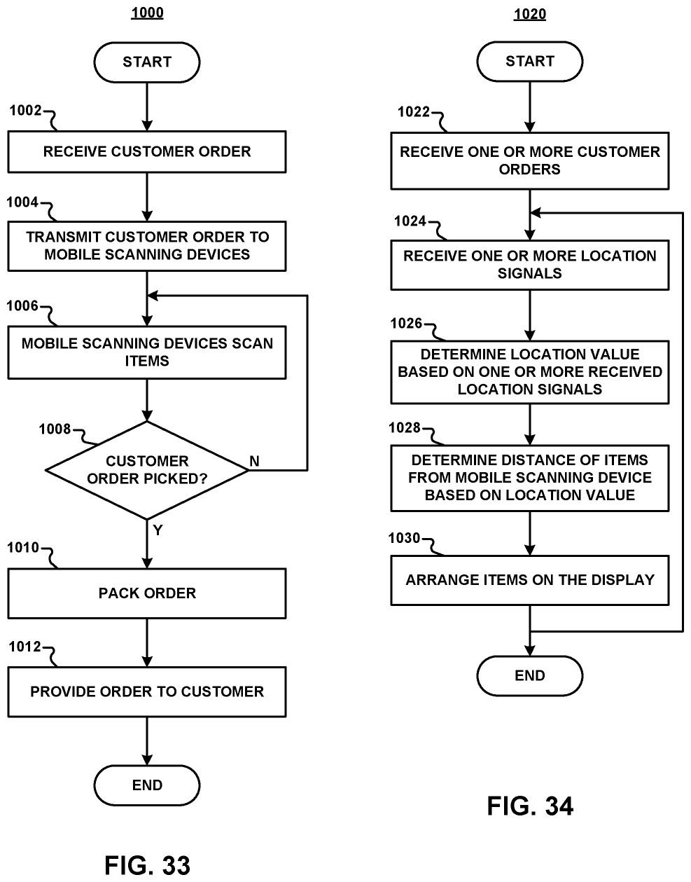

FIGS. 33-36 illustrate methods that describe operations of the OFS. FIG. 33 is a method 1000 that describes operation of an OFS from receipt of a customer order until the order is provided to the customer. The method 1000 of FIG. 33 is now described with reference to FIG. 1. At 1002, the CCS receives a customer order from CCDs. At 1004, the CCS wirelessly transmits the customer order to one or more MSDs via the communication system. At 1006, the MSDs are transported throughout the store 100 by users that scan items of the customer order. The users may pick the items from the racks before scanning the items. The users may place the items in a cart after scanning the items.

If the customer order has not been picked at 1008, the users may continue picking the customer order until the entire customer order is picked. At 1010, the users may assemble the items from the customer order (e.g., in a collection/packing area of the store 100) and pack the items of the customer order (e.g., in grocery bags and/or boxes). In some cases, the users may pack the items for orders as the items are being picked. At 1012, the filled customer order is provided to the customer. For example, the filled customer order may be picked up by the customer at the store 100. In other examples, the filled customer order may be delivered to the customer's home.

FIG. 34 is a method 1020 that describes operation of an MSD configured to receive location signals. At 1022, the MSD receives one or more customer orders via a communication module. At 1024, the MSD receives one or more location signals. For example, the location detection module detects one or more location signals. At 1026, the MSD determines a location value based on the one or more received location signals. For example, the location detection module determines a location value based on the one or more received location signals.

At 1028, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1030, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. For example, the MSD may display items in the current area at the top of the display. Additionally, or alternatively, the MSD may display the items in bold and/or colored text to indicate those items that are in proximity to the user. In some implementations, the MSD may arrange items on the display based on the number of junctions between the user and the items. For example, the MSD may display items more prominently that are separated from the user by a smaller number of junctions. In some implementations, the MSD may arrange items on the display based on the number of junctions between the user and the items along with the number of items in a particular area. For example, the MSD may tend to display items that are closer to the user more prominently, unless many items are located in another direction at a slightly longer distance. In this manner, the MSD may persuade the user to pick the largest amount of items in the smallest amount of time. In some implementations, the MSD may generate routes based on the number of items in zones and the distance of the zones from the MSD. For example, an MSD can prefer showing items in zones that are closer and/or associated with more items.

Method 1020 may continue at 1024 as the MSD is moved throughout the store. For example, while picking the one or more received customer orders, the MSD may be moved into areas of the store that receive different location signals. The MSD may determine a new location value based on the different location signals and update the display (e.g., in real-time) to reflect the distance of items from the MSD at the new location.

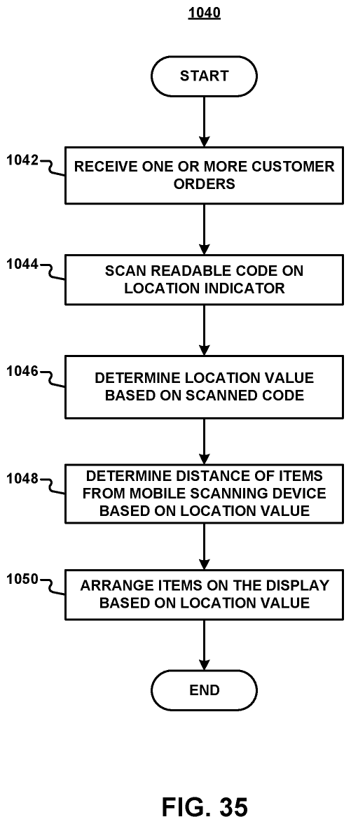

FIG. 35 is a method 1040 that describes operation of an MSD that is configured to determine location values by scanning location indicators that include readable codes. At 1042, the MSD receives one or more customer orders via a communication module. At 1044, the MSD scans a readable code of a location indicator. For example, the location detection module may scan a readable code. At 1046, the MSD determines a location value based on the scanned readable code. For example, the location detection module determines a location value based on the scanned readable code.

At 1048, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1050, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. Method 1040 may continue at 1044 as the MSD is moved throughout the store and new location indicators are scanned. For example, while picking the one or more received customer orders, the MSD may be moved into areas of the store in which the MSD scans different readable codes. The MSD may determine a new location value based on the different readable codes and update the display (e.g., in real-time) to reflect the distance of items from the MSD at the new location.

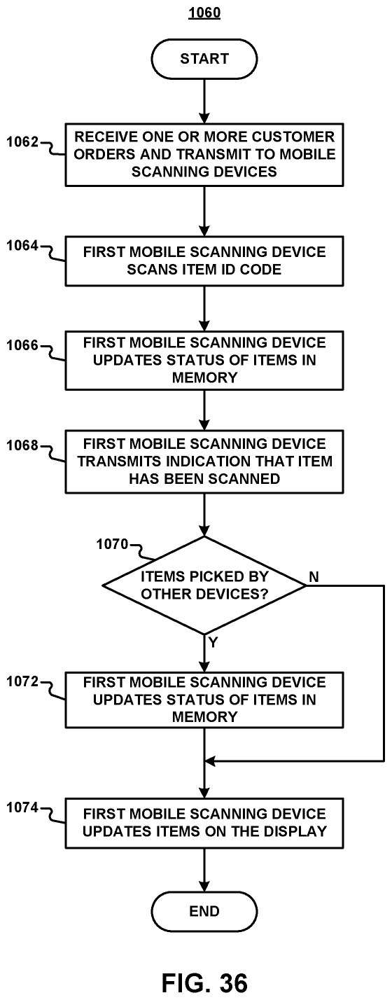

FIG. 36 is a method 1060 that describes operation of an MSD when items are picked by the MSD and other MSDs. The method 1060 of FIG. 36 is now described with reference to FIG. 1. At 1062, the CCS receives one or more customer orders from CCDs and transmits the one or more customer orders to the MSDs via the communication system. At 1064, the first MSD scans an item ID code of one of the items included in the customer orders. At 1066, the first MSD updates the status of the items in memory to indicate that the item has been scanned.

At 1068, the first MSD transmits an indication that the item has been scanned. For example, the first MSD may indicate to the CCS that the item has been scanned. In turn, the CCS may indicate to the second MSD that the item has been scanned so that the second MSD may update the status of items in memory of the second MSD. In other examples, the first MSD may transmit the indication directly to the second MSD.

At 1070, the first MSD determines whether other items have been scanned by the second MSD. The first MSD may determine that other items have been scanned by the second MSD when the first MSD receives an indication (e.g., from the CCS) that the second MSD has scanned other items. If the second MSD has not scanned any other items, method 1060 may continue in block 1074. If the second MSD has scanned other items, the first MSD may update the status of items in memory in block 1072 to indicate that the other items have been picked (e.g., based on indications received from the CCS). At 1074, the first MSD may update the display to indicate which items have been scanned. For example, the first MSD may remove the scanned item(s) from the display.

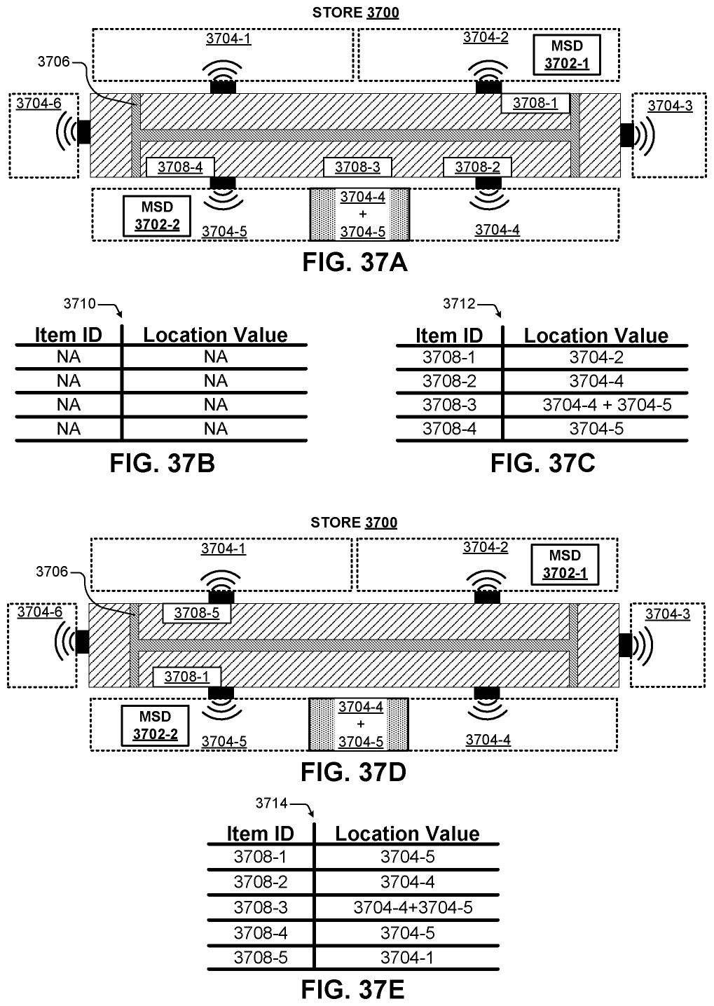

As described above, each of the items in the store may be associated with a location value. The associations between items and location values may be represented herein as an item association table (e.g., item association tables 3710, 3712, 3714 of FIGS. 37B, 37C, 37E). Item association tables (e.g., one or more of the same/similar versions of item association tables) may be stored in memory of the CCS and/or one or more MSDs. In implementations where the CCS stores an item association table, the CCS can transmit the item association table to the one or more MSDs in order to update the item association tables used by the MSDs. In some implementations, the CCS may transmit the item association tables to the MSDs at preselected time intervals (e.g., at periodic intervals). Additionally, or alternatively, the CCS may transmit the item association tables to the MSDs in response to updates to the item association table stored at the CCS. For example, if the CCS updates an item association table (e.g., in response to updates from one or more MSDs), the CCS may transmit the updated item association table to the MSDs in response to the recent update. In some implementations, the MSDs can request the updated item association table from the CCS. For example, the MSDs may be configured to request an up-to-date item association table upon powering up (e.g., from a standby or off state).

In some implementations, an MSD can request the updated item association table from the CCS. The MSD may be configured to receive manual input from the user that causes the MSD to request the item association table. For example, an MSD may receive a user input (e.g., on a touchscreen of the MSD) that instructs the MSD to request the updated item association table. In some examples, the MSD may present the user with an interactive GUI button or other user input (e.g., via a mechanical button) that causes the MSD to request an update of the item association table from the CCS.

In some implementations, the MSD may be configured to automatically request the item association table from the CCS. For example, the MSD may be configured to request the item association table from the CCS at preset times (e.g., periodically or after a threshold amount of time has passed since a most recent update of the item association table stored on the MSD). An MSD may automatically request the item association table in response to other events. For example, an MSD may automatically request an item association table in response to powering on after the MSD has been in an off state or a standby state.

In some cases, the MSDs may not be devices that are owned by the store operator and/or stored at the store. For example, the MSDs used in the store may be brought into the store by third parties and used to pick items for customer orders with the third parties. The third parties may include businesses that provide item delivery services (e.g., grocery delivery services) to customers. These third parties may receive customer orders via the internet, store the customer orders on a TPCS, and transfer the customer orders to the third-party MSDs. Upon entering a store with a third-party MSD, the MSD may be configured to request the item association table from the CCS (e.g., via an internet/cellular connection with the CCS and/or via a local wireless connection). In some cases, the CCS is configured to communicate with a TPCS and may transmit updated item association tables to the TPCS (e.g., in response to requests from the TPCS) so that the TPCS may store an updated version of the store's item association table.

A third-party MSD may request an item association table from the TPCS (e.g., via the internet). Additionally, or alternatively, the third-party MSD may request an item association table from the CCS. The CCS may respond to the request from the third-party MSD (e.g., via the internet or wirelessly in the store) by transmitting an item association table to the third-party MSD. A third-party MSD can make a request for an updated item association table (e.g., from the CCS and/or the third-party computing system) in response to a variety of events. In some implementations, a third party-MSD may make a request automatically in response to the current location of the third party MSD. For example, a third-party MSD can be configured to request an item association table based on the proximity of the third-party MSD relative to the store. In one example, a third-party MSD may be configured to request an item association table in response to being located within a predetermined distance of the store, such as upon coming within a predetermined distance from the store or entering the store. The third-party MSD may determine location and/or proximity to the store based on a GPS determined location (e.g., from a GPS receiver of the device), based on a wireless connection established in the store (e.g., a WIFI connection between the third-party MSD and the CCS), and/or based on some other form of location determination. In some implementations, the store may include store indicators (e.g., barcodes, QR codes, RFID tags, or other indicators) that may uniquely identify the store to a third-party MSD. Such store indicators may be placed at one or more entry points of the store for example. In these implementations, the third-party MSD can scan the store indicator and then request the item association table for the store corresponding to the store indicator.

In some implementations, the third-party users may manually request the item association table for the store (e.g., using a GUI of the third-party MSD). As another example, a third-party MSD may automatically request an item association table for a store in response to the third-party user selecting the store as the next store from which to pick (e.g., from a group of stores).

In some cases, shoppers at a store (e.g., a grocery store) may use their own devices (referred to herein as “personal scanning devices” or “customer computing devices”) to assist in routing them throughout the store. As described herein, the CCDs can include similar functionality to the MSDs that allows the CCDs to interact with the OFS (e.g., the CCS and the location indicators). For example, the CCDs may include wireless communication functionality (e.g., WiFi or Bluetooth) for communicating with the CCS, location signal detection functionality (e.g., Bluetooth receivers for detecting Bluetooth based location signals and/or light detection functionality such as a camera), and item ID scanning functionality (e.g., a camera). Example CCDs may include computing devices having a variety of different form factors including, but not limited to, smartphones, tablets, and any other handheld or wearable device. A CCD may execute an application (e.g., a native application installed on the CCD) or access a web application that performs similar functionality attributed to the MSDs herein (e.g., the CCD may receive location signals, scan barcodes, determines location values, store a location map, and organize items on the display based on the location of the items relative to the user). The application executing on the CCDs may be provided to the personal scanning devices by the operator of the store (e.g., via a download from an application distribution platform, such as Google Play or Apple iTunes).

As described herein, different parties may use MSDs to pick customer orders. For example, employees of the store may use MSDs to pick customer orders. Additionally, or alternatively, third-party users (e.g., employees of a third party) may use MSDs (e.g., owned by the third parties or the store owners) to pick customer orders. Customers may also use their own devices to pick their own orders. In some implementations of the OFS, any of these parties may pick orders within the same store at the same time, or at different times. In other cases, the OFS may be configured to only allow certain parties to pick items.

As described above, MSDs can request updated item association tables from the CCS or TPCS. As described herein, the MSDs may also request other data from the CCS or TPCS, such as updated location maps and/or item adjacency maps (e.g., at preset times and/or in response to a user command). In some implementations, the CCS may request location maps and/or item adjacency maps from the MSDs (e.g., at preset times). In general, the CCS, TPCS, MSDs, and/or CCDs may transfer data between one another based on any factors described herein, such as the factors described for requesting an item association table above.

In some circumstances, items may not be associated with location values. In one example, items may not yet be associated with location values when the location indicators are initially placed in the store. This example may occur when a store is initially equipped with the OFS (e.g., location indicators, MSDs, and the CCS). In another example, items that have been newly added to the racks of the store may not yet be associated with location values. Similarly, when the OFS is initially set up, item adjacency maps may not be initially completed. Over time, the item adjacency maps may be completed as described herein. A TPCS and/or third-party MSDs may also initially include incomplete item association tables, location maps, and item adjacency maps. A TPCS and/or third party-MSDs may acquire (e.g., download) the tables and maps from the CCS. In some implementations, a TPCS and/or third-party MSDs may download different tables and maps for different stores. In some implementations, at TPCS and/or third-party MSDs may generate their own tables and maps independently from the tables and maps included in the CCS. In some cases, a TPCS and/or third-party MSDs may initially acquire tables and maps for a store from the store CCS, and then update the tables and maps over time in a manner that differs from the initial store tables and maps.

In other circumstances described herein, items may be associated with an incorrect association value. For example, an item may initially be associated with a first location value when the item is placed in a first location in the store. Later, the item may be moved to a different place in the store that is associated with a different location. In these circumstances, the location value associated with an item may be updated. Different ways to associate items with a location value and update the associations are described herein.

Items may be associated with location values using a variety of different techniques. In some examples, associations between items and location values may be entered manually by a user. For example, a user may manually populate an item association table using a computing device, such as a desktop computer, laptop computer, an MSD, etc. Put another way, a computing device (e.g., an MSD or other computing device) may be configured to receive manual input from a user, generate associations between items and location values based on the manual input, and store the associations at the CCS. In some implementations, a user may use a keyboard (e.g., on an MSD or other computing device), a touchscreen computing device, or similar device, to populate the item association table. For example, a user may place location indicators in a store and manually associate items with location values that will be determined in proximity to the items. In a more specific example, when a location indicator includes a readable code, a user may place the location indicator on a rack, and then manually associate each of the items on the rack with the location value that is determined based on the readable code of the location indicator. In another specific example, when a location indicator transmits a location signal, a user may place the location indicator on a rack, and then manually associate each of the items near the area where the location signal will be transmitted to the location value that will be determined based on detection of the location signal.

Generating an item association table manually (e.g., manually entered into a user interface on a computing device) may be a somewhat cumbersome process because a store may include thousands of items. Additionally, a user may be prone to errors when manually generating an item association table. Manual generation of an item association table may also be somewhat inaccurate in examples where location indicators transmit signals because a user may not accurately predict exactly where location signals will be transmitted. Although it is contemplated that item association tables including a large number of items could be manually generated, other techniques for generating item association tables described herein may prove more effective. Although other techniques may prove more effective than manually entering item associations, manually entering some item associations may be effective in cases where a few item associations are to be made.

An item association table may be generated automatically (e.g., using an item association mode and/or during normal picking). In some examples, a user may set the MSD into an “item association mode” causing the MSD to generate the item association table by determining location values and scanning items. In general, an “item association mode” may refer to a state (e.g., a mode of operation) of an MSD which may be selected by a user to generate one or more associations between items and location values. A user may set an MSD into the item association mode using the touchscreen display of the MSD and/or the user interface, for example.

When operating in an item association mode, the MSD may determine a location value and associate that location value with a scanned item. In examples where a store includes location indicators having readable codes, the user may first use the MSD to scan the location indicator to determine a location value. Next, the user may begin using the MSD to scan item ID codes. For example, the user may scan a plurality of item ID codes after scanning the location indicator. The MSD may then associate each of the scanned item ID codes with the location value determined from the location indicator. Generating an item association table in this manner may be faster than manually generating an item association table because a user may quickly scan item ID codes after scanning a single location indicator. Instead of first scanning a location indicator and then scanning item ID codes, in other examples, a user may use the MSD to scan a plurality of item ID codes and then scan an associated location indicator in order to associate the scanned item ID codes with the later scanned location indicator.

When operating in an item association mode in a store that includes location indicators that transmit location signals, the MSD may determine a location value based on one or more received location signals and associate scanned item ID codes with the currently determined location value. Since the MSD may acquire location signals without additional user action, the user may freely walk through the store and scan a plurality of item ID codes to generate an item association table. For example, the MSD may associate scanned item ID codes with a first location value determined in a first location. When the MSD is moved to a second location where the MSD determines a second location value, the MSD may associate scanned item ID codes with the second location value. Generating an item association table in this manner may be faster than manually generating an item association table because a user may quickly scan item ID codes without scanning a location indicator.

In some examples, an MSD may generate and/or update an item association table without the user selecting a specific “item association mode.” Instead, the MSD may generate an item association table while the MSD is being used to pick items of customer orders. For example, if an MSD receives a customer order including a first item that is not associated with a location value, the MSD may generate an entry in an item association table for the first item when the MSD scans the item ID code of the first item. The generated entry in the item association table may include the scanned item ID code and the currently determined location value.

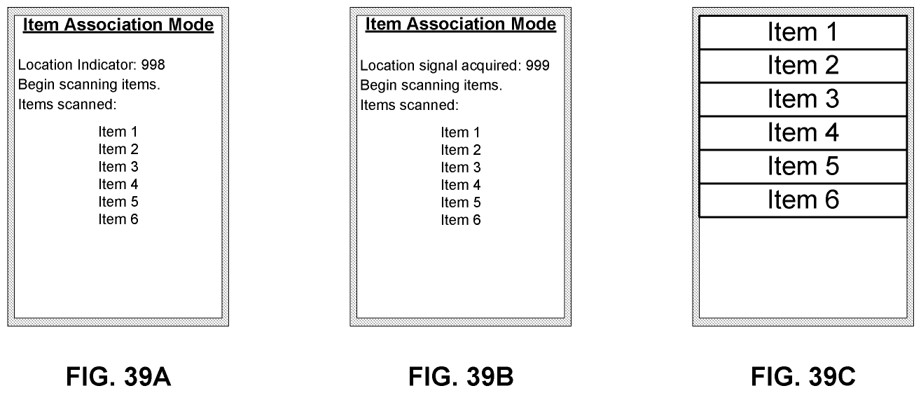

FIGS. 39A-39C illustrate displays of MSDs which may be viewed by a user while generating an item association table. FIGS. 39A-39B illustrate displays of MSDs that are set in an item association mode. The item association modes of the mobile devices of FIGS. 39A-39B may be initiated using the touchscreens and/or user interfaces of the MSDs. In one example, a user may select the “item association mode” from a menu displayed to the user using a touchscreen. In another example, a user may press a dedicated button of the MSD to enter the item association mode. The images on the displays of FIGS. 39A-39B may be displayed to users of MSDs having dedicated item association modes. The image on the display of FIG. 39C may represent an image displayed to a user that is picking items from a store. In FIG. 39C, the MSD may be configured to generate an item association table when the user is picking items. Example operation of MSDs shown in FIGS. 39A-39C are now described. FIGS. 39A-39C are only example images that may be displayed on a display of an MSD. Accordingly, it is contemplated that additional or alternative information may be displayed to a user when generating an item association table.

The image on the display of FIG. 39A may be generated by an MSD used in a store that includes location indicators having readable codes. As indicated on the display, the MSD is operating in an “Item Association Mode.” The user of the MSD may have set the MSD in the item association mode using the touchscreen and/or user interface of the MSD. The display indicates that location indicator 998 has been scanned. After scanning location indicator 998, the display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39A, an item association table would be populated with items 1-6, each of which is associated with the location value 998.

The image on the display of FIG. 39B may be generated by an MSD used in a store that includes location indicators that transmit location signals. As indicated on the display, the MSD is operating in an “Item Association Mode.” The user of the MSD may have set the MSD in the item association mode using the touchscreen and/or user interface of the MSD. The display indicates that the MSD has received a location signal and determined a location value of 999 based on the received location signal. The display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39B, an item association table would be populated with items 1-6, each of which is associated with location value 999.

In some examples, an MSD may generate an item association table without entering a dedicated item association mode. Instead, the MSD may generate an item association table during normal item picking described herein. For example, an MSD may receive a customer order, display the customer order to the user, and generate the item association table as the user picks and scans items of a customer order. The image on the display of FIG. 39C may be an image displayed by an MSD during normal picking of a customer order, as described above.

In FIG. 39C, it may be assumed that a customer order including items 1-6 has been placed with a CCS and that the customer order has been received by the MSD of FIG. 39C. The display displays items 1-6 of the customer order to indicate to the user that items 1-6 should be picked. The MSD may be configured to generate associations in an item association table when the user scans the item ID codes of items 1-6 of the customer order. For example, the MSD may generate an association between item 1 and the currently determined location value (e.g., based on a last scanned readable code or most recently received location signal) when the MSD scans the item ID code of item 1. Similarly, the MSD may generate an association between item 2 and the currently determined location value when the MSD scans the item ID code of item 2. Accordingly, the MSD may have generated associations between items 1-6 and their respective location values after the user has scanned all of items 1-6.

Generating associations in an association table while picking items, as described with reference to FIG. 39C, may provide a positive user experience because the item association table may be generated without the user initiating any additional modes (e.g., an item association mode). Instead, generation of the item association table may happen “in the background,” without burdening the user with the task of actively generating an item association table. In scenarios where most of the items in the store are associated with location values in an item association table, generating updates to the item association table in the manner described with reference to FIG. 39C may also be efficient. For example, items that are moved (e.g., to a different rack) within the store or added to the store may be associated with location values without burdening a user to explicitly update the item association table (e.g., by entering an item association mode).

FIGS. 37A-37E illustrate generation of an item association table and updating of the item association table. Referring now to FIG. 37A, a store 3700 includes location indicators that transmit location signals. MSDs 3702-1, 3702-2 may determine location values 3704-1, 3704-2, . . . , 3704-6, “3704-4+3704-5” in store 3700. Store 3700 includes a rack 3706 that includes items 3708-1, 3708-2, 3708-3, 3708-4. MSDs 3702-1, 3702-2 may be used to generate an item association table including items 3708-1, 3708-2, 3708-3, 3708-4.

FIG. 37B shows an item association table 3710 before any associations are made between items and location values. Item association table 3710 includes an item ID code column and a location value column. Each row of item association table 3710 may be populated to include an association between an item and a location value. Accordingly, the four rows of item association table 3710 may be populated to include four associations. Item association table 3710 of FIG. 37B is filled with “NA” entries indicating that items and location values are in a “non-associated” state. Although item association table 3710 is completely filled with NA entries, in some examples, the table may include item ID codes for items available in the store, with corresponding location values being entered as NA. This may be the case in scenarios where the item association tables are updated to include items in the store, but the items have not yet been associated with location values. Although item association tables 3710, 3712, 3714 illustrated in FIGS. 37B, 37C, and 37E include 4 associations, it is contemplated that an item association table may include thousands of associations or more. In some cases, item association tables may be prefilled with location values, such as a location value in the center of the store, or a location value associated with certain types/categories of products (e.g., frozen food, dry food, etc.).

One or both of MSDs 3702-1, 3702-2 may be used to populate the item association table (e.g., 3710, 3712, 3714). As described above, MSDs 3702-1, 3702-2 may be used to manually enter item associations in some examples. In other examples, the MSDs 3702-1, 3702-2 may automatically generate an item association table for store 3700. In some examples, users may set MSDs 3702-1, 3702-2 into an “item association mode” and generate the item association table, as described above. In other examples described above, MSDs 3702-1, 3702-2 may generate an item association table while MSDs 3702-1, 3702-2 are being used to pick items 3708-1, 3708-2, 3708-3, 3708-4.

FIG. 37C illustrates an item association table 3712 that has been populated to include associations between items 3708 and location values 3704. The associations in item association table 3712 may have been generated by MSD 3702-1 and/or MSD 3702-2. Item association tables may be stored in MSDs 3702 and/or a CCS of store 3700. In one example, MSDs 3702 may be configured to upload associations to the CCS. For example, MSD 3702-1 may generate an association between item ID code 3708-1 and location value 3704-2, and then transmit the association to the CCS. Similarly, MSD 3702-2 may generate an association between item ID code 3708-4 and location value 3704-5, and then transmit the association to the CCS. In this manner, the CCS may receive associations from MSDs 3702 and maintain an item association table that includes item associations generated by each of MSDs 3702. The CCS may transmit the complete item association table to MSDs 3702 so that MSDs 3702 may include a complete updated item association table.

As described above, an item association table may be generated by a plurality of different MSDs. For example, each of the MSDs may generate associations and upload the associations to a CCS that generates a complete item association table based on the associations generated by the plurality of MSDs. The CCS may then transmit the completed item association table to each of the plurality of MSDs so that the MSDs include a complete item association table for operation (e.g., to arrange items on displays to users). Although an item association table may be generated by a plurality of different MSDs, in some examples, a single MSD may be used to generate an item association table.

FIG. 37D shows store 3700 after a new item 3708-5 has been added and after item 3708-1 has been moved. FIG. 37E shows an updated item association table 3714 that includes a new association for item 3708-5 and a different location value associated with item 3708-1. In one scenario, item 3708-5 may not have been included in store 3700 during generation of item association table 3712 of FIG. 37C. Accordingly, item 3708-5 is not present in item association table 3712. In another scenario, item 3708-5 may not have been included in item association table 3712 of FIG. 37C because neither of MSDs 3702 had generated an association between item 3708-5 and a location signal. In either scenario, it may be assumed that one of MSDs 3702 has generated an association including item 3708-5 in FIG. 37D. Accordingly, item association table 3714 of FIG. 37E includes an association between item 3708-5 and location value 3704-1.

Item 3708-1 may have been moved after generating item association table 3712 of FIG. 37C. After initially moving item 3708-1, the association including item 3708-1 may have been incorrect. For example, item 3708-1 may have been associated with location value 3704-2 when item 3708-1 should have been associated with location value 3704-5. After moving item 3708-1, one of MSDs 3702 may generate a new association including item 3708-1. For example, one of MSDs 3702 generated an association between item 3708-1 and location value 3704-5, as shown in association table 3714 of FIG. 37E. Note that a new association including item 3708-1 may replace the old association between item 3708-1 and location value 3704-2. Accordingly, item association table 3714 may be an updated item association table that accurately reflects the movement of item 3708-1 and the addition of a new item 3708-5.

The OFS (e.g., the MSDs and/or CCS) may update the item association table in response to a variety of different factors. In some implementations, the OFS may update the item association table for each scan of an item that indicates the item has been moved to a new location. For example, if an item ID code is initially associated with a first location value, then the OFS determines that the item has been scanned in a new location, the system may update the item association table to reflect that the item is located at the new location. Similarly, if a new item is scanned that has not been previously included in the most recent item association table, the system may update the item association table to include the new item the first time the new item ID is scanned.

In some implementations, instead of updating the item association table after a single item scan (e.g., a new item and/or a moved item), the OFS may require that the items be scanned a number of times (e.g., a threshold number) before updating the item association table. For example, the system (e.g., MSD and/or CCS) may be configured to update the location of an item in the item association table in response to determining that the item has been scanned at a location greater than a threshold number of times (e.g., greater than 3 times). In some implementations, the OFS may require that the item be scanned a threshold number of times consecutively. In other implementations, the OFS may update the item association table to include the most detected location value for the item (e.g., the location value in which the item ID code was most scanned). In a similar manner, the OFS may require that a new item be scanned a threshold number of times before being entered into the system. Putting restrictions on updating the item association table (e.g., requiring a number of scans) may help maintain a stable and accurate OFS that rejects outlying item scans (e.g., in scenarios where a user picks up an item and does not scan the item until the item has been moved a great distance throughout the store).

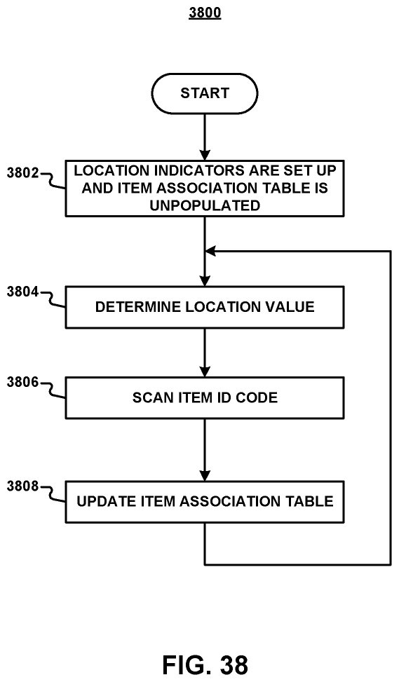

FIG. 38 shows an example method 3800 for generating and updating an item association table. At 3802, location indicators are set up in a store and an item association table for the store is initially unpopulated. For example, the item association table may include NA entries. At 3804, an MSD may determine a location value. For example, the MSD may receive a location signal and determine a location value based on the received location signal.

At 3806, the MSD may scan an item ID code. At 3808, the MSD may generate an association between the currently determined location value and the scanned item ID code. The MSD may then transmit the association to the CCS so that the CCS may maintain an up-to-date item association table, which may be modified by updates from any of a plurality of MSDs in the store. The method 3800 may then return to block 3804. Subsequently, the CCS may again update the item association table based on associations received from one or more MSDs according to method 3800. The method 3800 may be modified according to the disclosure included herein.

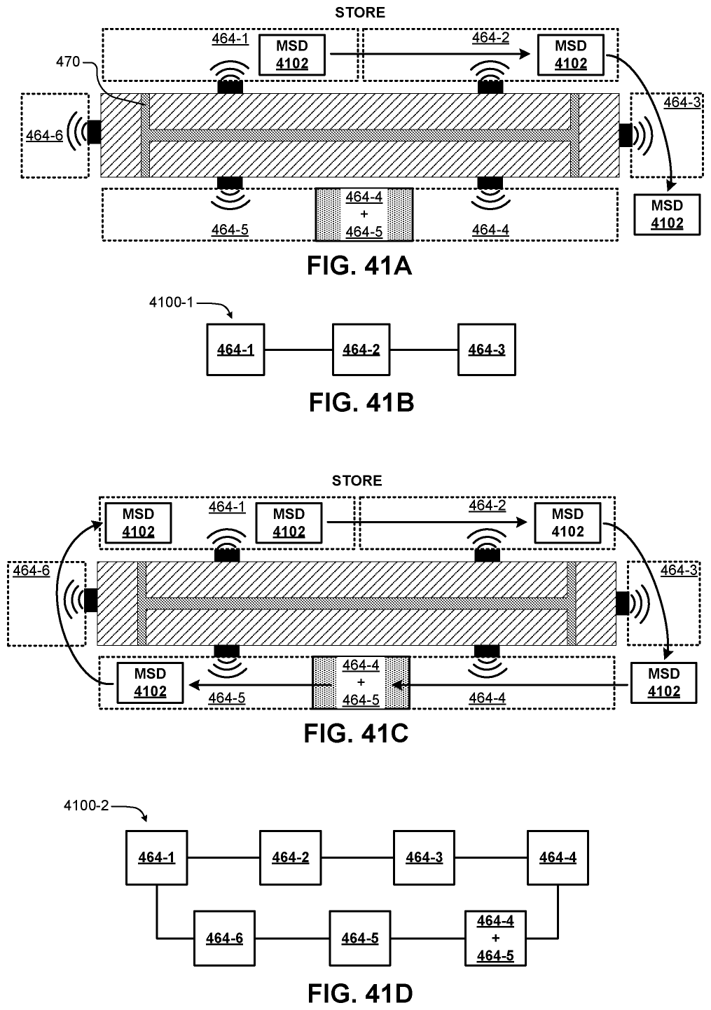

FIGS. 41A-41D illustrate generation of a location map using a single MSD 4102. As described above, one or more computing devices may store a location map that defines the spatial relationships between different areas of a store. For example, a location map may define the relative distances between different areas of the store. In some examples, two areas of the store may be adjacent to one another. In some examples, two adjacent areas may be touching one another. In other examples, two areas may be adjacent to one another when they are separated by a “dead zone.” Two areas may not be adjacent to one another when the shortest path between the two areas includes one or more additional areas. In stores including location indicators that transmit location signals, the location map may define how the areas of the store covered by the location signals are arranged relative to one another. In stores that include location indicators having readable codes, the location map may define how the location indicators (i.e., readable codes) are arranged relative to one another.

A location map may not yet be generated for a store when location indicators are initially placed in the store. This may occur when a store is initially equipped with the OFS (e.g., location indicators, MSDs, and the CCS). The OFS may generate a location map for a store after the location indicators are placed in the store. Location maps may be generated manually by a user in some examples (e.g., using a computing device and uploading the location map to the CCS). In other examples, a location map may be generated automatically (e.g., by one or more MSDs and/or the CCS). The location maps may be stored in one or more MSDs and/or the CCS.

Location maps may be generated using a variety of different techniques. In some examples, location maps may be entered manually by a user. For example, a user may manually generate a location map using a computing device, such as a desktop computer, laptop computer, an MSD, etc. In this example, a user may use a keyboard, or similar device, to generate the location map. For example, a user may place location indicators in a store and manually generate the location map based on where the location indicators are placed. In some examples, the user may generate the location map first, and then place the location indicators according to the generated location map.

Instead of manually generating a location map, a location map may be generated automatically. In stores including location indicators that transmit location signals, a user may transport an MSD throughout the store to generate a location map automatically. In one example, a user may set an MSD into a “location map generation mode” and transport the MSD throughout the store to generate a location map for the store. In other examples, the OFS may be configured to generate a location map while the user moves the MSD throughout the store picking items of customer orders. For example, the MSDs may maintain a location map locally and then indicate to the CCS when the location map should be updated (e.g., based on the absence of a location signal or one or more newly detected location signals).

Generation of location maps in stores including location indicators that transmit signals is illustrated and described with respect to FIGS. 41A-44B. It may be assumed that the MSDs may automatically generate the location maps while a user is picking items of a customer order displayed on the MSDs and/or using a “location map generation mode” of the MSDs.

When location indicators are initially placed in a store, the location map may be incomplete. A location map that is incomplete may not include each of the areas of the store in a proper arrangement. A location map that is incomplete may be referred to herein as an “incomplete location map.” A location map may be incomplete in a variety of different ways described hereinafter. In some examples, a location map may be incomplete when the location map for the store does not include all of the areas of the store. In another example, the location map may be incomplete when the location map does not include all of the junctions between different areas. In still other examples, the location map may be incomplete when the location map includes too many areas. This may occur when a location indicator breaks and fails to transmit location signals.

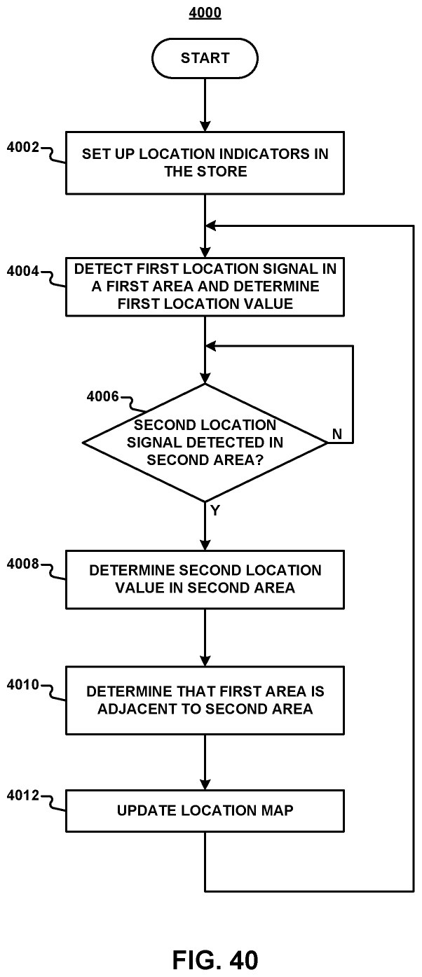

FIG. 40 illustrates an example method 4000 for generating a location map in stores including location indicators that transmit location signals. It may be assumed that location indicators have not been set up in the store at the start of method 4000. At 4002, location indicators that transmit location signals are set up in the store. At 4004, an MSD detects a first location signal in a first area of the store. The MSD determines a first location value based on the received first location signal. At 4006, the MSD determines whether a second location signal is detected. If a second location signal is not detected, method 4000 may continue in block 4006. Accordingly, the MSD may wait until a second location signal is detected in block 4006.

Method 4000 may continue in block 4008 when the MSD detects the second location signal in the second area. The MSD determines a second location value based on the detected second location signal. The MSD may then determine that the first area is adjacent to the second area in block 4010. In some examples, the MSD may determine that the first and second areas are adjacent to one another when the MSD determines that one or more location adjacency criteria are met.

In general, location adjacency criteria may include parameters that the MSD uses to determine the proximity of two different areas in a store. The MSD may determine that two different areas are adjacent to one another (e.g., connected by a single junction) when one or more location adjacency criteria are met. In general, different areas of a store may be adjacent in three different ways. In one example, two different areas of a store may be adjacent when location signals defining the two different areas abut one another. Abutting areas are described with respect to FIG. 17. In FIG. 17, aisle 270-3 includes multiple areas that abut one another. In one example, area 280-5 abuts area “280-5+280-6.” In this example, areas 280-5 and “280-5+280-6” are not separated by any dead zone because location signals overlap at the intersection of the two areas. In another example, area 280-6 abuts area 280-7. In this example, areas 280-6 and 280-7 are separated by a short dead zone in which location signals may not be present at detectable levels.

The size of a dead zone between two adjacent areas may vary. In one example, with respect to FIG. 17, area 280-6 and area 280-7 are separated by a short dead zone. In another example, area 280-1 and 280-2 are separated by a larger dead zone. As another example, the dead zone between area 280-3 and 280-10 is smaller than that between areas 280-1, 280-2, but larger than that between areas 280-6, 280-7. Accordingly, adjacent areas of a store may abut one another or be separated by a dead zone.

As described above, the location adjacency criteria may be used to determine whether two areas are adjacent to one another. In general, two areas may be considered adjacent to one another when the areas abut one another or when the two areas are separated by a relatively short dead zone. Qualitatively, two areas may be considered adjacent when the dead zones between the areas are small or not existent. Two areas are more likely to be considered non-adjacent by the OFS when the two areas are separated by larger dead zones. The location adjacency criteria may be used by the OFS to determine whether two areas are considered adjacent to one another.

A first location adjacency criterion may be based on whether two areas include common location values (e.g., are covered by common location signals). For example, if two areas include a common location value, then those two areas may be adjacent. Such a scenario arises when an area is defined by two overlapping signals. In this scenario, three different areas may be defined by two different location signals that overlap. The area in which the location signals overlap may be adjacent to each of the areas defined only by the single non-overlapping portions of the location signals. An example of three such areas are shown in FIG. 17. For example, in FIG. 17, areas 280-5, “280-5+280-6”, 280-6 are defined by two different location signals that overlap. Area “280-5+280-6” may be adjacent to area 280-5 because location value 280-5 is common to both area 280-5 and “280-5+280-6”. Similarly, area “280-5+280-6” may be adjacent to area 280-6 because location value 280-6 is common to both area 280-6 and “280-5+280-6.” Accordingly, area “280-5+280-6” may be adjacent to both areas 280-5 and 280-6.

Another location adjacency criterion may be an amount of time between detection of two different areas in the store. In general, an MSD may determine that first and second areas are adjacent when the amount of time between detecting the two areas is less than a threshold amount of time. In one example, the MSD may determine that first and second areas are adjacent when the MSD detects the second area within a threshold amount of time after detecting the first area. Similarly, the MSD may determine that first and second areas are adjacent when the MSD detects the first area within a threshold amount of time after detecting the second area.

In examples where an MSD uses a threshold amount of time to determine whether two areas are adjacent, the threshold amount of time may be selectable (e.g., by an operator of the OFS or another user). In general, a smaller threshold amount of time may require two areas to be closer to one another to be considered adjacent. A larger threshold amount of time may allow two areas that are farther apart to be considered adjacent.

In the example of adjacent areas 280-5 and “280-5+280-6” described above, an MSD may detect area 280-5 immediately after detecting area “280-5+280-6”. Similarly, an MSD may detect area “280-5+280-6” immediately after detecting area 280-5. Accordingly, an MSD may determine that area 280-5 and area “280-5+280-6” are adjacent for even small thresholds of time because the MSD may detect area 280-5 immediately after detecting area “280-5+280-6.” Similarly, an MSD may determine that area 280-6 and area “280-5+280-6” are adjacent for even small thresholds of time because the MSD may detect area 280-6 immediately after detecting area “280-5+280-6”.

Although areas may be immediately adjacent (e.g., not separated by a dead zone) as described with respect to areas 280-5 and “280-5+280-6,” in some examples, areas separated by dead zones may be considered adjacent. In examples where two areas are separated by a dead zone, the magnitude of the threshold amount of time may determine the amount of dead zone allowed between two areas that are considered adjacent.

Dead zones of different sizes are illustrated in FIG. 17. The size of the dead zone present between area 280-6 and area 280-7 is negligible. The dead zone present between area 280-6 and area 280-7 may be short enough that an MSD detects area 280-7 immediately upon exiting area 280-6. Put another way, the dead zone present between area 280-6 and area 280-7 may be so small that area 280-6 abuts area 280-7. Similarly, the dead zone present between area 280-7 and area 280-8 may be short enough that an MSD detects area 280-8 immediately upon exiting area 280-7.

A relatively short dead zone 281-1 is located between area 280-1 and area 280-2. Similarly, a relatively short dead zone 281-3 is located between area 280-4 and area “280-9+280-10.” A user may move an MSD from area 280-4 to area “280-9+280-10,” or from area 280-1 to area 280-2, on the order of one or more seconds (e.g., 1-3 seconds). Similarly, a user may move an MSD from area 280-4 to area “280-9+280-10,” or from area 280-1 to area 280-2, on the order of one or more seconds (1-3 seconds). A slightly larger dead zone is illustrated between area 280-1 and area 280-4 (e.g., on the side of rack 268-1 that does not include a location indicator). A user may move an MSD from area 280-1 to area 280-4 on the order of a 3 seconds or more.

An even larger dead zone is illustrated between area 280-1 and area 280-5 (e.g., on the sides of racks 268-1, 268-2 that do not include a location indicator). Movement of an MSD from area 280-1 to area 280-5 may take a greater amount of time than movement from area 280-1 to area 280-4. For example, moving an MSD from area 280-1 to area 280-5 may take approximately twice the amount of time (e.g., 5-10 seconds) as moving from area 280-1 to area 280-4.

As described above, an MSD may be configured to determine that two areas are adjacent when the amount of time between detecting the two areas is less than a threshold amount of time. The threshold amount of time used by the MSD may be a selectable value. In one example, the threshold amount of time may be set to 3 seconds. In this example, the MSD may determine that areas 280-1, 280-2 are adjacent to one another. Additionally, the MSD may determine that areas 280-1, 280-4 are adjacent to one another. An MSD may not determine that areas 280-1, 280-5 are adjacent because the MSD may not be moved between areas 280-1, 280-5 within the 3 second threshold, assuming that movement from area 280-1 to area 280-5 takes approximately 5-10 seconds.

In another example, the threshold amount of time may be set to 1 second. In this example, the MSD may determine that areas 280-1, 280-2 are adjacent to one another because an MSD may be moved between areas 280-1, 280-2 within a second. However, in this example, an MSD may determine that areas 280-1, 280-4 are not adjacent because the MSD may not be moved between areas 280-1, 280-4 within the 1 second threshold, assuming movement from area 280-1 to area 280-4 takes approximately 3 seconds or more.

The structure of a location map (e.g., the junctions) may depend on the placement of location indicators in the store and the number of location indicators in the store. In general, a greater density of location indicators within a store may result in a location map including more junctions (i.e., more adjacencies). For example, placing a greater number of location indicators within a given amount of floor space may generally result in a greater number of adjacent areas because there may be more overlapping signals and a smaller number of dead zones. With respect to the threshold amount of time used by an MSD, using a greater threshold amount of time may result in a location map having more adjacencies (i.e., more junctions) because areas separated by larger dead zones may be considered adjacent.

In summary, an MSD may use location adjacency criteria to determine if two areas are adjacent. In some examples, an MSD may determine that two areas are adjacent when the two areas include common location values. In some examples, an MSD may determine that two areas are adjacent when the amount of time between detection of the two areas is less than a threshold amount of time. The adjacency of areas may depend on the placement of location indicators in the store and the number of location indicators arranged throughout the store. Although location adjacency criteria may include the use of common location values and/or a threshold amount of time, it is contemplated that an MSD may use other adjacency criteria to determine whether two areas are adjacent.

Referring back to method 4000, an MSD may determine whether two areas area adjacent (e.g., using the location adjacency criteria) in block 4010. In block 4012, the mobile device indicates to the CCS that the two areas are adjacent. The CCS may then update the location map to indicate that the two areas are adjacent. The central system may transmit the updated location map to the one or more MSDs in the store. Over time, one or more MSDs in the store may identify additional adjacent areas. The CCS can further update the location map based on these identified adjacent areas. Continuation of the method 4000 in block 4004 after block 4012 represents that the location map may be continually updated over time as new areas (e.g., new location signals) are detected and new adjacencies are determined by the MSD(s).

FIGS. 41A-41D illustrate generation of a location map using a single MSD 4102. FIGS. 41A-41B illustrate generation of a partial location map including areas 464-1, 464-2, and 464-3. The MSD 4102 may generate the location map 4100-1 including the three areas 464-1, 464-2, 464-3 as the MSD 4102 is moved from area 464-1 to area 464-2 and on to 464-3 in FIG. 41A. In FIG. 41C, the MSD 4102 is moved from through areas 464-4, “464-4+464-5,” 464-5, 464-6, and back to area 464-1. The MSD 4102 may generate the location map 4100-2 illustrated in FIG. 41D during the movement in FIG. 41C. The MSD 4102 may transmit the location map 4100-2 to the CCS which may store the location map 4100-2 and transmit the location map to other MSDs in the store.

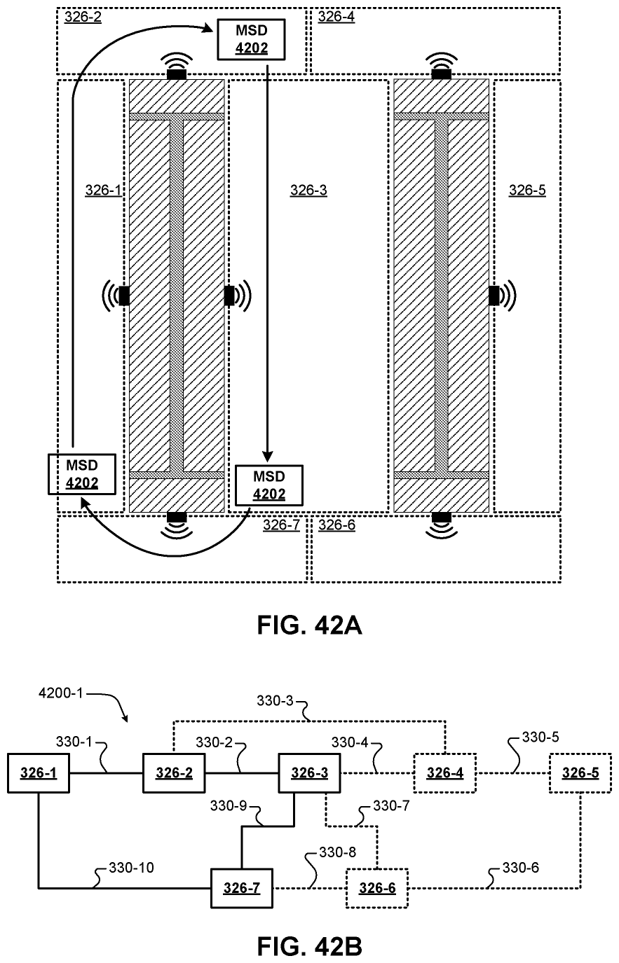

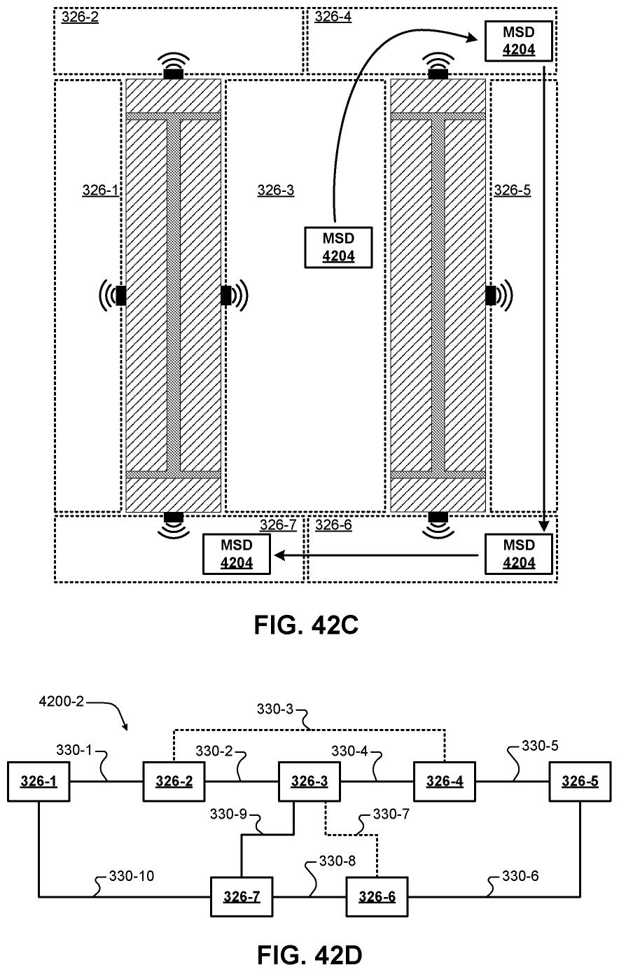

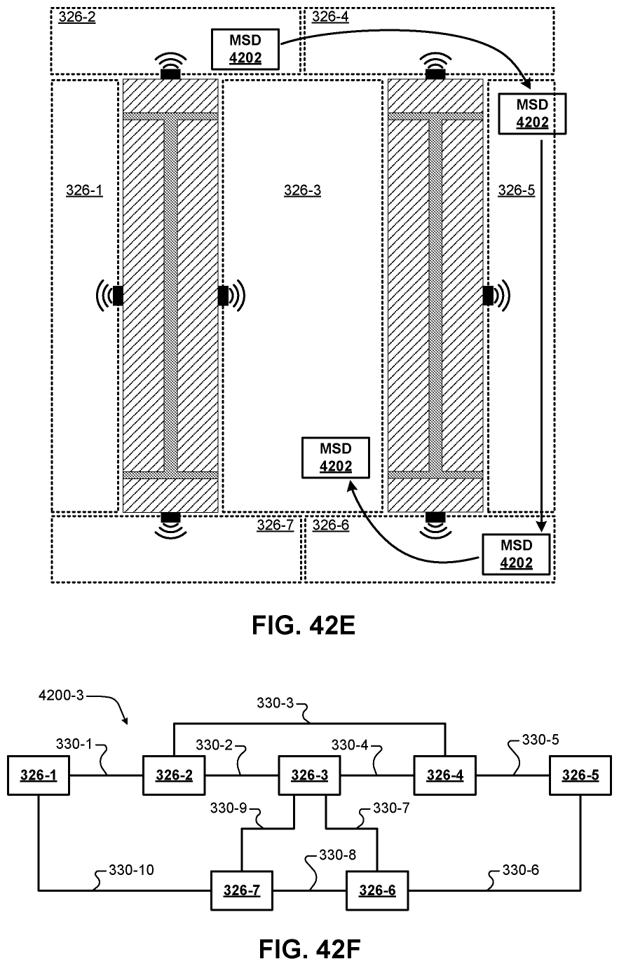

FIGS. 42A-42F illustrate generation of a location map using multiple MSDs. In FIG. 42A, the MSD 4202 is moved from area 326-1 through areas 326-2, 326-3, 326-7, and back to 326-1. The MSD 4202 may generate location map 4200-1 in FIG. 42B based on the movement. The junctions in solid lines indicate the adjacencies determined by the MSD 4200-1. The MSD 4202 may transmit the location map 4200-1 to the CCS which may update the location map stored at the CCS and then transmit the updated location map back out to other MSDs. The broken lines indicate adjacencies that may be determined in the future by MSDs. The broken lines are illustrated to provide context to the reader as to how the OFS may automatically generate a location map. As such, the broken lines may not represent junctions stored in the memory of the MSDs and CCS.

FIGS. 42C-42D illustrate generation of another portion of a location map 4200-2 using a second MSD 4204. In FIG. 42C, the second MSD 4204 is moved from area 326-3 through 326-4, 236-5, 326-6, and 326-7. The MSD 4202 may update the location map stored on the MSD 4202 to the location map illustrated in FIG. 42 based on detection of location signals in the areas. The MSD 4202 may transmit the updated location map to the CCS which may update the location map stored at the CCS and then transmit the updated location map back out to the other MSDs.

FIGS. 42E-42F illustrate generation of the remaining portions of a location map using the first MSD 4202. In FIG. 42E, the first MSD 4202 is moved from area 326-2 through areas 236-4, 326-5, 326-6 and 326-3. The MSD 4202 may complete the location map 4200-3 for the store based on such movement. The MSD 4202 may transmit the updated location map to the CCS which may update the location map stored at the CCS and then transmit the updated location map back out to the other MSDs.

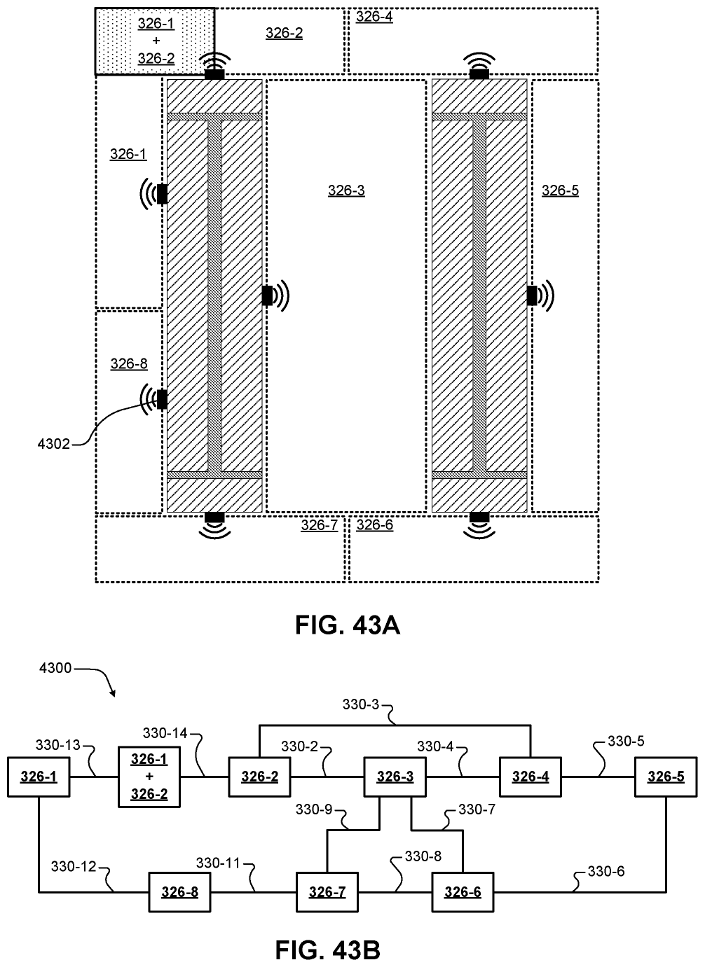

FIGS. 43A-43B illustrate an example updated location indicator layout and an example updated location map 4300 generated based on the updated location indicator layout. Relative to FIG. 42A, the store illustrated in FIG. 43A has had the location indicators updated to included two location indicators 4302, 4304 in the same aisle. Specifically, the location indicator for area 326-1 may have been moved closer to area 326-2, causing an overlap in areas 326-1 and 326-2. Additionally, the new location indicator 4302 has been added to the aisle adjacent to the location indicator for area 326-2. Modification of the location indicator layout cased the formation of 2 new areas 326-8, “326-1+326-2.” One or more MSDs and the CCS may identify the new areas and generate new adjacencies as illustrated in the location map 4300 of FIG. 43B. The MSDs and/or the CCS may then update the item association table based on the updated location map, as described above.

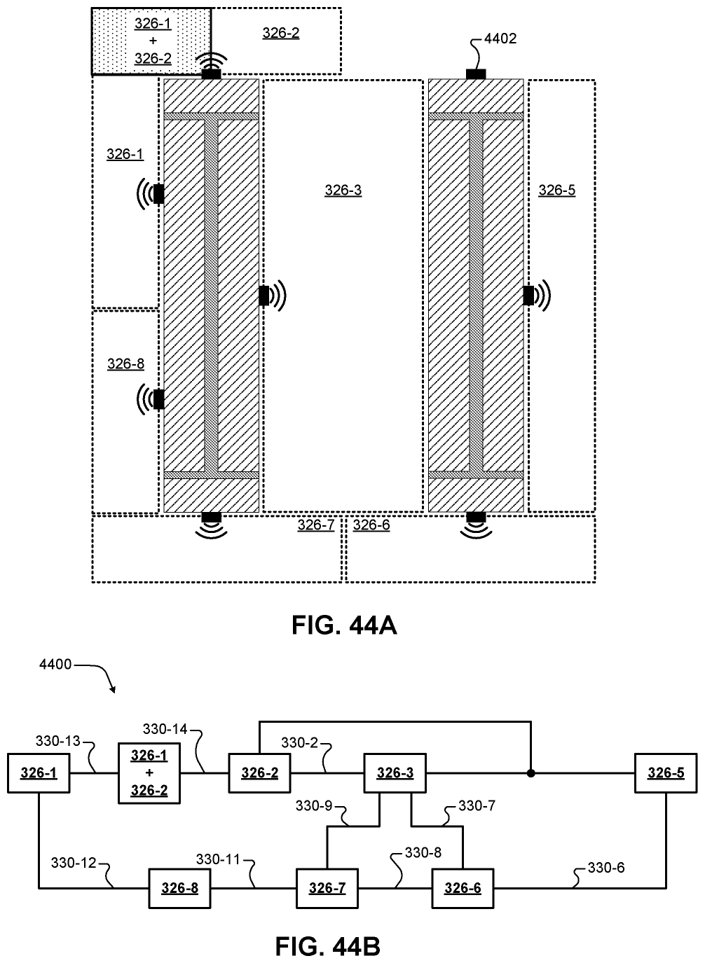

FIGS. 44A-44B illustrate an example location indicator layout similar to FIG. 43A, except that the location indicator 4402 for area 326-4 is not functioning properly.

In some examples, the location indicator 4402 may be out of power, broken, or malfunctioning for another reason. In this example, one or more MSDs and the CCS may automatically update the location map 4400 to remove area 326-4, as illustrated in FIG. 44B. In some implementations, the MSDs and/or the CCS may be configured to remove an area from the store in response to detecting the absence of location signals that otherwise were detected in the past. For example, the MSDs and/or CCS may remove the area from the location map after determining that the location signal has not been detected for a threshold amount of time. Upon removing an area from the location map, the MSDs and/or the CCS may initially update the item association table by assigning item ID codes to adjacent areas. Subsequently, over time, the MSDs and/or the CCS may update the item association table based on the updated location map, as described above.

Although generation/update of location maps is described above with respect to location indicators that emit location signals, the OFS may also generate/update location maps in stores that include location indicators having readable codes (e.g., barcodes). For example, MSDs can automatically scan for location indicators (e.g., using a barcode reader or camera) including readable codes and automatically update the location map in a manner similar to that described with respect to FIGS. 41A-44B. Specifically, over time, the MSDs may add areas and/or remove areas associated with location indicators having readable codes, as described above with respect to FIGS. 41A-44B.

In some implementations, the location map updating may be accomplished while the users are picking items from the racks for customer orders. In other examples, the user may set the MSD into a “location mapping mode” and walk through the store with the MSD while the MSD is acquiring location signals and automatically generating the location map based on the acquired location signals. In a store that includes location indicators having readable codes, the user may walk throughout the store and scan the location indicators to generate the location map. In other examples, the MSD may be configured to automatically read the readable codes. For example, the MSD may be configured to rest in a cart pushed throughout the store and scan the racks or other areas for the readable codes. In this example, the MSD may automatically pick up the readable codes as the cart is pushed throughout the store (e.g., using a camera or other barcode scanning device), as described herein with respect to using the MSDs for picking.

The MSDs may be configured to scan the item indicators, or detect the item signals transmitted from the item indicators, and perform various operations in response to scanning the item indicators or detecting the item signals. In one sense, an item indicator that is scanned or an item signal that is received by an MSD may be thought of as indicating a particular location of a corresponding item within the store. For example, a first location (e.g., on a shelf of a rack within an aisle) in the store may include a first item indicator that is scanned by an MSD, or which transmits a first item signal to an MSD. Similarly, a second location may include a second item indicator that is scanned by an MSD, or which transmits a second item signal to an MSD. As a result, an MSD may determine that the MSD is located in the first or second location when the MSD scans the first or second item indicator or detects the first or second item signal, respectively. Additionally, the item indicators or the corresponding item signals scanned or detected by an MSD at a particular time may also be thought of as indicating which of the items available in the store are in proximity to the MSD at that specific time. For example, since each of the items in the store may be associated with one or more item indicators and/or item signals, an MSD may, upon scanning an item indicator or detecting an item signal, determine which one or more of the items are in the vicinity of the MSD at that particular time.

Using the techniques described herein, an MSD may determine a location within the store and/or proximity of the MSD to one or more of the items included in the store. In some examples, the MSD may determine the location based on scanned item indicators or detected item signals. For example, the location may be represented as a location value, which may generally refer to any value or plurality of values (e.g., alphanumeric values) determined by the MSD that indicate a location of the MSD within the store. In some implementations, the MSD may further determine the location and the location value based on scanned location indicators or detected location signals. In general, the location values determined by the MSDs may depend on the types of item indicators/signals and location indicators/signals used in the store. A variety of example item and location indicators and item and location signals are described herein. In examples where the item and location indicators transmit item or location signals, an MSD may determine locations and corresponding location values based on one or more of the signals. In examples where the item and location indicators do not transmit item or location signals, an MSD may determine locations and corresponding location values in a different manner. For example, when item indicators and location indicators are readable objects (e.g., barcodes), an MSD may determine a location within the store and a corresponding location value based on a code included on the readable object.

An MSD may scan item indicators or acquire item signals as the MSD is transported throughout the store by a user. The item indicators may be set up throughout the store in a variety of different configurations. In some examples, the item indicators may be set up in the store such that the MSD may scan an item indicator or pick up an item signal near any given item located within the store. In these examples, the item indicators may be set up such that the item indicators, or item signals generated by the item indicators, overlap to varying degrees such that an MSD may scan multiple item indicators or acquire multiple item signals simultaneously in some locations. Additionally, or alternatively, the item indicators may be arranged such that the item indicators or associated item signals do not quite overlap, but, instead, abut one another or are separated by a short distance such that an MSD may scan a first item indicator or detect a first item signal in a first location, and then abruptly scan a second item indicator or detect a second item signal upon moving out of range of the first item indicator or first item signal. In other examples, the item indicators may be set up such that an MSD may not scan item indicators or pick up item signals at some locations within the store. In these examples, there may be so-called “dead zones” in which an MSD may not scan item indicators or acquire item signals because item indicators or item signals may be absent in that location, or not be sufficiently strong in that location. Various configurations of item indicators within a store are illustrated and described herein.

An MSD may perform a variety of different operations based on a location (e.g., a corresponding location value) and item proximity determined by the MSD. As described herein, the MSD may receive a customer order from the CCS outside of the store or as the MSD is being transported throughout the store by a user. In some examples, the MSD may be configured to display items of the received customer order on a display of the MSD based on a currently determined location, as indicated by a corresponding location value, and based on proximity of the items to the location and to each other, as indicated by an item adjacency map. For example, the MSD may be configured to arrange (e.g., order within a list) the items that are in proximity to the user (i.e., the MSD) at the top of the display for the user to view (e.g., at the top of the list). The MSD may be further configured to arrange the items that are farther from the user lower on the display (e.g., at the bottom of the list). In examples where a large number of items are displayed (e.g., ordered within a list), the items that are more distant from the user may be omitted from the display. Accordingly, in some examples, the items that are in closer proximity to the user may be displayed at the top of the display, while those items that are more distant from the user may be placed at the bottom of the display or not included on the display. Such an arrangement of items on an MSD display may prompt the user to pick items from the racks that are closest to the user. This may speed up the picking process by prompting a user to pick those items that may be picked the quickest and preventing the user from walking by items that are currently ordered by a customer.

The display of an MSD may be updated in real-time as the MSD is moved throughout the store. For example, the arrangement of the items on the display (e.g., within the list) may be updated as the user moves the MSD from a first location where a first item indicator is scanned or a first item signal is detected by the MSD to a second location where a second item indicator is scanned or a second item signal is detected by the MSD. In this example, the items originally arranged on the display may be further rearranged in real-time to reflect which of the items are currently in proximity to the user after the user has moved to the second location. Since the arrangement of the items may vary based on the location of the MSD, it follows that, in some examples, different MSDs present in different locations within the store may display different arrangements of the same items to their respective users.

In some examples, the display of an MSD may also be updated in real-time when new customer orders are received. For example, if a newly-received customer order includes items that are present in the store at the current location of an MSD, the display of that MSD may be updated to include the items of the newly-received order at or near the top of the display of the MSD. This may prevent a user from walking past an item that has just been ordered (e.g., ordered within the past few seconds).

In some examples, the display of an MSD may also be updated in real-time when items are scanned by the MSD. For example, an item may be removed from the display of the MSD when the MSD scans the item. In some examples, the displays of multiple MSDs may be updated in real-time when items are scanned by any one of the multiple MSDs. For example, when an item is scanned by any one of the multiple MSDs, the item may be removed from the displays of all of the MSDs in the store. In these examples, all of the MSDs may be updated each time any of the MSDs in the store scans an ordered item. This may allow multiple users located throughout the store to scan and pick different items of a single customer order. In some circumstances, this may allow customer orders to be picked more quickly than if a single user was picking the entire order.

One or more of the MSDs and/or the CCS may generate an item adjacency map that includes multiple items and indicates whether any two or more of the items are adjacent to one another (e.g., whether the items are located close to one another in the store). Adjacent items may be relatively close to one another in the store, such that the adjacent items may be picked one after another efficiently (e.g., without excessive movement). The distance between adjacent items may be configurable, depending on the item adjacency criteria used (e.g., depending on threshold times). As such, the meaning of adjacency (e.g., in terms of distance/time) may be configurable by the store operator. In a specific example, if the OFS is configured to set items as adjacent that are scanned within less than a few seconds of one another, adjacent items in the store may be very close to one another (e.g., within reach of one another). In general, increasing the amount of scan time allowed between adjacent items may allow for adjacent items to be farther apart from one another.

The MSDs and/or CCS may determine two or more scan times associated with two or more of the items (e.g., any two or more items that are currently displayed to a user of an MSD at the MSD display). The MSDs and/or CCS may determine whether the scan times satisfy an item adjacency criterion (e.g., a predetermined threshold amount of time) and, if so, determine that the items corresponding to the scan times are adjacent to one another. Subsequently, the MSDs and/or CCS may update the item adjacency map to indicate this determination. Alternatively, in the event the MSDs and/or CCS determine that the scan times do not satisfy the item adjacency criterion, the MSDs and/or CCS may determine that the two or more items are not adjacent to one another (or have undetermined adjacency). In some examples, the MSDs and/or CCS may further update the item adjacency map to indicate that the two or more items are not adjacent (e.g., by removing an indication of adjacency).

In some implementations, the item adjacency map may be generated based on scan times associated with picked customer items. Although the item adjacency map may be generated based on picked customer items, in some implementations, an MSD may include an “item adjacency mapping mode” that a user can use to generate some/all of the item adjacency map. For example, the user may set the MSD into the item adjacency mapping mode and scan items (e.g., not included in customer orders) while walking through the store. In some implementations, the item adjacency map may be created based on scans of items that are not included in customer orders, such as item scans that occur passively while a user is picking items.

The item association tables, location maps, and item adjacency maps described herein may also be generated based on data (e.g., location signal detection and scan times) acquired from CCDs used for mapping/picking, third-party MSDs used for mapping/picking, and/or other devices (e.g., robotic scanning devices) used for mapping/picking. The TPCS and CCS may store the item association tables, location maps, and adjacency maps for a single store. In some implementations, the TPCS may acquire the tables and maps from the CCS. In other implementations, the TPCS may generate and store their own tables and maps for the store. In some implementations, the CCS may retrieve tables and maps from the TPCS.

An MSD may receive a customer order including one or more items in the store (e.g., from the CCS) and retrieve the item adjacency map described above. For example, the item adjacency map may be stored at the CCS and transmitted to the MSD and/or the item adjacency map may already be stored at the MSD at the time the customer order is received. The item adjacency map may include multiple items within the store, including items that are in the customer order, and indicate whether any two or more of the items are adjacent. The MSD may display the items in the customer order based on data included in the item adjacency map. In some cases, the MSD may select an initial one of the items in the customer order and then display the items included in the customer order based on the initially selected item and based on the item adjacency map. For example, the MSD may arrange adjacent items (e.g., nearby items) at the top of the display for picking. In this example, the MSD may arrange items that are farther away (e.g., adjacent to currently adjacent items) farther down the display. In one example, the MSD may determine (e.g., estimate) a distance and/or a time required for a user to move between the initial item and one or more other items included in the customer order based on the item adjacency map (e.g., previous scan times). The MSD may then arrange some (or all) of the items of the customer order on the MSD display based on the determined distance and/or time. For example, the MSD may display the initial item at the top of a list. The MSD may further display other items lower within the same list based on the relative distances and/or times associated with the items and the initial item. In a specific example, the MSD may display an item that is closer to the initial item higher within the list compared to an item that is farther from the initial item. In some examples, the MSD arranges all items in the customer order on the display. In other examples, the MSD arranges a subset of the items, with the remaining items accessible to the user by scrolling down the list. In some examples, the MSD may arrange the currently adjacent items in a group near the top of the display and arrange other items farther down the display. In some examples, the MSD arranges the items in the order of closest to farthest with respect to the user (e.g., the MSD). In other examples, the MSD displays the items that are closest to the user at that particular time. In still other examples, the MSD indicates that a specific one of the items is currently adjacent to the user.

Although an MSD may display items based on a determined distance or time, in some implementations, an item adjacency map may not include distance or time data. In these implementations, the item adjacency map may just indicate that items are adjacent, without accompanying time/distance data. In these implementations, the MSD may display items that are determined to be adjacent to a current item/location higher on the display (e.g., for more immediate picking). The MSD may display items that are not adjacent farther down the display (e.g., for subsequent picking). In some cases, the MSD may display the currently non-adjacent items according to whether the currently non-adjacent items are adjacent to items which are currently near the user. For example, the MSD may display items farther down the display (e.g., for subsequent picking) that are adjacent to items which are adjacent to a current item/location. In a similar manner, the MSD may display subsequently adjacent items farther down the list. In some cases, the MSD may arrange an entire order based on adjacency. In other cases, the MSD may be configured to arrange a subset of the items in the list, and then arrange the remaining items that are farther away after the user has started picking the subset of items. In this manner, the MSD may present a list to the user that indicates which items are currently nearby and should be picked.

In some implementations, the OFS may make use of location indicators and/or location signals in conjunction with the item indicators, item signals, location maps and/or an item adjacency maps. As described herein, an MSD may perform a variety of different operations based on a location and a corresponding location value determined by the MSD, irrespective of whether the location and location value are determined using location indicators/signals alone or in conjunction with item indicators/signals. For example, an MSD may be configured to receive a customer order from the CCS while the MSD is being transported throughout the store. The MSD may be further configured to determine a location value associated with a current location of the MSD using one or more location indicators and/or location signals. The MSD may be further configured to display items of the received customer order on an MSD based on the determined location value and an item adjacency map. For example, the MSD may be configured to initially use the location value to orient the MSD as to the MSD's current location within the store and subsequently use the item adjacency map to determine the relative locations of the items in the customer order with respect to that location. For example, the MSD may first determine an initial one of the items included in the customer order that is located closest to (e.g., within) the location associated with the location value. The MSD may then use the item adjacency map to determine the locations of the remaining items of the customer order relative to the location of the initial item. As a result, the techniques of this disclosure may, in some examples, enable more accurate determination of relative locations of items in areas of the store (e.g., aisles) that include many items in close proximity to one another. The techniques of the disclosure may also allow for more efficient item picking.

In some implementations, one or more of the MSDs and/or the CCS may be configured to determine that two items are located adjacent to one another upon an MSD scanning the items and determining that the corresponding scan times are within a predetermined threshold amount of time. In some implementations, one or more of the MSDs and/or the CCS may be configured to determine that two items are located adjacent to one another upon an MSD scanning the items and determining that the corresponding scan times are within a predetermined threshold amount of time N number of times (e.g., a threshold number of times). In other words, in some examples, the techniques of this disclosure include determining that two items are adjacent upon scanning the items within a predetermined threshold amount of time in multiple instances. Similarly, in some examples, the techniques may include determining that two items are not adjacent upon scanning the items outside of a predetermined threshold amount of time in multiple instances. As a result of using data from multiple scans, the techniques may allow determining that the items are likely adjacent and decrease the chance of erroneous adjacency determinations (e.g., using so-called “outlier” scan times).

In some implementations, one or more of the MSDs and/or the CCS may be configured to determine adjacency of groups, or so-called “clusters,” of multiple items. For instance, in some examples, the techniques of this disclosure include grouping multiple items scanned by one or more of the MSDs into each of a first group and a second group. For instance, for any of the first and second groups, a plurality of the items scanned by the MSDs may be included in a particular group based on a number of the items (e.g., N of the items) and/or based on a threshold amount or duration of time during which the items were scanned. The techniques further include determining whether the first group includes one or more items that are the same as, or “overlap with,” one or more items included in the second group. The techniques also include, upon determining that the first and second group include one or more of the same items, determining that the first and second groups are adjacent. This may enable more accurately determining relative locations of the items within a store by grouping the items into groups and determining common items within the groups. In some examples, adjacency among any two of the items may be referred to as primary, or “first-tier,” adjacency. Adjacency among any two groups of items may be referred to as secondary, or “second-tier,” adjacency.

In some implementations, one or more of the MSDs and/or the CCS may be further configured to, upon generating an item adjacency map that indicates adjacency of a plurality of items, also include an indication of time (e.g., estimated time) and/or distance (e.g., estimated distance) required for a user to move (e.g., walk) between two or more of the items in the item adjacency map. In these examples, the MSDs and/or CCS may arrange multiple items on a display of an MSD in the manner described herein based on relative times and/or distances associated with two or more of the items using the item adjacency map including such indication of time and/or distance. In some implementations, the time and/or distance indications in the item adjacency map may be values that indicate relative time and/or distance between items, but not indicate actual time units (e.g., seconds) and/or distance units (e.g., meters). Instead, the time and/or distance indications may be dimensionless (e.g., without units). In other implementations, the time and/or distance indications may include time and/or distance units.

In some implementations, to generate an item adjacency map, one or more of the MSDs and/or the CCS may be configured to process the scan times associated with the items as the scan times are acquired (e.g., in real-time). Alternatively, the MSDs and/or the CCS may be configured to process a scan log including the scan times at a later point in time. The scan log may include data that indicates an MSD that scanned an item, a time when the item was scanned, and other data described herein. For example, a scan log may indicate a location value for the scan, where the location value may be determined based on a location indicator (e.g., a last/next scanned indicator or detected location signal) or other location technology (e.g., GPS, WIFI, etc.).

In some implementations, one or more of the MSDs and/or the CCS may be further configured to perform a calibration of the predetermined threshold amount of time described herein based on user speed (e.g., based on the scan times included in the scan log). For example, the MSDs and/or CCS may be configured to determine the predetermined threshold amount of time by determining user speed and scanning time, and then adjusting the predetermined threshold amount of time based on the user speed. In a specific example, users that pick items at a faster/slower rate may have their threshold scan times decreased/increased for determining adjacency.

In some implementations, one or more of the MSDs and/or the CCS may be configured to infer item adjacency between two items based on determined item adjacency between two or more intervening items. In other words, in some examples, the MSDs and/or CCS may be configured to, upon determining that a first item is adjacent to a second one or more items, and that the second one or more items are adjacent to a third item, further determine that the first and third items are also adjacent.

In some implementations, one or more of the MSDs and/or the CCS may be configured to infer item adjacency between multiple items based on corresponding scan times being within a predetermined threshold amount of time and/or based on sequential scanning of the items. For example, the MSDs and/or the CCS may determine that multiple items are all adjacent to one another upon determining that each of the multiple items was scanned by an MSD within a predetermined threshold amount of time. Additionally, or alternatively, the MSDs and/or the CCS may determine that the multiple items are all adjacent to one another upon determining that the items were scanned in a sequence (e.g., one item directly after another).

In some implementations, one or more of the MSDs may be configured to display multiple items in the manner described herein based on relative numbers of intervening items located between any two of the items, as indicated by an item adjacency map. For example, the MSD may display an initial item at the top of a list and one or more other items lower within the list in the order of how many intervening items are located between each such item and the initial item. In these implementations, the MSDs and/or CCS may generate an item adjacency map to indicate adjacency of a plurality of items using numbers of intervening items as metrics for adjacency. Also, in these implementations, the MSDs and/or CCS may omit any time or distance metrics previously described from the item adjacency map and retain sequence data indicating one or more sequences or orders in which the items in the store are arranged.

In some implementations, an MSD may be configured to display items such that a user of the MSD is directed to keep moving the MSD from a particular group of items to another group of items. For example, the MSD may be configured to, after scanning an item included in a first group of items, display an item included in a different group of items. In other words, the MSD may be configured to display an item that is adjacent to items in the first group, but which is not included in the first group. For example, the MSD may display items from the first group on the display along with another item from the second group of items to move the user in the direction of the second group.

In some implementations, one or more of the MSDs and/or the CCS may be configured to generate an item adjacency map that indicates adjacency of a plurality of items as well as scan directionality, or a scanning order, associated with the items in the item adjacency map. For example, the item adjacency map may indicate a temporal order in which the items in the item adjacency map were scanned by an MSD, in some examples indicating a time at which each item was scanned. The MSD may arrange items on the display based on the known temporal order in which items were scanned and determined as adjacent. Using a known temporal order of adjacency may provide directionality to the user while picking, which may reduce an amount of back-and-forth movement of the user while picking adjacent items. Additionally, the temporal order of adjacency may help the MSD put together a longer and more efficient picking route for one or more customer orders. For example, the temporal order of adjacency may indicate a direction of motion in which the user should pick single items and/or groups of items. In some cases, the historical scanning of intervening items between first and last picked items may provide an indication of direction in which the items may be picked efficiently.

In some implementations, an MSD may display items included in a customer order to a user and receive an input (e.g., a touchscreen tap) from the user selecting one of the items. In these implementations, one or more of the MSDs and/or the CCS may be configured to, upon receiving the input, designate the corresponding item as the next item to be picked by the user. For example, the MSD and/or the CCS may use the corresponding item as a “seed” or a “re-seed” item and determine one or more other items included in the customer order that are adjacent to that item using an item adjacency map (or other table/map). In this manner, each of multiple users of the MSDs may pick the items included in the customer order by selecting an item closest to the user and updating the items on the corresponding MSD to reflect one or more of the items that are adjacent to the user. As a result, multiple users of the MSDs may dynamically enter and exit the process of picking the items included in the customer order described herein. In some implementations, the MSD and/or CCS may “seed” an item in response to a scan of the item. For example, the MSD may assume that the user is in the location of the scanned item in response to the user scanning the item. The seeded item, whether manually selected or scanned, may be used to arrange items based on the item adjacency map and/or the location map and item associations.

In some implementations, one or more of the MSDs and/or the CCS may be configured to arrange items included in a customer order based on one or more location indicators. For example, an MSD may prioritize (e.g., move up a list) items that are located in a zone corresponding to a current location of the MSD, as indicated by an associated location indicator present in that zone.

In some implementations, one or more of the MSDs and/or the CCS may be configured to generate an adjacency map that is represented using any of a variety of other data structures other than those depicted in the figures of this disclosure, such as those indicating a number of item “hops” (e.g., a number of items) between any two items, an amount of time needed for a user to move between any two items, and so forth.

In some implementations, one or more of the MSDs and/or the CCS may be configured to use metadata indicating a type/category (e.g., produce, dairy, meat products) associated with an item included in a customer order to group (e.g., cluster) the item with one or more other items that are also included in the customer order, adjacent to the item, and associated with the same type. In this manner, the MSDs and/or CCS may group or cluster multiple adjacent items in the manner described herein based on item type shared by, or associated with the items, rather than on a number of the items. In some implementations, the MSDs and/or CCS may group items by type in an item adjacency map and then indicate which items are adjacent to one another within the item type group. For example, the item adjacency map may group dairy products together based on type and/or aisle location (e.g., aisle number). The item adjacency map may then further define the location of the items within the group (e.g., item type and/or aisle) using item adjacency or other location indicator mapping described herein. In additional implementations, the MSDs and/or CCS may include multiple items in a group or cluster and then infer that the items share a common item type.

In some implementations, one or more of the MSDs and/or the CCS may be configured to identify a first item included in a first group and identify a second, different item, that is adjacent to the first item but not included in the first group. The MSDs and/or the CCS may be configured to identify one or more additional items that are adjacent to the second item and also not included in the first group and include the second item and the additional items in a second, different group.

In some implementations, one or more of the MSDs and/or the CCS may be configured to generate a cluster map that indicates one or more items that are included in one or more groups (e.g., clusters). The MSDs and/or the CCS may be configured to use the cluster map in a similar manner as described herein with reference to an item adjacency map. For example, the MSDs and/or CCS may be configured to identify an item included in a cluster and use the cluster map to identify and indicate one or more additional items that are also included in the same cluster and are therefore adjacent to the item. In some implementations, one or more of the MSDs and/or the CCS may be configured to use a cluster map to determine a location of one or more items included in a store and/or a location in a store. The cluster maps may be used alone, or with other maps, such as other item adjacency maps and/or location maps. In some implementations, the cluster maps may be used as an alternative to location maps and/or when a location indicator has not been detected and/or is faulty, missing, or outdated (e.g., moved to another location).

In some implementations, one or more of the MSDs and/or the CCS may be configured to determine that two items are adjacent upon scanning the items within a predetermined threshold amount of time after several instances of scanning the items outside of the predetermined threshold amount of time. In this manner, a single scan instance indicating adjacency among the items may negate or remove several prior scan instances indicating non-adjacency among the items. In further examples, non-adjacency among items may be used to fill in missing information in an adjacency map. For example, an MSD may display items that are determined non-adjacent to a current item when adjacent items are missing or not known.

In some implementations, one or more of the MSDs and/or the CCS may be configured to use an item adjacency map in conjunction with one or more location indicators. For example, in these implementations, a store may include one or more zones, each associated with a location indicator. In each such zone, one or more areas associated with one or more items included in the zone may be organized based on adjacency among the items. For example, the item adjacency map may indicate to an MSD and/or the CCS where within the zone the items are located based on the adjacency among the items. In some implementations, the location map and/or item adjacency map may indicate an aisle number and/or a portion of the aisle (e.g., middle, end, etc.).

In various implementations, the MSDs and/or CCS may be configured to identify a first item (e.g., an anchor item) included in a particular zone associated with a location indicator, and then determine relative locations of one or more different items also included in the zone with respect to the first item using an adjacency map. In this manner, the MSDs and/or CCS may add granularity to, or enhance resolution of, relative locations of the items included in the zone. In some examples, one or more of the different items previously not displayed on an MSD (e.g., displayed off-screen) may be displayed upon determining the items are adjacent to the first item. Alternatively, one or more previously displayed items may be removed from being displayed upon determining the items are not adjacent to the first item.

In various implementations, one or more of the MSDs and/or CCS may be configured to make use of items (e.g., an anchor item) included in zones and MSDs transitioning from one zone to another zone. For example, the MSDs and/or the CCS may determine that an item included in a first zone is proximate to an item included in a second zone upon an MSD scanning the two items within a predetermined threshold amount of time when the MSD transitions between the two zones, thereby defining edges of the zones. In various implementations, the items scanned by the MSD in this manner may be referred to as edge items. Identifying edge items and a sequence of items between edge items in a zone may assist the CCS and/or MSDs in determining how to arrange items on the display. For example, if the MSD is about to traverse a zone, the MSD may display items at the entry edge of the zone, and then display sequential items in the zone farther down the list until the items on the opposite edge are reached. Displaying items in this manner may provide for efficient picking in a store that is laid out in long aisles, where most aisles have two ways to enter/leave. In a specific example, if an aisle has one or more zones in a line, the arrangement of items for picking may be organized in a linear fashion down the aisle from zone to zone based on the edge items and sequential items between the edge items.

In some implementations, an MSD may be configured to display a subset of the items included in a customer order (e.g., items that are located proximate to the MSD at that time). In some implementations, the MSD may randomly insert one or more other items included in the customer order into a list of displayed items, such as items that are not adjacent to the MSD or for which adjacency is not known (e.g., to fill a screen). In this manner, the MSD may indicate to a user where the user is ultimately expected to go to fill the customer order and/or enable the user to determine (e.g., refresh) adjacency of the items included in the customer order by prompting the user to move toward items for which adjacency is not known.

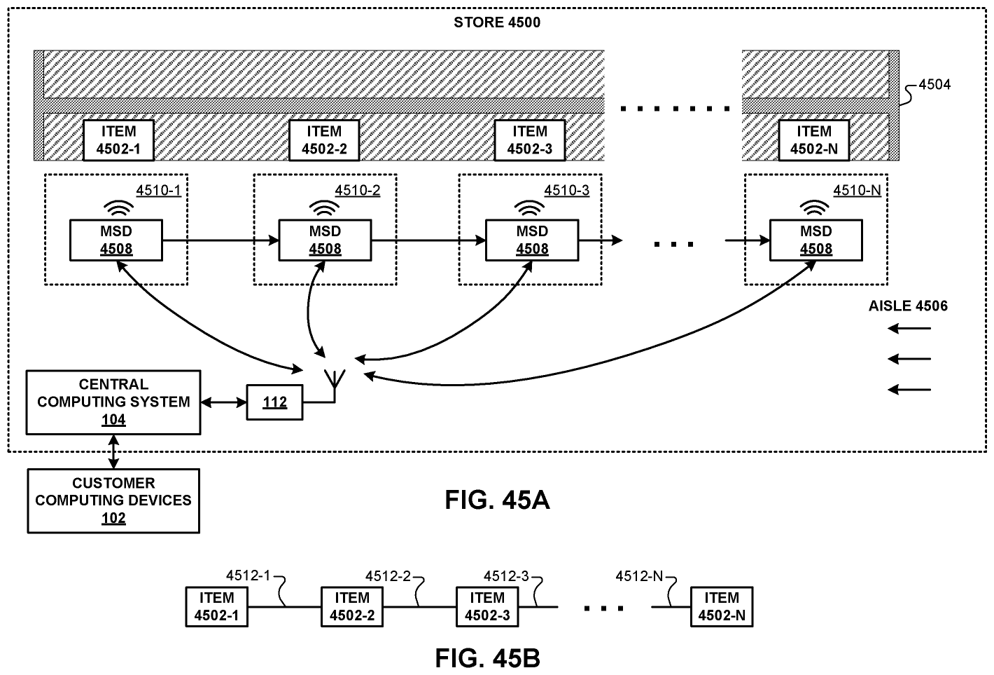

FIG. 45A illustrates an example store 4500 including a plurality of items 4502-1 . . . 4502-N placed on a rack 4504. Example store 4500 also includes an aisle 4506 formed along (e.g., located adjacent to) rack 4504. Items 4502-1 . . . 4502-N include item indicators (e.g., barcodes/RFIDs) that may be associated with item IDs. The items, item indicators, and item IDs may be referred to using the same callouts. Item indicators 4502-1 . . . 4502-N may each identify a corresponding one of items 4502-1 . . . 4502-N to a particular one of MSDs, namely MSD 4508, when MSD 4508 is located proximate to the item. Store 4500 includes CCS 104 that communicates with the one or more MSDs, including MSD 4508, and with one or more CCDs 102, via communication system 112. The broken line boxes labeled 4510 may indicate different scan times for the items (e.g., not necessarily sequential). Although the items are illustrated as being arranged along a straight line on a single rack, item adjacency may be applicable to items in any arrangement on any number of racks throughout the store.

FIG. 45B depicts an example graphical representation of adjacency among items 4502-1 . . . 4502-N described with reference to FIG. 45A. The graphical representation of adjacency indicates that item 4502-1 is adjacent to item 4502-2, item 4502-2 is adjacent to item 4502-3, and so forth. The graphical representation of adjacency depicted in FIG. 45B may correspond to any data structure, including information represented as one or more alphanumeric characters, binary data, or other human- and/or machine-readable information. In the example of FIG. 45B, the graphical representation of adjacency among items 4502-1 . . . 4502-N indicates a substantially linear adjacency relationship between items 4502-1 . . . 4502-N. In other examples, the graphical representation of adjacency among items 4502-1 . . . 4502-N, or other items, may be non-linear, branched, circular, or have other relationships. The junctions 4512 between items 4502 may represent adjacency between the items. In some implementations, the junctions may represent an item adjacency value that indicates the proximity between the items (e.g., a scan time difference between the items).

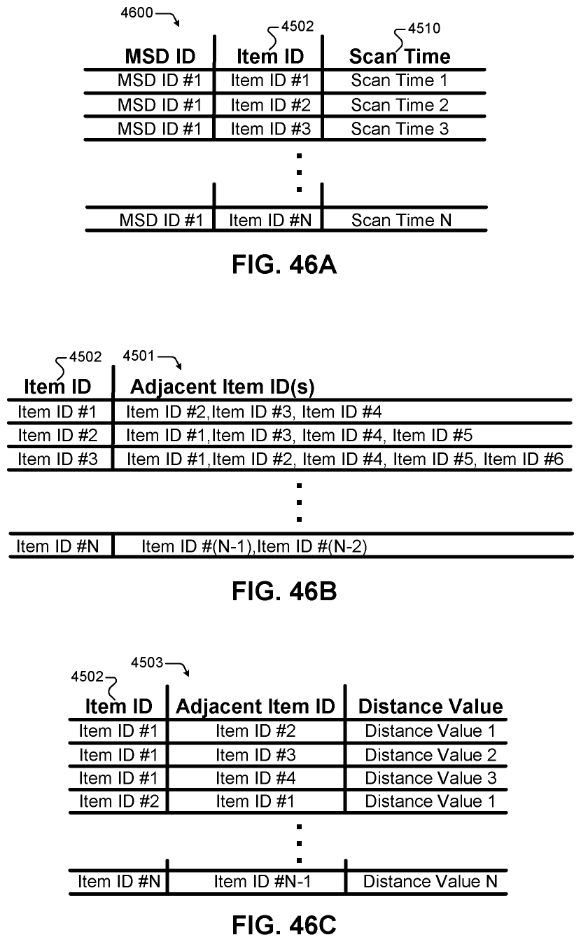

FIG. 46A depicts example item scan time data 4600 associated with the plurality of items 4502 described with reference to FIGS. 45A-45B. As shown in FIG. 46A, item scan time data 4600 includes a table indicating each of the plurality of items 4502. Specifically, item scan time data 4600 includes, for each of the plurality of items 4502, an item identification (ID) number that identifies the item and a scan time associated with the item. As described with reference to FIGS. 46A-46B, the scan time associated with each of the plurality of items 4502 may be determined by scanning the item on a rack of a store using MSD 4508. As shown in FIG. 46A, in some implementations, a scan time associated with each of the plurality of items is represented in numeric form (e.g., hours, minutes, and/or seconds) or other form. As also shown in FIG. 46A, in some implementations, item scan time data 4600 further includes, for each of the plurality of items, an MSD ID number that identifies an MSD 4508 used to acquire the scan time associated with the item.

FIGS. 46B-46C depict example item adjacency maps 4501 and 4503 generated based on the item scan time data 4600 described with reference to FIG. 46A. As shown in FIG. 46B, item adjacency map 4501 includes a table indicating each of the plurality of items 4502 described with reference to FIGS. 45A-45B. In particular, item adjacency map 4501 includes, for each of the plurality of items 4502, an item ID number that identifies the item. Item adjacency map 4501 further includes a list of adjacent items for each of the plurality of items 4502. As shown in FIG. 46C, in some implementations, item adjacency map 4503 further includes estimated relative distances between adjacent items, such as distance values estimated based on scan times between items (e.g., average/median scan times). The item adjacency map 4503 may include scan times and/or distance values, depending on the implementation.

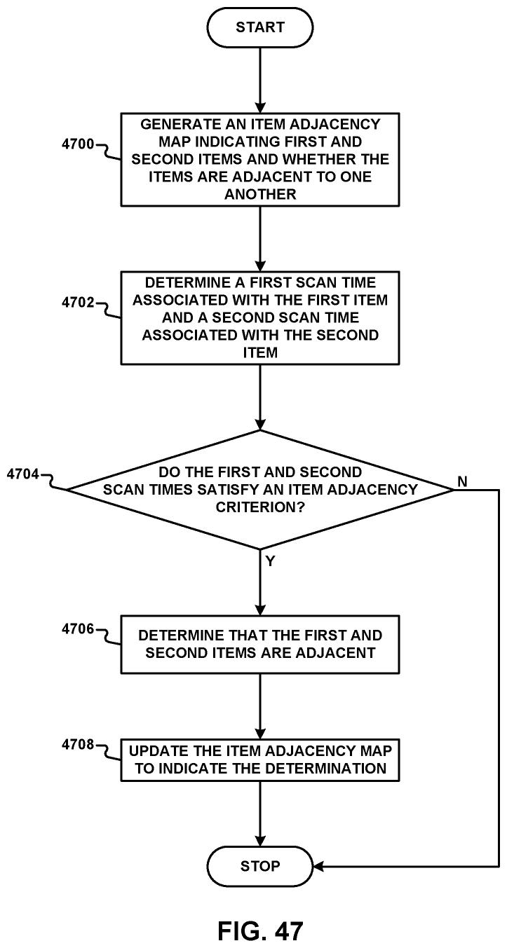

FIG. 47 depicts a method describing operation of an MSD configured to generate an item adjacency map indicating adjacency of a plurality of items. In block 4700, an MSD and/or the CCS initially generates an initial item adjacency map that indicates a plurality of items located on one or more racks included in a store and whether the items are adjacent to one another. Upon initial creation of the item adjacency map, the item adjacency map may include a plurality of items, but may not indicate whether the items are adjacent or not. For example, adjacency between the items may be labeled as undetermined (e.g., N/A). In some implementations, the MSD may initially generate the item adjacency map to partially, or preliminarily, indicate whether the items are adjacent to one another. In other words, the MSD may generate the adjacency map to indicate the plurality of items, as well as indications of whether the items are adjacent to one another.

The adjacency map may be subsequently updated based on scan times associated with the items. For example, an indication of whether two of the items are adjacent to one another may be determined and/or reinforced based on relatively temporally close scan times associated with the items, indicating that the items are adjacent to one another. Alternatively, the indication of whether the two of the items are adjacent to one another may be removed based on relatively temporally distant scan times associated with the items, indicating that the items are not adjacent to one another. Specifically, in block 4700, the MSD generates the item adjacency map to indicate at least first and second items and whether the items are adjacent to one another (or undetermined). As described herein, the MSD may further update the item adjacency map to include one or more additional items and whether each of the additional items is adjacent to each of another one or more items also included in the item adjacency map.

In block 4702, the MSD determines a first scan time associated with the first item and a second scan time associated with the second item. In some implementations, the MSD determines the first and second scan times by scanning the first and second items, as described herein. For example, the MSD may scan the first and second items in a temporally sequential manner automatically as the MSD passes the first and second items while the items are located on one or more racks. As another example, an MSD may determine the first and second scan times when a user manually operates the MSD to scan the items while picking a customer order.

In block 4704, the MSD determines whether the first and second scan times satisfy an item adjacency criterion (e.g., a predetermined threshold amount of time). In some implementations, the MSD determines whether the first and second scan times are sufficiency temporally close to one another, indicating that the first and second items are adjacent to one another. For example, the MSD may determine whether a difference between values associated with the first and second scan times is sufficiency small (e.g., within a predetermined threshold amount of time). In other implementations, the MSD determines whether the first and second scan times satisfy an item adjacency criterion using other techniques/criteria, such as a criterion that may be satisfied by having two or more independent users (e.g., MSDs) scan the items in less than a threshold amount of time.

In some implementations, the MSDs may reject scan times between items that are outliers from other scan times, as such outliers may not be representative of an accurate distance between items. An outlier scan time difference between two items may be a scan time difference that varies by greater than a threshold amount from a typical range (e.g., average or median) of scan times between specific items. For example, if two items are typically scanned within tens of seconds of one another, the MSDs may reject scan time differences of minutes or seconds, as such outlier scan times may indicate an atypical scenario. An atypical scenario may occur when a user holds on to an item for a long period of time and then scans it. This scenario may result in an atypically long scan time between the recently scanned item and a previous item. Another atypical scenario may occur when a user holds on to a first item for a long period of time and then scans the first item just before scanning the second item. This scenario may result in an atypically short scan time between the held first item and the subsequent second item.

In block 4706, in the event the MSD determines that the first and second scan times satisfy the item adjacency criterion, the MSD determines that the first and second items are adjacent to one another. Subsequently, in block 4708, the MSD updates the item adjacency map to indicate this determination. For example, as described herein, the MSD may reinforce an existing indication included in the item adjacency map that indicates that the first and second items are adjacent. In other examples, the MSD may create a new indication that the first and second items are adjacent and include the indication in the item adjacency map. Reinforcing a determination of adjacency may include updating data associated with the adjacent items that indicates the scan times between items have satisfied item adjacency criterion multiple times. For example, the MSD and/or CCS may update the item adjacency map to include, for each pair of adjacent items, a reinforcement indicator value that indicates the number of times the two items have been considered adjacent. The item adjacency map may also include, for each pair of adjacent items, the history of scan times associated with the pair of adjacent items.

In the event the MSD determines that the first and second scan times do not satisfy the item adjacency criterion (“NO” branch of block 4704), the MSD may make a variety of determinations. In some implementations, the MSD may determine that the adjacency status of the first and second items remains undetermined. In these implementations, the item adjacency map may include data that indicates when items are adjacent or whether the status of the adjacency is undetermined.

In some implementations, the item adjacency map may include data that indicates when items are not adjacent. In these implementations, the MSD may determine that the first and second items are not adjacent to one another based on one or more scan times associated with the two items that indicate they are not adjacent. For example, the items may be determined to be non-adjacent when the scan times between the items are large (e.g., sufficiently greater than a threshold value). In some examples, the MSD may further update the item adjacency map to indicate that the first and second items are not adjacent, in a similar manner as described with reference to block 4708. For example, as described herein, the MSD may remove an existing indication included in the item adjacency map that indicates that the first and second items are adjacent. Alternatively, the MSD may explicitly indicate that two items are not adjacent in some cases.

In some implementations, the item adjacency map is generated by a combination of the MSD and the CCS 104. In some examples, the CCS 104 generates the item adjacency map in a similar manner as described herein with reference to the MSD, and transmits the item adjacency map to the MSD. For example, the MSD may transmit, to the CCS 104, information indicating that the first and second items are adjacent and/or the first and second scan times. In this example, the CCS 104 may generate the item adjacency map based on the first and second scan times. In other examples, the CCS 104 and the MSD jointly generate the item adjacency map based on the first and second scan times. In these examples, upon generating and/or receiving the item adjacency map, the MSD uses the map to display a list of items located on racks of a store.

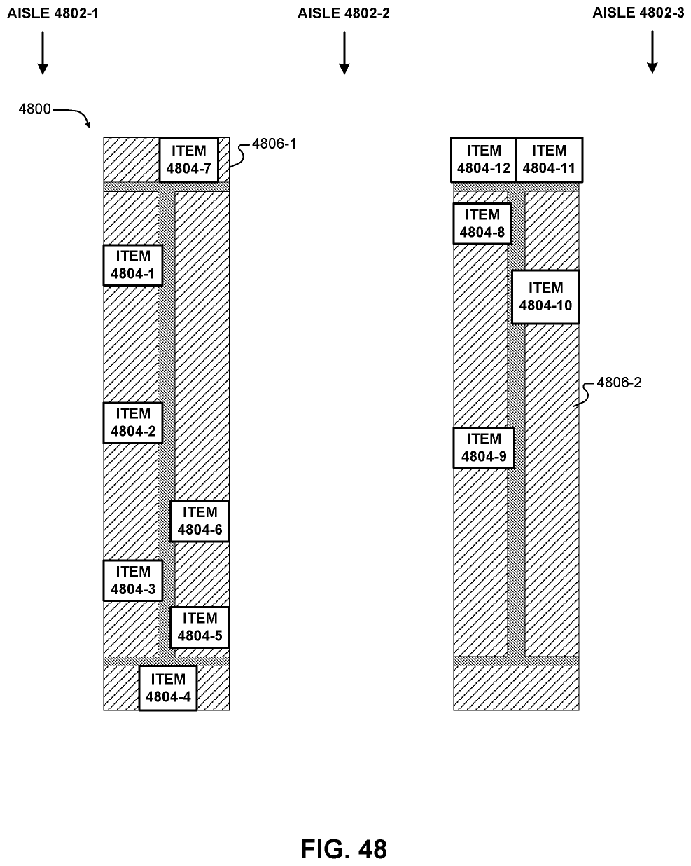

FIG. 48 depicts an example store 4800 including a plurality of items 4804 (e.g., including item indicators 4804) placed on racks 4806. Example store 4800 also includes aisles 4802. In FIG. 48, one or more of the MSDs and/or the CCS have generated an item adjacency map including items 4804. The MSDs and/or the CCS have also determined scan times between items 4804 and determined whether the scan times satisfy an item adjacency criterion (e.g., a predetermined threshold amount of time). In the event the scan times satisfied the item adjacency criterion, the MSDs and/or CCS have further determined that the items are adjacent to one another and have updated the item adjacency map to indicate this determination.

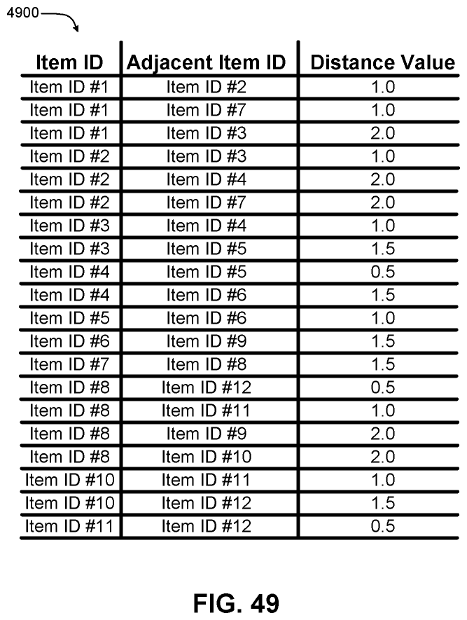

FIG. 49 depicts an example item adjacency map 4900 generated based on item scan times acquired for items 4804 in FIG. 48. As shown in FIG. 49, item adjacency map 4900 includes a table including items 4804-1 to 4804-12. The item adjacency map 4900 includes, for each of the plurality of items 4804, an item identification (ID) number that identifies the item. The item adjacency map 4900 also indicates, for each item, which other items are adjacent to the item. The item adjacency map 4900 also includes, for each item, an indication of a distance between the item and the adjacent item. As shown in FIG. 49, in some implementations, an indication of a distance between adjacent items is represented in numeric form (e.g., in a nominal or real value). In other implementations, the item adjacency map may indicate an amount of time between adjacent items (e.g., an average scan time). The item adjacency map in FIG. 49 may be updated over time to include additional adjacencies, remove existing adjacencies, and/or modify distance values and scan times. The item adjacency map of FIG. 49 is only one example item adjacency map that may be generated for the items of FIG. 48.

An MSD may use the item adjacency map of FIG. 49 in order to pick the items of FIG. 48. In some cases, the MSD may have the item adjacency map included in memory. In other cases, the MSD may retrieve the item adjacency map from the CCS. The MSD may select an initial item included in the customer order using any of a variety of techniques described herein. The MSD may display items in the customer order based on the selected initial item and the item adjacency map. In some examples, the MSD determines a distance and/or a time required for a user to move between the initial item and one or more other items included in the customer order based on the item adjacency map. In these examples, the MSD then arranges some/all of the items on the display based on the determined distance and/or time. For example, the MSD may display the initial item at the top of a list and display the other items lower on the list based on the relative distances and/or times associated with the items and the initial item. The MSD may further indicate that a specific one of the items is currently adjacent to the user.

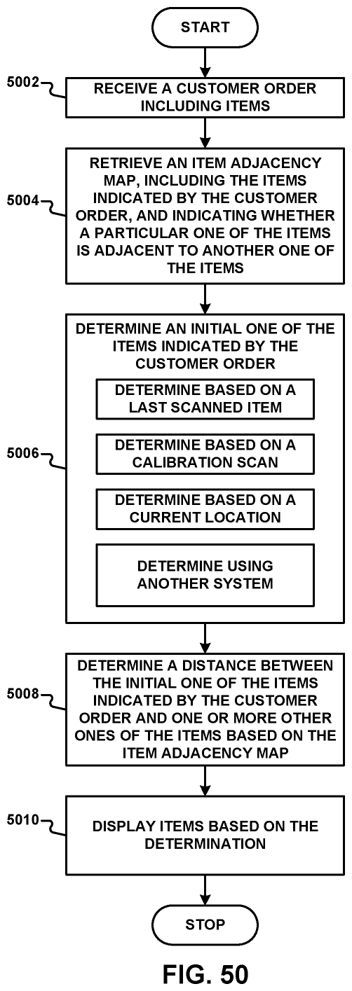

FIG. 50 depicts a method describing operation of an MSD that displays items based on an item adjacency map. In block 5002, the MSD receives a customer order including a plurality of items from the CCS. In block 5004, the MSD retrieves an item adjacency map (e.g., from MSD memory or the CCS) that includes the items of the customer order and indicates whether any items are adjacent to one another.

In block 5006, the MSD selects an initial one of the items in the customer order. In some implementations, the MSD selects the initial one of the items based on a last-scanned item. For example, the MSD may select the item in the customer order that the MSD most recently scanned as the initial one of the items, or items near the last scanned item. In other implementations, the MSD may select one of the items that is most proximate to the item that the MSD most recently scanned as the initial one of the items. For example, the MSD may determine that a particular one of the items included in the customer order is proximate to the item that the MSD most recently scanned using an item adjacency map. In other examples, the MSD may determine that a particular one of the items is proximate to the item that the MSD most recently scanned using one or more received location signals and location values determined based on the received location signals. In still other examples, the MSD may determine that a given one of the items is proximate to the most recently scanned item using other techniques (e.g., GPS/WiFi location information). In other implementations, the MSD determines the initial one of the items based on a calibration scan. For example, the MSD may determine the initial one of the items based on a scan of one or more items located on one or more racks included in the store that are each proximate to the MSD. In other implementations, the MSD determines the initial one of the items based on a current location. For example, the MSD may determine the initial one of the items using one or more received location signals and location values determined based on the received location signals and/or using other techniques (e.g., GPS/WiFi location information), in a similar manner as described herein.

In block 5008, the MSD determines a distance between the initially selected item and the other items in the customer order using the item adjacency map. For example, the MSD may determine whether the initially selected item is closer to a particular item in the customer order based on the item adjacency map. In other words, the MSD may determine a relative distance between the initially selected item and the other items in the customer order using the item adjacency map. In some implementations, the MSD may determine the relative distance based on single distance values and/or a sum of distance values.

In block 5010, the MSD displays the items of the customer order based on the distance determination described with reference to block 5008. As one example, the MSD may display the initially selected item at the top of a list presented to a user. In this example, the MSD may further display additional items lower within the same list based on the relative distances between the items and the initially selected item. In particular, the MSD may arrange items that are relatively closer to the initially selected item higher within the list. In a specific example, with respect to FIG. 48, an MSD near item 4804-5 may display items 4804-3, 4804-4, 4804-5, and 4804-6 higher on the display to prompt the user to pick those items due to their adjacency. Due to the item adjacency map, this may even be the case if items 4804-3 and/or 4804-4 are in different zones (e.g., associated with different location values) than item 4804-5.

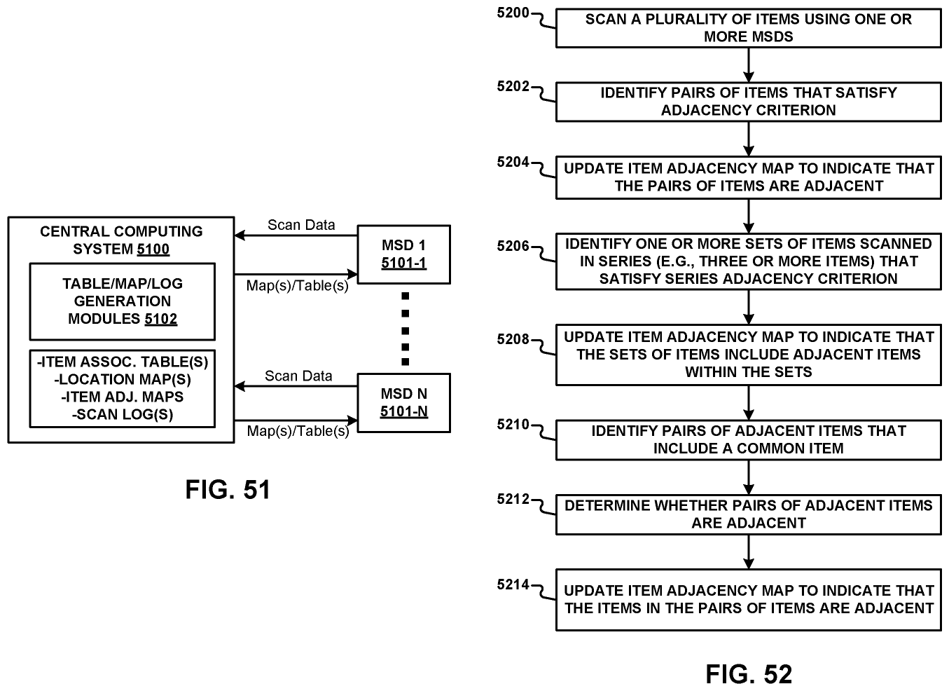

FIG. 51 illustrates an example CCS 5100 that includes data described herein. For example, the CCS 5100 may include one or more item association tables, one or more location maps, one or more item adjacency maps, and one or more scan logs. As described herein, the CCS 5100 may generate the data included in the CCS 5100 based on data (e.g., item IDs, location signals, etc.) acquired from one or more MSDs (e.g. MSDs 5101-1 to 5101-N).

The CCS 5100 may include modules 5102 that generate the tables, maps, and logs stored at the CCS 5100. For example, the CCS 5100 may include table generation modules (e.g., item association table generation modules), map generation modules (e.g., location/adjacency map modules), and/or log generation modules (e.g., scan log generation modules) that generate the tables, maps, and logs stored at the CCS 5100. The modules and data included in the CCS 5100 represent features that may be included in the CCS 5100 of the present disclosure. The modules and data described herein may be embodied by electronic hardware, software, firmware, or any combination thereof.

FIG. 51 illustrates N MSDs 5101 that provide data to the CCS 5100 that may be used to generate the item adjacency maps and scan logs. For example, each of the N MSDs provide scan data to the CCS 5100. The scan data may include, but is not limited to, item IDs, timestamps, and location values. The CCS 5100 may generate and update the scan logs and/or the item adjacency maps based on the received scan data from the N MSDs 5101. The CCS 5100 may also generate and update other data structures described herein based on the scan data, such as item association tables and location maps.

FIG. 52 illustrates an example method that describes multiple ways the CCS may determine that items are adjacent. In block 5200, one or more MSDs scan a plurality of items. For example, the MSDs may scan items for a plurality of customer orders over time (e.g., hours, days, weeks, or more). The method of FIG. 52 may be implemented in real time and/or or may be implemented using item scan data stored in a scan log. In block 5202, the CCS identifies pairs of items that satisfy adjacency criterion (e.g., scanned within a threshold time). In block 5204, the CCS updates the item adjacency map to indicate that the pairs of items are adjacent.

Blocks 5206-5208 are directed to identifying a situation where a series of scanned items are determined to be adjacent to one another. In block 5206, the CCS identifies one or more sets of items that were scanned in series. For example, the CCS may identify a series of items (e.g., 3 or more items) that were scanned in series by a single MSD. Furthermore, in block 5206, the CCS identifies one or more sets of the items scanned in series that satisfy series adjacency criterion. Example series adjacency criterion may include a requirement that the series of items be scanned within less than a threshold period of time (e.g., a series threshold time). In this example, if multiple items (e.g., 3 or more) are scanned in less than the threshold period of time, the multiple items may be considered as adjacent to one another. For example, each of the items may be considered as adjacent to the other items. In block 5208, the CCS updates the item adjacency map to indicate that the items in the sets of items are adjacent to one another. In an example case where a set of items includes three items, the first item may be updated as adjacent to the second item and the third item, the second item may be updated as adjacent to the first and third item, and the third item may be updated as adjacent to the first and second item.

Blocks 5210-5212 are directed to identifying a situation in which items in two pairs of adjacent items that include a common item may be determined to be adjacent. This situation may arise when a single MSD scans the pairs of items at different times (e.g., different times of day, week, etc.) for different customer orders. This situation may also arise when a first MSD scans a first pair of items and a second MSD scans a second pair of items, where the first and second pairs of items include the same item. In block 5210, the CCS identifies pairs of adjacent items that include a common item. In block 5212, the CCS determines whether items in the pairs are adjacent. In one example, the CCS may determine that all items in the two pairs of items are adjacent when the sum of the scan times is less than a threshold value. For example, the CCS may determine that the three items in two pairs of adjacent items are adjacent if the sum of the scan times between the first pair of items and the second pair of items is less than a threshold value. The CCS may make the determination in block 5212 using various scan times associated with the pairs, such as the most recent scan times, average scan times, etc. In block 5214, the CCS updates the item adjacency map to indicate the items in the pairs of items are adjacent if the criteria in block 5212 are satisfied.

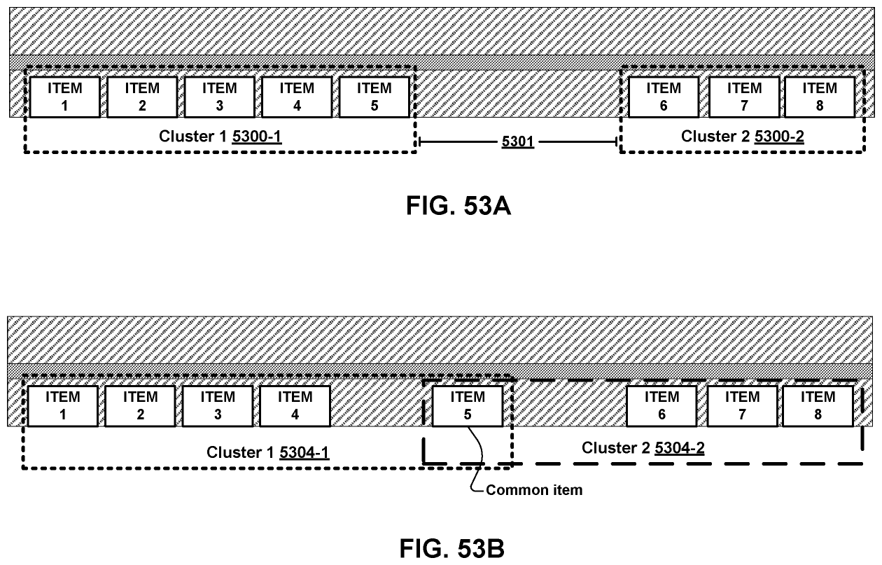

FIGS. 53A-53B illustrate example clusters of adjacent items. FIG. 53A includes a first cluster 5300-1 and a second cluster 5300-2. The first cluster 5300-1 includes five adjacent items. The second cluster 5300-2 includes three adjacent items. The two clusters 5300 are separated by some distance indicated at 5301. In some cases, the two clusters 5300 may not be considered as adjacent. In other cases, the two clusters 5300 may be considered adjacent if one of the items from the second cluster 5300-2 is scanned within a threshold amount of time after scanning an item from the first cluster 5300-1. In this case, an item adjacency map may be updated to indicate that the two clusters are adjacent (e.g., cluster identifiers may be indicated as adjacent). In some cases, when two clusters are adjacent, each item from both clusters may be considered as adjacent to one another (e.g., in a single combined cluster).

FIG. 53B illustrates an example in which two clusters 5304-1, 5304-2 include a common item (e.g., item 5). The inclusion of a common item in two clusters may indicate that the two clusters are adjacent. This scenario may arise when two previously separate clusters each add the common item at a later time. The CCS may leave the two clusters as separate data structures in some cases, but indicate that the two clusters are adjacent based on the common item. In other cases, the CCS may combine the clusters and consider the items in the clusters as being adjacent to one another (e.g., in a single cluster).

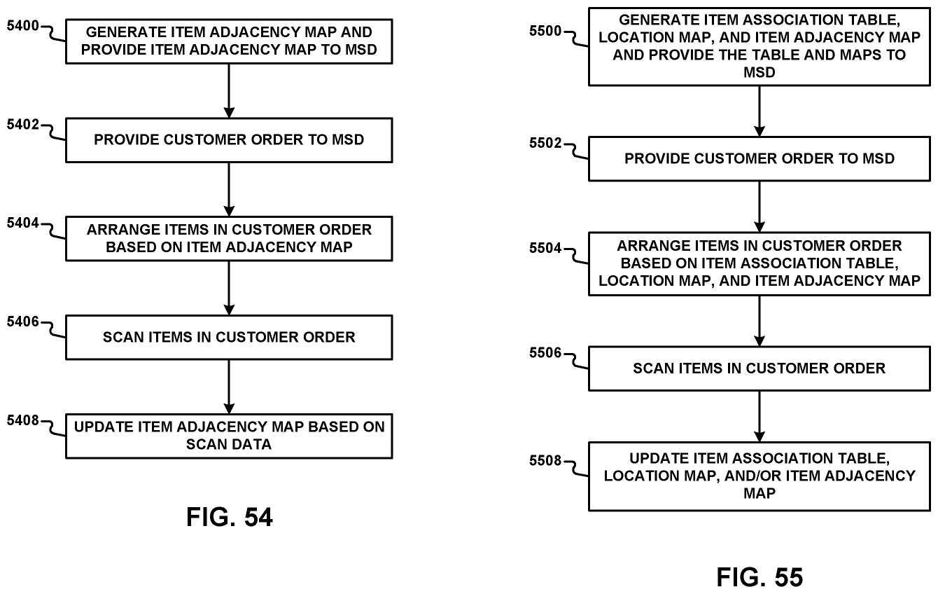

FIG. 54 illustrates a method that describes using an item adjacency map for mapping and picking items from the store. In block 5400, the CCS generates an item adjacency map for the store and provides the item adjacency map to an MSD. In block 5402, the CCS provides a customer order to the MSD for picking.

In block 5404, the MSD arranges the items in the customer order on the display based on the item adjacency map. For example, the MSD may arrange the items in a picking order that minimizes picking time by generating the picking sequence for the items based on the items' location relative to one another. In a specific example, the MSD may arrange the items so the user is mostly picking items that are subsequently adjacent to one another until the order is picked.

In some implementations, the MSD may initially arrange the items based on an assumed starting point for picking. For example, the MSD may arrange items relative to a specific/general picking starting point, such as the entry to the store, a first aisle location, or other location. In these implementations, the MSD may rearrange the items as the user moves throughout the store and/or scans items. In other cases, the MSD may not rearrange the items. Instead, the MSD may maintain the initial arrangement of items on the display, such that the customer order is presented as a fixed sequential list of items. The MSD may also initially arrange and/or rearrange items based on a determined location.

In block 5406, the user moves through the store picking and scanning items in the customer order. In block 5408, the CCS may update the item adjacency map based on scan data received from the MSD. In some cases, the MSD or other scanning device may scan items on the shelf that are not included in the customer order. For example, an MSD or other scanning device (e.g., robotic, attached to the cart or user, etc.) may scan items, scan readable location indicators, and/or pick up location signals for the purposes of updating the item association table, location map, and/or item adjacency map.

FIG. 55 illustrates a method that describes using an item association table, location map, and item adjacency map for mapping and picking items from the store. In block 5500, the CCS generates an item association table, location map, and item adjacency map for the store, and then provides the table and maps to an MSD. In block 5502, the CCS provides a customer order to the MSD for picking.

In block 5504, the MSD arranges the items in the customer order on the display based on the item association table, location map, and item adjacency map. In some implementations, the MSD may be configured to determine an initial arrangement of items based on the user's location, as determined by the location map and/or item association table. The MSD may then further arrange the items within the location using the item adjacency map. The additional arrangement based on item adjacency may arrange the items for more efficient picking in the case that a location indicator/signal covers a large number of items. For example, if a location indicator covers an entire aisle of items, the item adjacency map may define more granular arrangements of items on the display. Alternatively, in some cases, the MSD may arrange items based on item adjacency first and then based on location.

In block 5506, the user moves through the store picking and scanning items in the customer order. In block 5508, the CCS may update the item association table, the location map, and/or the item adjacency map based on scan data received from the MSD. As described herein, an MSD may generate an initial arrangement of items for one or more customer orders upon receiving the one or more customer orders. Subsequently, the MSD may rearrange the items on the display based on user movement/picking. Although an MSD may rearrange items based on a current location (or other data), in some implementations, the MSD may maintain the initial arrangement of items on the display (e.g., not rearrange the items). For example, the MSD may present the customer orders as a fixed sequential list of items.

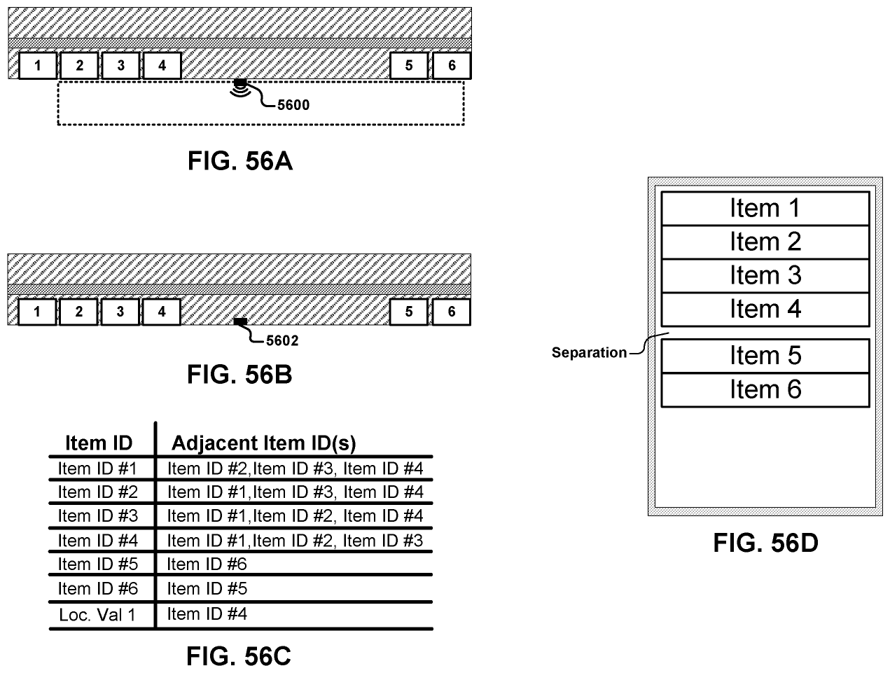

FIGS. 56A-56D illustrate examples of a store that implements both location indicators and item adjacency mapping. FIGS. 56A-56B both include six items (e.g., items 1-6). FIG. 56C illustrates an item adjacency map that indicates items 1-4 are adjacent to one another and items 5-6 are adjacent to each other. The item adjacency map also includes a location value (Loc. Val 1) associated with a location indicator 5600 that emits a location signal (e.g., FIG. 56A) or a readable location indicator 5602 (e.g., FIG. 56B).

FIG. 56A illustrates how location indicators and item adjacency may be implemented to better arrange items for picking. In FIG. 56A, the location indicator 5600 emits a location signal that covers items 2-6, but not item 1. Accordingly, item 1 may not be associated with a location value in some cases. However, if item adjacency is used, the MSD may determine that item 1 is near items 2-4. Also, using item adjacency, the MSD may determine that items 1-4 are grouped together and items 5-6 are grouped together.

FIG. 56B illustrates how a readable location indicator 5602 and item adjacency may be implemented to better arrange items for picking. In FIG. 56B, the readable location indicator 5602 may be associated with items 1-6, or some of items 1-6. In this case, however, if item adjacency is used, the MSD may also determine that items 1-4 are grouped together and that items 5-6 are grouped together.

FIG. 56D illustrates how item adjacency can be used to arrange customer items on a display. The MSD displays adjacent items as being grouped. For example, items 1-4 and items 5-6 are grouped. The groups of items are also separated on the display to indicate that the physical groups of items are separated from one another (e.g., determined based on adjacency). The separation is illustrated as a gap between the item groups. In some implementations, the MSD may display the groupings in a different manner. For example, the groupings may be rendered in different colors, text (e.g., font/bold/underlining), etc. In cases where item adjacency is not used, the MSD may group items together that are associated with the same locations.

Note that the item adjacency map of FIG. 56C includes data that indicates the adjacency of a location indicator (e.g., location value) to an item. The adjacency of a location indicator relative to items may be determined in a variety of ways, depending on the type of location indicator used. With respect to readable location indicators, the CCS may generate the item association table by treating the readable location indicator as though the readable location indicator is an item ID for purposes of the item adjacency map. With respect to a location indicator that emits a location signal, the MSD may generate the adjacency map based on a location of the location indicator relative to the items. The MSD may make the determination of proximity to the location indicator in a variety of ways, depending on the type of location indicator. In some implementations, the MSD may determine the proximity based on the strength of the location signal.

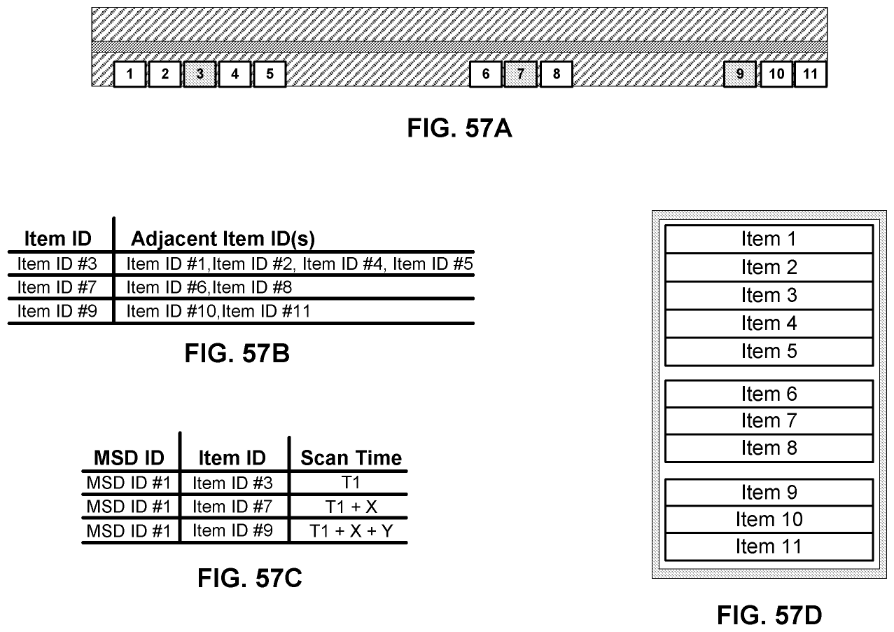

FIGS. 57A-57D illustrate the use of a scan log to determine item adjacency and directionality in a store. The item adjacency and directionality may be used to map items in a store. The maps based on item adjacency and directionality may allow the MSD to provide the user with a more efficient picking route. In FIG. 57A, items 1-5 are adjacent, items 6-8 are adjacent, and items 9-11 are adjacent. The three separate clusters in FIG. 57A are not adjacent to one another. The adjacency between the items may have been determined based on scan logs provided by one or more MSDs that picked one or more customer orders. FIG. 57B illustrates a partial item adjacency map that indicates the adjacencies in FIG. 57A.

FIG. 57C illustrates example scan log data that indicates a single MSD had scanned items 3, 7, and 9 in sequence. Specifically, the items were scanned at time T1, subsequent time T1+X (e.g., X seconds after T1), and further subsequent time T1+X+Y (e.g., Y seconds after T1+X). Although the sequential scan of items 3, 7, and 9 may not indicate adjacency of the items, the sequential scan times may indicate a physical location (e.g., arrangement) of items 3, 7, and 9 relative to one another. For example, the sequential scan times may indicate that items 3, 7, and 9 may be picked in a sequence (e.g., a linear sequence where item 7 is in the middle). Although a sequence of only 3 items are shown in the scan log, a scan log may include a much longer sequence of items (e.g., greater than 3 items) that indicate the relative location of a sequence of items to one another. Note that items 3, 7, and 9 are shaded for illustration purposes in FIG. 57A.

In FIG. 57D, it may be assumed that the MSD has received a customer order including items 1-11 of FIG. 57A. The MSD groups the adjacent items into different groups on the display based on adjacency. Additionally, the MSD arranges the groups of items based on the sequence data, with the items adjacent to item 7 displayed in the middle of the groups. The arrangement of the groups in FIG. 57D may be determined based on an assumed or determined starting point of the picker (e.g., near items 1-5) in a variety of ways described herein. If the picker were to start picking from the group of items 9-11, the groups may be rearranged on the display such that the bottom group of items 9-11 is switched with the top group of items 1-5.

Although the data used to generate the item association tables, location maps, and item adjacency maps may be acquired from MSDs, in some implementations, the data may be acquired by other computing devices, such as an automatic scanning and/or picking device (e.g., a robotic device that moves throughout the store). For example, a robotic device may scan items, acquire location signals, and/or scan location indicators. In some implementations, the robotic device may send the acquired data to the CCS for processing. The robotic device and/or the CCS may generate the tables and maps described herein based on the acquired data. The maps may then be used to arrange items for picking by MSDs and/or CCDs.

Various examples have been described. These and other examples are within the scope of the following claims.

What is claimed is:

1. An order filling system for a store that includes a plurality of stocked items for picking according to one or more electronic customer orders, the order filling system comprising:
a computing system configured to:
generate an item adjacency map based on a plurality of scan times associated with the plurality of stocked items, wherein the item adjacency map indicates which of the stocked items are adjacent to one another;
receive an electronic customer order including a plurality of ordered items indicating which of the stocked items are to be picked; and
wirelessly transmit the electronic customer order; and
a mobile scanning device comprising a display, the mobile scanning device configured to:
receive the transmitted electronic customer order; and
arrange at least some of the plurality of ordered items on the display based on the item adjacency map.

2. The order filling system of claim 1, wherein the item adjacency map includes adjacency values for adjacent items, and wherein the adjacency values indicate the distance between the adjacent items.

3. The order filling system of claim 1, wherein the item adjacency map includes adjacency values for adjacent items, and wherein the adjacency values indicate an amount of time for movement between the adjacent items.

4. The order filling system of claim 1, wherein the computing system is configured to determine that two stocked items are adjacent to one another when the two stocked items are associated with scan times that differ by less than a threshold period of time.

5. The order filling system of claim 1, wherein the computing system is configured to determine that three or more stocked items are adjacent to one another when the three or more stocked items are associated with scan times that indicate that all three or more stocked items were scanned in less than a threshold period of time.

6. The order filling system of claim 1, wherein the mobile scanning device generated the plurality of scan times upon which the computing system generated the item adjacency map.

7. The order filling system of claim 1, wherein the mobile scanning device is a first mobile scanning device, wherein the order filling system further comprises a second mobile scanning device, and wherein the second mobile scanning device generated the plurality of scan times upon which the computing system generated the item adjacency map.

8. The order filling system of claim 1, wherein the mobile scanning device is configured to:
scan item identification codes for the plurality of ordered items in the electronic customer order; and
wirelessly transmit data to the computing system indicating that the item identification codes were scanned, wherein the computing system is configured to update the item adjacency map based on when the item identification codes were scanned.

9. The order filling system of claim 1, wherein the item adjacency map includes a plurality of clusters of stocked items, and wherein the item adjacency map indicates which of the clusters are adjacent to one another.

10. The order filling system of claim 9, wherein the clusters of stocked items are clusters that are based on item type.

11. The order filling system of claim 9, wherein the clusters of stocked items are clusters based on location in the store.

12. The order filling system of claim 1, wherein the mobile scanning device is configured to:
scan a first item of the electronic customer order; and
arrange at least some of the plurality of ordered items on the display based on the item adjacency map and the scanned first item.

13. The order filling system of claim 1, wherein the mobile scanning device is a first mobile scanning device, wherein the order filling system comprises a second mobile scanning device comprising a second display, and wherein the second mobile scanning device is configured to:
receive the transmitted electronic customer order; and
arrange at least some of the plurality of ordered items on the second display based on the item adjacency map.

14. The order filling system of claim 1, further comprising N location indicators for arrangement throughout the store, wherein each of the N location indicators is configured to transmit a different location signal, and wherein the mobile scanning device is configured to:
detect at least one of the N location signals; and
arrange at least some of the plurality of ordered items on the display based on the item adjacency map and based on which of the N location signals is detected.

15. The order filling system of claim 1, further comprising a plurality of location indicators for arrangement throughout the store, wherein each of the location indicators includes a different readable code that is associated with a different area of the store, and wherein the mobile scanning device is configured to:
scan a first readable code and determine a location value based on the scanned first readable code; and
arrange the plurality of ordered items on the display based on the item adjacency map and the location value.
